(19) United States
(12) Patent Application Publication
(10) Pub. No.: US 2011/0030957 A1
(43) Pub. Date: Feb. 10, 2011

(54) CARBON CAPTURE AND STORAGE

(76) Inventors: BRENT CONSTANTZ, Portola Valley, CA (US); KYLE SELF, San Jose, CA (US); WILLIAM RANDALL SEEKER, San Clemente, CA (US); MIGUEL FERNANDEZ, San Jose, CA (US)

Correspondence Address: Calera Corporation;Eric Witt, 14600 Winchester Blvd., Los Gatos, CA, 95032, US

(21) Appl. No.: 12/852,053

(22) Filed: Aug. 6, 2010

Related U.S. Application Data
(60) Provisional application No. 61/264,564, filed on Nov. 25, 2009.
(60) Provisional application No. 61/232,401, filed on Aug. 7, 2009.
(60) Provisional application No. 61/352,604, filed on Jun. 8, 2010.
(60) Provisional application No. 61/309,812, filed on Mar. 2, 2010.
(60) Provisional application No. 61/360,397, filed on Jun. 30, 2010.
(60) Provisional application No. 61/305,473, filed on Feb. 17, 2010.

(51) Int. Cl. E21B 43/16; B65G 5/00; C01B 6/00

(52) U.S. Cl. 166/305.1; 405/53; 422/162

(57) ABSTRACT

Aspects of the invention include methods of contacting carbon dioxide with an aqueous mixture. In practicing methods according to certain embodiments, a subterranean brine may be contacted with carbon dioxide to produce a reaction product, which may or may not be further processed as desired. Also provided are methods in which a brine or minerals are contacted with an aqueous composition. Aspects of the invention further include compositions produced by methods of the invention as well as systems for practicing methods of the invention.

### CROSS-REFERENCE

This application claims priority to U.S. Provisional Application 61/264,564 “Methods and Systems for Utilizing Salts” filed on Nov. 25, 2009 and U.S. Provisional Application 61/232,401 “Carbon Capture and Storage” filed on Aug. 7, 2009 and U.S. Provisional Application 61/352,604 “Methods and Systems for Utilizing Salts” filed on Jun. 8, 2010 and U.S. Provisional Application 61/309,812 “Gas Stream Multi-Pollutants Control Systems And Methods” filed on Mar. 2, 2010 and U.S. Provisional Application 61/360,397 “Natural Gas Power Plant E-Chem Process” filed on Jun. 30, 2010 and U.S. Provisional Application 61/305,473 “Gas Stream Multi-Pollutants Control Systems And Methods” filed on Feb. 17, 2010.

### BACKGROUND

An important environmental problem is global-warming Carbon dioxide (CO₂) emissions have been identified as a major contributor to the phenomenon of global warming and ocean acidification. CO₂ is a by-product of combustion and it creates operational, economic, and environmental problems. It is expected that elevated atmospheric concentrations of CO₂ and other greenhouse gases will facilitate greater storage of heat within the atmosphere leading to enhanced surface temperatures and rapid climate change. CO₂ has also been interacting with the oceans driving down the pH toward 8.0. CO₂ monitoring has shown atmospheric CO₂ has risen from approximately 280 parts per million (ppm) in the 1950s to approximately 380 ppm today, and is expect to exceed 400 ppm in the next decade. The impact of climate change will likely be economically expensive and environmentally hazardous. Reducing potential risks of climate change will require sequestration of CO₂.

There are a number of recognized issues with conventional methods of carbon capture that have constrained widespread adoption of this technology to address global warming: cost and power requirements; risks associated with the storage of high pressure gases underground; and availability of economically viable formations with the appropriate characteristics for long-term storage. A less recognized challenge in sequestration is that almost all subterranean locations, e.g., geological formations that are well suited for CO₂ sequestration are already filled with water or brine which, if not removed, severely constrains the storage capacity of the formation. Provided herein are methods and systems that address the utilization of subterranean brine resources for carbon capture and storage.

### SUMMARY

The invention includes methods, compositions and systems. In some embodiments methods are provided for contacting carbon dioxide with an aqueous mixture to form a reaction product in the contacted aqueous mixture and sequestering at least a portion of the reaction product or derivative thereof in a first subterranean location. The reaction product may comprise water and dissolved carbon dioxide carbonic acid, carbonates, or bicarbonates or any combination thereof. The carbon dioxide may be a component of an industrial waste gas or may be in the form of supercritical carbon dioxide. In some embodiments, the aqueous mixture used to contact the carbon dioxide may comprise divalent cation e.g. calcium, magnesium, or a combination of calcium and magnesium. In some embodiments the aqueous mixture the molar ratio of calcium to magnesium may be between 1:1 and 1000:1. In some embodiments the aqueous mixture may be alkaline. In some embodiments the reaction product may contain less than 1% solids (e.g., less than 0.5% solids). In some embodiments the methods of this invention further include precipitating a precipitation material comprising carbonates, bicarbonates, or a combination of carbonates and bicarbonates from the reaction product. The reaction product may be concentrated to form a concentrated mixture. In some embodiments the contacting of an aqueous mixture with carbon dioxide may occur at or above ground level. In some embodiments the reaction product has a δ¹³C value less −10‰. In some embodiments the waste gas used in methods of this invention may comprise SO_{X}, NOₓ, industrial waste particulate, VOCs, heavy metals, heavy metal containing compounds, or a derivative of any of the forgoing or any combinations thereof. In some embodiments the reaction products of this invention may comprises SOₓ, NOₓ, industrial waste particulates, VOCs, metals, metal containing compounds, or any combinations thereof. In some embodiments the concentration of carbon in the reaction product may be at least 0.012 g/cm³, or 0.123 g/cm³ or in some embodiments at least 0.2472 g/cm³. In some embodiments aqueous mixture used to contact carbon dioxide comprises solid material. In some embodiments that solid material may be mafic mineral particulate, evaporates, solid waste from an industrial process, or any derivative or combination thereof. In some embodiments the first subterranean of this invention may be an aquifer, a petroleum reservoir, a deep coal seam, or a sub-oceanic location. In some embodiments wherein the subterranean location is a geological feature covered by rock with a porosity greater than 1%. In some embodiments the geological feature not covered by cap rock. In some embodiments, the subterranean location is between 100 and 1000 meters below ground. In some embodiments the aqueous mixture comprises fresh water, seawater, retentate from a desalination process, a subterranean brine, or a stream resulting from dissolution of mineral sources or any combination thereof. In some embodiments the waste gas comprising carbon dioxide is provided by an industrial process (e.g., power plant, a steam fossil fuel reformer, a liquefied natural gas plant, a cement plant, a smelter, or any combination thereof). In some embodiments producing the reaction product comprises removing protons from the aqueous solution before or after contacting the aqueous mixture with carbon dioxide. In some embodiments the protons may be removed by addition of a proton-removing agent such as an industrial waste. In some embodiments the industrial waste may comprise fly ash, bottom ash, cement kiln dust, slag, red mud, mining waste, or any combination thereof. In some embodiments the protons are removed by an electrochemical method. In some embodiments the protons are removed by a combination of electrochemistry and the addition of a proton removing agent. In some embodiments methods of this invention include separating an amount of water from the reaction product, to produce a concentrated mixture and a supernatant. A portion of the concentrated mixture may be transported to the subterranean location. The concentrated mixture may comprise greater than 30% solids by weight. In some embodiments the supernatant may be reused as a portion of the aqueous mixture. In some embodiments the methods of this invention may include removing the aqueous mixture from a second subterranean location prior to contacting the aqueous mixture with the waste gas comprising carbon dioxide or supercritical carbon dioxide. The first and second subterranean locations may be the same location or a different location.

In some embodiments systems of this invention may comprise a processor configured for contacting an aqueous mixture with an industrial waste gas to produce a reaction product, a first conduit and a first subterranean location, wherein the conduit provides for transferring a portion of the reaction product or a derivative of the reaction product from the processor to the subterranean location. The reaction product may comprise comprising water and dissolved carbon dioxide carbonic acid, carbonates, or bicarbonates or a combination thereof. In some embodiments the system may further include a source for the industrial waste gas operably connected to the processor. In some embodiments the system may further include a second subterranean location operably connected to the processor. In some embodiments the system may include a pump configured for transferring a subterranean brine from the second subterranean location to the processor. The first and second subterranean locations may be the same or different. In some embodiments the processor may be configured to contact an aqueous mixture that is a liquid or a slurry. In some embodiments the processor may be configured to produce a reaction product comprising liquids and solids. In some embodiments the system may also include a liquid-solid separator for concentrating the reaction product mixture that is operably connected to the processor and the first conduit. In some embodiments the system may also include a first pump for pumping the product mixture to the first subterranean location. In some embodiments the pump may be configured to provide no more than 2 bars of pressure. In some embodiments the first subterranean location is a depleted petroleum reservoir, or a coal deposit. In some embodiments the rock above the first subterranean location may have a porosity greater that 1%. In some embodiments the first subterranean location may be a geological formation is a saline aquifer. In some embodiments the industrial waste gas comprising carbon dioxide may be provided by a power plant, a steam fossil fuel reformer, a cement plant, a smelter, or a liquefied natural gas plant.

In some embodiments methods of this invention provide for obtaining a reaction product comprising at least 0.0103 mol/cm³ of carbon and a subterranean brine from a first subterranean location, and sequestering some or all of the reaction product in a second subterranean location. The reaction product may comprise water carbonic acid, bicarbonate, or carbonate or a combination thereof. In some embodiments the first and second subterranean location are the same location. In some embodiments the first and second subterranean location are less than 100 surface miles away from each other. In some embodiments reaction product may be a slurry comprising a liquid and a solid. In some embodiments the methods of this invention may include separating some or all of the liquid from the solid. In some embodiments separating the liquid from the solid may create a slurry comprising between 15% and 50% solids by weight or between 40% and 50% solids by weight.

In some embodiments the invention provides methods for assessing a region for suitability of sequestering carbon dioxide. The methods may include creating a representation (e.g., a map) of the region comprising a combination of physical data wherein the physical data comprises data indicative of the presence or absence of sources either of divalent cations or alkalinity and anthropogenic data comprising data indicative of the presence or absence of sources of anthropogenic carbon dioxide, and determining the proximity of sources either of divalent cations or alkalinity to sources of anthropogenic carbon dioxide. In some embodiments, the physical data comprises geographical, lithographical, hydrological, seismic data or the combination thereof. In some embodiments, the source of anthropogenic carbon is a power plant, cement plant or smelter. In some embodiments, the representation of the region further comprises data indicative of the legal status of water rights, mineral rights or a combination thereof. In some embodiments, the physical data about the region comprises lithographic data indicating the presence and/or abundance of calcium. In some embodiments, the physical data about the region comprises seismic data indicating the presence and/or abundance of permeable rock. In some embodiments, physical data about the region further comprises hydrological data indicating the presence or absence of a subterranean brine. In some embodiments, the representation of the region comprises data indicating the proximity of the subterranean brine to the source of anthropogenic carbon dioxide. In some embodiments, the proximity of the source of anthropogenic carbon dioxide to the subterranean brine is less than five surface miles. In some embodiments, the method includes generating new physical data about the region, such as drilling a well. In some embodiments new data may be acquired by seismic, infrared, geophysical tomographic, magnetic, robotic, aerial, or ground mapping methods or any combination thereof.

Methods are provided for determining the probability that a subterranean brine in a region is suitable for the absorption of gaseous carbon dioxide and/or a reaction with an aqueous solution comprising dissolved carbon dioxide, carbonic acid, carbonate, or bicarbonate or any combination thereof. In some embodiments the method comprises determining one or more properties of the subterranean brine, contacting the subterranean brine with carbon dioxide and or the aqueous solution. In some embodiments, determining the probability comprises programming a computer. In some embodiments, the reaction is a precipitation reaction. In some embodiments, the reaction is a deprotonation reaction. In some embodiments, the method includes pursuing beneficial use rights to the subterranean brine in the region. In some embodiments, determining the probability comprises determining the proximity of the subterranean brine to a source of anthropogenic carbon dioxide. In some embodiments, one or more properties may be determined remotely. In some embodiments, determining the properties comprises determining the concentration of one or more divalent cations (e.g., Ca⁺²) in the subterranean brine. In some embodiments, the Ca⁺² concentration of the subterranean brine may be between 100 ppm and 100,000 ppm. In some embodiments the properties comprises determining the alkalinity of the brine. In some embodiments the subterranean brine may have an alkalinity between 100 and 2000 mEq/l. In some embodiments the property comprise the identity or the concentration of compounds contributing to the alkalinity. In some embodiments the property may be the temperature of the brine. In some embodiments the method includes quantifying borate, carbonate or hydroxyl components or any combination thereof of the brine. In some embodiments the method includes the property of the brine comprises the ionic strength of the subterranean brine. In some embodiments the method includes adjusting the brine composition based on a desired reaction product of the subterranean brine and the gaseous carbon dioxide or the aqueous solution. In some embodiments the method includes adjusting the brine composition above the ground level or below ground level. In some embodiments the method may include adjusting the ratio of Mg²⁺ to Ca²⁺ present in the brine (e.g., a final Mg²⁺:Ca²⁺ ratio of between 1:1 and 1:1000). In some embodiments adjusting the composition comprises raising the pH of the brine. In some embodiments adjusting the composition comprises precipitating one or more unwanted species in the brine. In some embodiments adjusting the composition comprises diluting the brine with water. In some embodiments adjusting the composition comprises concentrating the brine.

Methods are described for determining the source of components of a carbon containing reaction product. In some embodiments the methods may include creating a first profile of a carbon containing reaction product and obtaining a second profile of a subterranean brine. The methods may further include comparing the first profile to the second profile to determine whether the carbon containing product was made with the brine. In some embodiments one or more of the steps for determining the source of components is performed on a computer. In some embodiments creating the first profile comprises one or more operations that physically transform at least a portion of the reaction product. In some embodiments the first and second profiles comprise ratios of elements selected from the group of strontium, barium, iron, boron, lithium, rhodium, arsenic, and neodymium. In some embodiments the first and second profiles comprises the same organic compound. In some embodiments the first profile may comprise a measurable amount of a particular crystalline polymorph and the second physical profile may comprise an organic compound.

Systems of this invention are described that include a source of one or more subterranean brines and a source of a carbon dioxide and a detector configured for determining the composition of the one or more subterranean brines. In some embodiments, systems may also include a reactor for adjusting the composition of the one or more subterranean brines, wherein the reactor is operably connected to the source of one or more subterranean brines and the source of carbon dioxide and wherein the detector is operably connected to the reactor. In some embodiments the reactor may be configured to mix the one or more brines to a desired ratio. In some embodiments the reactor may be configured to adjust the composition of the one or more brines. In some embodiments the reactor may be configured to dilute the one or more brines with water. In some embodiments the reactor may be configured to concentrate the one or more brines by removing water.

Methods of the invention disclosed here include contacting CO₂ with a subterranean brine to produce a first reaction product comprising carbonic acid, bicarbonate, or carbonate or a mixture thereof and placing the reaction product in a subterranean location and/or producing a solid material from the reaction product. In some embodiments the reaction product is a liquid, such as a clear liquid. In some embodiments the method includes contacting CO₂ with an aqueous mixture to produce a first reaction product comprising carbonic acid, bicarbonate, or carbonate or mixture thereof and contacting the first reaction product with a subterranean brine to produce a second reaction product. The second reaction product may be placed in an underground location and/or a solid material may be produced from the second reaction product. In some embodiments the method comprises placing a first amount of the reaction product in the underground location and producing the solid product from a second amount of reaction product. The subterranean brine of this invention may comprise one or more proton removing agents (e.g., organic base, borate, sulfate, carbonate or nitrate). In some embodiments the brines of this invention may comprises 10% w/v or 25% w/v or greater of carbonate. In some embodiments, geothermal energy may be utilized to dry the solid material of this invention or to produce the reaction product. In some embodiments geothermal energy may be used to generate a proton removing reagent for producing the first reaction product. The geothermal energy may be derived from the subterranean brine used for methods and compositions of this invention. In some embodiments method of this invention may include obtaining brines from a subterranean location that is 100 meters or more below ground level. In some embodiments method of this invention may include obtaining brines derived from a concentrated waste water stream. In some embodiments CO₂ contacted during methods of this invention may be contacted at or above ground level. In some embodiments the methods of this invention may further include adjusting the composition of the brine before or at the same time as contacting the brine with CO₂. Adjusting the composition of the brine may comprise increasing the concentration of carbonate in the brine or dilution the brine. Methods of this invention may comprise a single source of gas. In some embodiments the gas may comprise an industrial gaseous waste stream comprising CO₂. The industrial gaseous waste stream may be flue gas a power plant, a cement plant, a foundry, a refinery or a smelter. Methods of this invention may utilize CO₂ from a supercritical fluid. Subterranean brine of this invention may or may not be co-located at a hydrocarbon deposit.

Systems of this invention may comprise a first source of one or more brines and a source of CO₂ operably connected to one or more reactors for contacting the brine with CO₂ to produce reaction product comprising carbonic acid, carbonate, or bicarbonate, or a combination thereof. The system may be a first conduit configured to place the reaction product in a first subterranean location and/or an apparatus to produce a carbonate-containing solid material from the reaction product. In some embodiments the system is configured to only receive gases comprising CO₂ at levels greater than that found in the atmosphere. In some embodiments the system may comprise a control station configured to regulate the amount of reaction product that is placed in the first subterranean location and the amount of reaction product employed to produce a carbonate-containing precipitation material. In some embodiments the system comprises a second conduit to a second source of brine second at a subterranean location. The first and second subterranean locations may or may not be the same location. In some embodiments, the system is configured to receive a source of CO₂ that is a gaseous waste stream. The gaseous waste stream may be provided by a conduit coupled to a source selected from the group consisting of a power plant, a cement plant, a foundry, a refinery and smelter. In some embodiments the system is configured to receive a source of CO₂ that is a supercritical fluid. In some embodiments the system is configure with one or more conduits for conveying the bicarbonate composition to the first subterranean location.

In some embodiments the invention discloses a carbonate-containing solid material comprising carbon wherein the carbon has a δ¹³C of −10‰ or less and at least one rare earth element. In some embodiments the invention discloses a carbonate-containing solid material comprising carbon wherein the carbon has a δ¹³C of −10‰ or less and at least one alkaline earth metal. The material of this invention may comprise vaterite, aragonite, amorphous calcium carbonate or a combination thereof. In some embodiments the material further comprises a second rare earth element. In some embodiments the material further comprises a second alkaline earth metal. In some embodiments material comprises strontium, barium, iron, arsenic, selenium, mercury or a combination thereof in an amount that is indicative of a subterranean brine origin. In some embodiments the material has a calcium to magnesium (Ca/Mg) molar ratio that is between 200/1 and 15/1. In some embodiments the material has a calcium to magnesium (Ca/Mg) molar ratio is between 100/1 and 50/1. In some embodiments material comprises an isotopic composition that is indicative of a subterranean brine origin. In some embodiments material comprises strontium-87 and strontium-86 wherein the strontium-87 to strontium-86 (⁸⁷Sr/⁸⁶Sr) ratio is between 0.71/1 and 0.80/1. In some embodiments material comprises oxygen wherein the oxygen isotope has a δ¹⁸O value that is between −14.0‰ and −21.0‰. In some embodiments material comprises a composition is indicative of a mixture of more than one subterranean brine.

Aspects of this invention include cementitious compositions comprising carbonate, bicarbonate, or mixture thereof and one or more elements selected from the group consisting of aluminum, barium, cobalt, copper, iron, lanthanum, lithium, mercury, arsenic, cadmium, lead, nickel, phosphorus, scandium, titanium, zinc, zirconium, molybdenum, and selenium, wherein the composition upon combination with water; setting; and hardening has a compressive strength of at least 14 MPa. In some embodiments the one or more elements are selected from the group consisting of lanthanum, mercury, arsenic, lead, and selenium. In some embodiments each of the one or more elements are present in the composition in an amount of between 0.5-1000 ppm. In some embodiments the one or more elements are arsenic, mercury, or selenium. In some embodiments the one or more elements are present in the composition in an amount of between 0.5-100 ppm. In some embodiments after setting and hardening, the cementitious composition has the compressive strength in a range of 14-80 MPa. In some embodiments after setting and hardening the composition has the compressive strength in a range of 20-40 MPa. In some embodiments the composition is a particulate composition with an average particle size of 0.1-100 microns. In some embodiments the composition is a particulate composition with an average particle size of 1-10 microns. In some embodiments the composition further comprises Portland cement clinker, aggregate, supplementary cementitious material (SCM), or combination thereof. In some embodiments the composition is in a dry powdered form. In some embodiments the carbon in the composition has the δ¹³C of between 0.1‰ to 25‰. In some embodiments the composition the carbon in the composition has a δ¹³C of between 3‰ to 20‰. In some embodiments the composition comprises calcium carbonate, calcium bicarbonate, or mixture thereof. In some embodiments the carbon of the composition is derived entirely from a carbonate brine resource.

Aspects of this invention include methods for contacting a source of cation with a carbonate brine to give a reaction product comprising carbonic acid, bicarbonate, carbonate, or mixture thereof. In some embodiments the method includes a reaction product that does not comprise carbon from flue gas. In some embodiments the method further comprises placing the reaction product in a subterranean location. In some embodiments the method further comprises producing a solid material from the reaction product. In some embodiments the method further comprises placing a portion of the reaction product in a subterranean location and using another portion of the reaction product to produce a solid material. In some embodiments the source of cation is an aqueous solution containing an alkaline earth metal ion. In some embodiments the alkaline earth metal ion is calcium ion or magnesium ion. In some embodiments the source of cation has an alkaline earth metal ion in an amount of 1% to 90% by wt. In some embodiments the source of cation has calcium ion in an amount of 1% to 90% by wt. In some embodiments the source of cation is seawater. In some embodiments the carbonate brine is a subterranean brine. In some embodiments the carbonate brine comprises 5% to 95% carbonate by wt. In some embodiments the carbonate brine comprises 5% to 75% carbonate by wt. In some embodiments the method further comprises a proton removing agent. In some embodiments the proton removing agent is an industrial waste selected from the group consisting of fly ash, bottom ash, cement kiln dust, slag, red mud, mining waste, and combination thereof.

Aspects of this invention include a system, comprising an input for a source of cation, an input for a carbonate brine, and a reactor connected to the inputs of step (a) and step (b) that is configured to give a reaction product comprising carbonic acid, bicarbonate, carbonate, or mixture thereof.

### DESCRIPTION

### Drawings

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 depicts a process of the invention for contacting a subterranean brine with a carbon containing material.

FIG. 2 depicts a process where carbon dioxide and an aqueous solution are input materials and a gas depleted of CO₂, and carbon containing product materials are produced.

FIG. 3 depicts a process wherein a carbon dioxide-containing gas and a proton removing agent are input materials and a gas depleted of CO₂, a solid product and a supernatant solution are output products.

FIG. 4 depicts a process where a carbon dioxide-containing gas and a proton removing agent are input materials and a gas depleted of CO₂, a divalent cation is added, and a solid product and a supernatant solution are output products.

FIG. 5 depicts a process wherein product materials may be sequestered in an underground location.

FIG. 6 depicts an embodiment of a process of this invention.

FIG. 7 shows a graph of carbon dioxide densities of various carbonate and bicarbonate slurries versus percent solids, wherein the solids comprise only the carbonates and bicarbonates indicated.

FIG. 8 depicts a method of the invention for determining an identifiable brine profile.

Before the invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrequited number may be a number, which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the invention, representative illustrative methods and materials are now described.

All publications, patents, and patent applications mentioned in this specification are incorporated herein by reference to the same extent as if each individual publication, patent, or patent application was specifically and individually indicated to be incorporated by reference. Furthermore, each cited publication, patent, or patent application is incorporated herein by reference to disclose and describe the subject matter in connection with which the publications are cited. The citation of any publication is for its disclosure prior to the filing date and should not be construed as an admission that the invention described herein is not entitled to antedate such publication by virtue of prior invention. Further, the dates of publication provided may be different from the actual publication dates, which may need to be independently confirmed.

It is noted that, as used herein and in the appended claims, the singular forms “a”, “an”, and “the” include plural references unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the invention. Any recited method can be carried out in the order of events recited or in any other order, which is logically possible.

The invention provides systems methods and compositions directed detection, evaluation and use of subterranean brines; and in many embodiments, the invention includes contacting such brines with CO₂ for example from an industrial source. Some embodiments of this invention provide for sequestration of carbon dioxide in a subterranean location (e.g., geological formation). Some embodiments of this invention provide for methods and systems for a assessing a region for the presence of subterranean brine suitable for reaction with CO₂ or an aqueous solution of dissolved carbon dioxide, carbonic acid, or bicarbonate, or any combination thereof. Some embodiments of this invention provide for methods and systems for assessing the reactants and products of reactions between subterranean brines and CO₂ or an aqueous solution of dissolved carbon dioxide, carbonic acid, or bicarbonate, or any combination thereof. Some embodiments of this invention provide for methods and systems for reacting subterranean brines with CO₂ or an aqueous solution of dissolved carbon dioxide, carbonic acid, carbonate, or bicarbonate, or any combination thereof. As described further herein, CO₂ from a CO₂-containing gas may be converted to a composition comprising carbonic acid, bicarbonate, carbonate, or a mixture thereof, which may then be stored in a subterranean location. Embodiments of the invention utilize a source of CO₂, a source of proton-removing agents (and/or methods of effecting proton removal), and optionally a source of divalent cations. As such, carbon dioxide sources, divalent cation sources, and sources of proton-removing will first be described in a section on materials. Subterranean brines may be utilized as proton removing agents or sources of divalent cations or both, or any other reagent desired for reaction with CO₂ or a waste gas. Methods by which the materials may be used to practice the invention are described in a following section on methods. Systems upon which methods of the invention are practiced are likewise described in a subsequent section on systems. Compositions resulting from methods and systems of the invention are described in a following section on compositions. The invention further provides business methods for creating, storing, or creating and storing compositions of the invention, as well as for obtaining tradable commodities. Subject matter is organized as a convenience to the reader and in no way limits the scope of the invention.

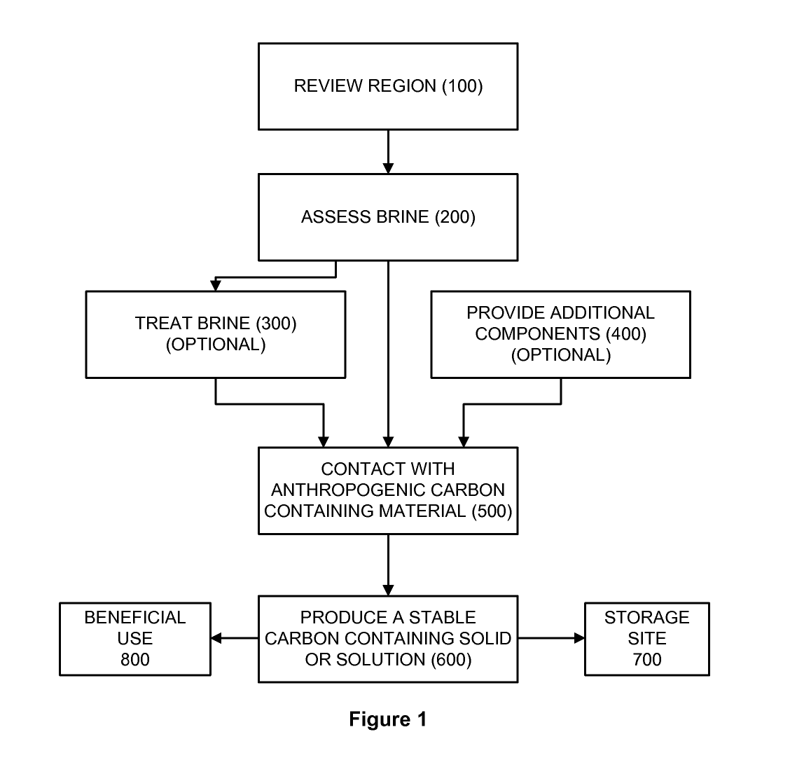

FIG. 1 illustrates some aspects of this invention. In further describing the subject invention, the methods of assessing a region for probability of finding a suitable subterranean brine (100), and methods of assessing a subterranean brine (200) according to embodiments of the invention are described first in greater detail. Methods of optionally adjusting the properties of a brine (300) and providing additional components (400) for reaction with an anthropogenic carbon containing material (e.g., waste gas, supercritical CO₂, aqueous solution comprising carbonate, and/or bicarbonate) (500) are described. Next, systems that find use in practicing various embodiments of the methods of the invention are reviewed. Compositions produced by practicing methods of the subject invention are also described (600). Compositions may be stably stored in a subterranean location (700) or transformed into a product for beneficial use (800).

Materials

Carbon Dioxide

Methods of the invention include contacting a volume of a solution with a source of CO₂ to form a composition comprising water, carbonic acids, bicarbonates, or carbonates, or any combination thereof, wherein the composition is a solution, slurry, or solid material. In some embodiments, the resultant solution is prepared for injection into a subterranean location. In some embodiments, the resultant solution is subjected to conditions that induce precipitation of a precipitation material. The source of CO₂ may be any convenient source in any convenient form including, but not limited to, a gas, a liquid, a solid (e.g., dry ice), a supercritical fluid, and CO₂ dissolved in a liquid. In some embodiments, the CO₂ source is a gaseous CO₂ source. The gaseous stream may be substantially pure CO₂ or comprise multiple components that include CO₂ and one or more additional gases and/or other substances such as ash and other particulate material. In some embodiments, the gaseous CO₂ source is a waste feed (i.e., a by-product of an active process of the industrial plant) such as exhaust from an industrial plant. The nature of the industrial plant may vary, the industrial plants of interest including, but not limited to, power plants, chemical processing plants, mechanical processing plants, refineries, cement plants, smelters, steel plants, and other industrial plants that produce CO₂ as a by-product of fuel combustion or another processing step (such as calcination by a cement plant).

Waste gas streams comprising CO₂ include both reducing (e.g., syngas, shifted syngas, natural gas, hydrogen and the like) and oxidizing condition streams (e.g., flue gases from combustion). Particular waste gas streams that may be convenient for the invention include oxygen-containing combustion industrial plant flue gas (e.g., from coal or another carbon-based fuel with little or no pretreatment of the flue gas), turbo charged boiler product gas, coal gasification product gas, shifted coal gasification product gas, anaerobic digester product gas, wellhead natural gas stream, reformed natural gas or methane hydrates, and the like. Combustion gas from any convenient source may be used in methods and systems of the invention. In some embodiments, combustion gases in post-combustion effluent stacks of industrial plants such as power plants, cement plants, smelters, and coal processing plants is used.

Thus, the waste streams may be produced from a variety of different types of industrial plants. Suitable waste streams for the invention include waste streams produced by industrial plants that combust fossil fuels (e.g., coal, oil, natural gas) or anthropogenic fuel products of naturally occurring organic fuel deposits (e.g., tar sands, heavy oil, oil shale, etc.). In some embodiments, a waste stream suitable for systems and methods of the invention is sourced from a coal-fired power plant, such as a pulverized coal power plant, a supercritical coal power plant, a mass burn coal power plant, a fluidized bed coal power plant. In some embodiments, the waste stream is sourced from gas or oil-fired boiler and steam turbine power plants, gas or oil-fired boiler simple cycle gas turbine power plants, or gas or oil-fired boiler combined cycle gas turbine power plants. In some embodiments, waste streams produced by power plants that combust syngas (i.e., gas that is produced by the gasification of organic matter, for example, coal, biomass, etc.) are used. In some embodiments, waste streams from integrated gasification combined cycle (IGCC) plants are used. In some embodiments, waste streams produced by Heat Recovery Steam Generator (HRSG) plants are used to produce compositions in accordance with systems and methods of the invention.

Waste streams produced by cement plants are also suitable for systems and methods of the invention. Cement plant waste streams include waste streams from both wet process and dry process plants, which plants may employ shaft kilns or rotary kilns, and may include pre-calciners. These industrial plants may each burn a single fuel, or may burn two or more fuels sequentially or simultaneously.

While industrial waste gas streams suitable for use in the invention contain carbon dioxide, such waste streams may, especially in the case of power plants that combust carbon-based fuels (e.g., coal), contain additional components such as water (e.g., water vapor), CO, NOₓ (mononitrogen oxides: NO and NO₂), SO_{X} (monosulfur oxides: SO, SO₂ and SO₃), VOC (volatile organic compounds), heavy metals and heavy metal-containing compounds (e.g., mercury and mercury-containing compounds), and suspended solid or liquid particles (or both). Additional components in the gas stream may also include halides such as hydrogen chloride and hydrogen fluoride; particulate matter such as fly ash, dusts (e.g., from calcining), and metals including arsenic, beryllium, boron, cadmium, chromium, chromium VI, cobalt, lead, manganese, mercury, molybdenum, selenium, strontium, thallium, and vanadium; and organics such as hydrocarbons, dioxins, and polycyclic aromatic hydrocarbon (PAH) compounds. Suitable gaseous waste streams that may be treated have, in some embodiments, CO₂ present in amounts of 200 ppm to 1,000,000 ppm, such as 200,000 ppm to 1000 ppm, including 200,000 ppm to 2000 ppm, for example 180,000 ppm to 2000 ppm, or 180,000 ppm to 5000 ppm, also including 180,000 ppm to 10,000 ppm. Flue gas temperature may also vary. In some embodiments, the temperature of the flue gas is from 0° C. to 2000° C., such as from 60° C. to 700° C., and including 100° C. to 400° C.

Cations

Methods of the invention include contacting a volume of a cation-containing (e.g., Na⁺, K⁺, Ca²⁺, Mg²⁺, etc.) solution with a source of CO₂ to form a reaction product mixture comprising carbonic acids, bicarbonates, carbonates, or mixtures thereof, wherein the product mixture is a solution, slurry, or a solid material. In other embodiments of this invention a cation solution may be contacted with an aqueous solution (e.g., a clear liquid) or slurries containing carbonic acid, dissolved CO₂, bicarbonate, carbonate or any combinations thereof to form a reaction product mixture. In some embodiments, the resultant mixtures may be prepared for injection into a subterranean location. In some embodiments, the resultant mixture is subjected to conditions that induce precipitation of a precipitation material. Cations, as described below, may come from any of a number of different cation sources depending upon availability at a particular location. Divalent cations (e.g., alkaline earth metal cations such as Ca²⁺ and Mg²⁺), which are useful for producing precipitation material of the invention, may be found in industrial wastes, seawater, brines, hard water, minerals, and many other suitable sources.

In some locations, industrial waste streams from various industrial processes provide for convenient sources of cations (as well as in some cases other materials useful in the process, e.g., metal hydroxide). Such waste streams include, but are not limited to, mining wastes; fossil fuel burning ash (e.g., fly ash, bottom ash, boiler slag); slag (e.g., iron slag, phosphorous slag); cement kiln waste (e.g., cement kiln dust); oil refinery/petrochemical refinery waste (e.g., oil field and methane seam brines); coal seam wastes (e.g., gas production brines and coal seam brine); paper processing waste; water softening waste brine (e.g., ion exchange effluent); silicon processing wastes; agricultural waste; metal finishing waste; high pH textile waste; and caustic sludge.

In some locations, a convenient source of cations for use in systems and methods of the invention is water (e.g., an aqueous solution comprising cations such as seawater or subterranean brine), which may vary depending upon the particular location at which the invention is practiced. Suitable aqueous solutions of cations that may be used include solutions comprising one or more divalent cations, e.g., alkaline earth metal cations such as Ca²⁺ and Mg²⁺. In some embodiments, the aqueous source of cations comprises alkaline earth metal cations. In some embodiments, the alkaline earth metal cations include calcium, magnesium, or a mixture thereof. In some embodiments, the aqueous solution of cations comprises calcium in amounts ranging from 50 to 50,000 ppm, 50 to 40,000 ppm, 50 to 20,000 ppm, 100 to 10,000 ppm, 200 to 5000 ppm, 1000 to 50,000 ppm, or 400 to 1000 ppm. The aqueous solution of cations may comprise cations derived from freshwater, brackish water, seawater, or brine (e.g., naturally occurring subterranean brines or anthropogenic subterranean brines such as geothermal plant wastewaters, desalination plant waste waters), as well as other salines having a salinity that is greater than that of freshwater, any of which may be naturally occurring or anthropogenic. Brackish water is water that is saltier than freshwater, but not as salty as seawater. Brackish water has a salinity ranging from about 0.5 to about 35 ppt (parts per thousand). Seawater is water from a sea, an ocean, or any other saline body of water that has a salinity ranging from about 35 to about 50 ppt. Brine may be a water saturated or nearly saturated with salt. Brine may have a salinity that is about 50 ppt or greater. In some embodiments, the saltwater source from which cations are derived is a naturally occurring source selected from a sea, an ocean, a lake, a swamp, an estuary, a lagoon, a surface brine, a subterranean brine, an alkaline lake, an inland sea, or the like. In some embodiments, the saltwater source from which the cations are derived is an anthropogenic brine selected from a geothermal plant wastewater or a desalination wastewater.

Freshwater is often a convenient source of cations (e.g., cations of alkaline earth metals such as Ca²⁺ and Mg²⁺). Any of a number of suitable freshwater sources may be used, including freshwater sources ranging from sources relatively free of minerals to sources relatively rich in minerals. Mineral-rich freshwater sources may be naturally occurring, including any of a number of hard water sources, lakes, or inland seas. Some mineral-rich freshwater sources such as alkaline lakes or inland seas (e.g., Lake Van in Turkey) also provide a source of pH-modifying agents. Mineral-rich freshwater sources may also be anthropogenic. For example, a mineral-poor (soft) water may be contacted with a source of cations such as alkaline earth metal cations (e.g., Ca²⁺, Mg²⁺, etc.) to produce a mineral-rich water that is suitable for methods and systems described herein. Cations or precursors thereof (e.g., salts, minerals) may be added to freshwater (or any other type of water described herein) using any convenient protocol (e.g., addition of solids, suspensions, or solutions). In some embodiments, divalent cations selected from Ca²⁺ and Mg²⁺ are added to freshwater. In some embodiments, monovalent cations selected from Na⁺ and K⁺ are added to freshwater. In some embodiments, freshwater comprising Ca²⁺ is combined with magnesium silicates (e.g., olivine or serpentine), or products or processed forms thereof, yielding a solution comprising calcium and magnesium cations.

Many minerals provide sources of cations and, in addition, some minerals are sources of base. Divalent cation-containing minerals include mafic and ultramafic minerals such as olivine, serpentine, and other suitable minerals, which may be dissolved using any convenient protocol. In some embodiment, cations such as calcium may be provided for methods and compositions of this invention from arkosic sands. In some embodiment, cations such as calcium may be provided for methods and compositions of this invention from feldspars such as anorthite. Cations may be obtained directly from mineral sources or from subterranean brines high in calcium or other divalent cations. Other minerals such as wollastonite may also be used. Dissolution may be accelerated by increasing surface area, such as by milling by conventional means or by, for example, jet milling, as well as by use of, for example, ultrasonic techniques. In addition, mineral dissolution may be accelerated by exposure to acid or base. Metal silicates (e.g., magnesium silicates) and other minerals comprising cations of interest may be dissolved, for example, in acid such as HCl (optionally from an electrochemical process) to produce, for example, magnesium and other metal cations for use in compositions of the invention. In some embodiments, magnesium silicates and other minerals may be digested or dissolved in an aqueous solution that has become acidic due to the addition of carbon dioxide and other components of waste gas (e.g., combustion gas). Alternatively, other metal species such as metal hydroxide (e.g., Mg(OH)₂, Ca(OH)₂) may be made available for use by dissolution of one or more metal silicates (e.g., olivine and serpentine) with aqueous alkali hydroxide (e.g., NaOH) or any other suitable caustic material. Any suitable concentration of aqueous alkali hydroxide or other caustic material may be used to decompose metal silicates, including highly concentrated and very dilute solutions. The concentration (by weight) of an alkali hydroxide (e.g., NaOH) in solution may be, for example, from 10% to 80% (w/w).

In some embodiments, an aqueous solution of cations may be obtained from an industrial plant that is also providing a combustion gas stream. For example, in water-cooled industrial plants, such as seawater-cooled industrial plants, water that has been used by an industrial plant for cooling may then be used as water for producing compositions of the invention. If desired, the water may be cooled prior to entering the CO₂ processing system. Such approaches may be employed, for example, with once-through cooling systems. For example, a city or agricultural water supply may be employed as a once-through cooling system for an industrial plant. Water from the industrial plant may then be employed for producing compositions of the invention, wherein output water has a reduced hardness and greater purity. In embodiments of the invention described herein, subterranean brines may serve as a source of cations as fully described hereafter.

Proton-Removing Agents

Methods of the invention include contacting a volume of a solution with a source of CO₂ to form a product mixture comprising an aqueous composition including carbonic acid, bicarbonate, carbonate, or any combination thereof, wherein the mixture may be a solution, slurry, or a solid material. In some embodiments the solution may be alkaline. In some embodiments, the resultant product mixture is prepared for injection into a subterranean location. In some embodiments, the resultant product mixture is subjected to conditions that induce precipitation of a precipitation material. The dissolution of CO₂ into the aqueous solution of cations may produce carbonic acid, a species in equilibrium with both bicarbonate and carbonate. In order to produce some compositions of the invention, protons may be removed from various species (e.g., carbonic acid, bicarbonate, hydronium, etc.) in the solution to shift the equilibrium toward bicarbonate or carbonate. As protons are removed, more CO₂ goes into solution. In some embodiments, proton-removing agents and/or methods are used while contacting a cation-containing aqueous solution with CO₂ to increase CO₂ absorption in one phase of the reaction, where the pH may remain constant, increase, or even decrease, followed by a rapid removal of protons (e.g., by addition of a base) to cause rapid formation of compositions of the invention. Protons may be removed from the various species (e.g., carbonic acid, bicarbonate, hydronium, etc.) by any convenient approach, including, but not limited use of waste sources of metal oxides such as combustion ash (e.g., fly ash, bottom ash, boiler slag), cement kiln dust, and slag (e.g., Iron slag, phosphorous slag), use of naturally occurring proton-removing agents, use of microorganisms and fungi, use of synthetic chemical proton-removing agents, recovery of man-made waste streams, alkaline brines, electrochemical means, and combinations thereof.

Naturally occurring proton-removing agents encompass any proton-removing agents that can be found in the wider environment that may create or have a basic local environment. Some embodiments provide for naturally occurring proton-removing agents including minerals that create basic environments upon addition to solution (i.e., dissolution). Such minerals include, but are not limited to lime (CaO); periclase (MgO); volcanic ash; ultramafic rocks and minerals such as serpentine; and iron hydroxide minerals (e.g., goethite and limonite). Some embodiments provide for using naturally alkaline bodies of water as naturally occurring proton-removing agents. Examples of naturally alkaline bodies of water include, but are not limited to surface water sources (e.g., alkaline lakes such as Mono Lake in California) and ground water sources (e.g., basic aquifers). Other embodiments provide for use of deposits from dried alkaline bodies of water such as the crust along Lake Natron in Africa's Great Rift Valley. In some embodiments, organisms that excrete basic molecules or solutions in their normal metabolism are used as proton-removing agents. Examples of such organisms are fungi that produce alkaline protease (e.g., deep-sea fungus Aspergillus ustus with an optimal pH of 9) and bacteria that create alkaline molecules (e.g., cyanobacteria such as Lyngbya sp. from the Atlin wetlands in British Columbia) which increase pH from a byproduct of photosynthesis. In some embodiments, organisms are used to produce proton-removing agents, wherein the organisms (e.g., Bacillus pasteurii, which hydrolyzes urea to ammonia) metabolize a contaminant (e.g., urea) to produce proton-removing agents or solutions comprising proton-removing agents (e.g., ammonia, ammonium hydroxide). In some embodiments, organisms are cultured separately from the reaction mixture used to produce compositions of the invention, wherein proton-removing agents or solutions comprising proton-removing agents are used for addition to the reaction mixture. In some embodiments, naturally occurring or manufactured enzymes are used in combination with other proton-removing agents to produce compositions of the invention. Carbonic anhydrase, which is an enzyme produced by plants and animals, accelerates transformation of carbonic acid to bicarbonate in aqueous solution. As such, carbonic anhydrase may be used to accelerate production of compositions of the invention.

Chemical agents for effecting proton removal generally refer to synthetic chemical agents that are produced in large quantities and are commercially available. For example, chemical agents for removing protons include, but are not limited to, hydroxides, organic bases, super bases, oxides, ammonia, and carbonates. Hydroxides include chemical species that provide hydroxide anions in solution, including, for example, sodium hydroxide (NaOH), potassium hydroxide (KOH), calcium hydroxide (Ca(OH)₂), or magnesium hydroxide (Mg(OH)₂). Organic bases are carbon-containing molecules that are generally nitrogenous bases including primary amines such as methyl amine, secondary amines such as diisopropylamine, tertiary amines such as diisopropylethylamine, aromatic amines such as aniline, heteroaromatics such as pyridine, imidazole, and benzimidazole, and various forms thereof. In some embodiments, an organic base selected from pyridine, methylamine, imidazole, benzimidazole, histidine, and a phophazene is used to remove protons from various species (e.g., carbonic acid, bicarbonate, hydronium, etc.) for producing compositions of the invention. In some embodiments, ammonia is used to raise pH to a sufficient level for producing compositions of the invention. Super bases suitable for use as proton-removing agents include sodium ethoxide, sodium amide (NaNH₂), sodium hydride (NaH), butyl lithium, lithium diisopropylamide, lithium diethylamide, and lithium bis(trimethylsilyl)amide. Carbonates for use in the invention include, but are not limited to, sodium carbonate. Metal oxides including, for example, calcium oxide (CaO), magnesium oxide (MgO), strontium oxide (SrO), beryllium oxide (BeO), barium oxide (BaO), etc.) or is a metal hydroxide (e.g., sodium hydroxide (NaOH), potassium hydroxide (KOH), calcium hydroxide (Ca(OH)2), magnesium hydroxide (Mg(OH)₂, etc are also suitable proton-removing agents that may be used. In some embodiments, such metal oxides may also be obtained from waste sources such as combustion ash (e.g., fly ash, bottom ash, boiler slag), cement kiln dust, and slag (e.g., iron slag, phosphorous slag). In some embodiments, wastes from mining are used to modify pH, wherein the waste is selected from red mud from the Bayer aluminum extraction process; waste from magnesium extraction from sea water (e.g., Mg(OH)₂ such as that found in Moss Landing, Calif.); and wastes from mining processes involving leaching. For example, red mud may be used to modify pH as described in U.S. patent application Ser. No. 12/716,235 titled “Neutralizing Industrial Wastes Utilizing CO₂ And a Divalent Cation Solution,” filed 2 Mar. 2010, which is incorporated herein by reference in its entirety. Agricultural waste, either through animal waste or excessive fertilizer use, may contain potassium hydroxide (KOH) or ammonia (NH₃) or both. As such, agricultural waste may be used in some embodiments of the invention as a proton-removing agent source. This agricultural waste is often collected in ponds, but it may also percolate down into aquifers, where it can be accessed and used.

Electrochemical methods are another means to remove protons from various species in a solution, either by removing protons from solute (e.g., deprotonation of carbonic acid or bicarbonate) or from solvent (e.g., deprotonation of hydronium or water). Deprotonation of solvent may result, for example, if proton production from CO₂ dissolution matches or exceeds electrochemical proton removal from solute molecules. Alternatively, electrochemical methods may be used to produce caustic molecules (e.g., hydroxide) through, for example, the chlor-alkali process, or modification thereof. Electrodes (i.e., cathodes and anodes) may be present in the apparatus containing the cation-containing aqueous solution or gaseous waste stream-charged (e.g., CO₂-charged) solution, and a selective barrier, such as a membrane, may separate the electrodes. Electrochemical systems and methods for removing protons may produce by-products (e.g., hydrogen) that may be harvested and used for other purposes. Additional electrochemical approaches that may be used in systems and methods of the invention include, but are not limited to, those described in U.S. patent application Ser. No. 12/344,019, filed 24 Dec. 2008; U.S. patent application Ser. No. 12/375,632, filed 23 Dec. 2008, International Patent Application No. PCT/US08/088242, filed 23 Dec. 2008; International Patent Application No. PCT/US09/32301, filed 28 Jan. 2009; International Patent Application No. PCT/US09/48511, filed 24 Jun. 2009; U.S. patent application Ser. No. 12/541,055 filed 13 Aug. 2009; and U.S. patent application Ser. No. 12/617,005, filed 12 Nov. 2009, the disclosures of which are incorporated herein by reference in their entirety. Combinations of any of the above mentioned sources of proton-removing agents and methods for effecting proton removal may also be employed.

In some instances, the source of alkalinity of alkaline solutions of the invention is carbonate and the alkaline solution is a “high carbonate” alkaline solution. “High carbonate” alkaline solution as used herein refers to an aqueous composition which possesses carbonate in a sufficient amount so as to remove one or more protons from proton-containing species in solution such that carbonic acid is converted to bicarbonate. As such, the amount of carbonate present in alkaline solutions of the invention may be 5,000 ppm or greater, such as 10,000 ppm greater, such as 25,000 ppm or greater, such as 50,000 ppm or greater, such as 75,000 ppm or greater, including 100,000 ppm or greater. Alkalinity may also be described in terms the unit mEq/L (milliequivalent per liter). The alkalinity is equal to the stoichiometric sum of the bases in solution. In the natural environment carbonate alkalinity tends to make up most of the total alkalinity due to the common occurrence and dissolution of carbonate rocks and presence of carbon dioxide in the atmosphere. Other common natural components that can contribute to alkalinity include borate, hydroxide, phosphate, silicate, nitrate, dissolved ammonia, the conjugate bases of some organic acids and sulfide.

Brines

In some embodiments methods of the invention may utilize a subterranean brine. In some embodiments a subterranean may be contacted with carbon dioxide or aqueous solutions comprising carbonic acid, carbonate, or bicarbonate or combinations thereof to produce a reaction mixture. In some embodiments of this invention, subterranean brines may be a convenient source for divalent cations, monovalent cations, proton removing agents, or any combination thereof. The subterranean brine that is employed in embodiments of this invention may be from any suitable subterranean brine source. “Subterranean brine” as used herein includes naturally occurring or anthropogenic, concentrated aqueous saline compositions obtained from a subterranean geological location. “Concentrated aqueous saline composition” as used herein includes an aqueous solution which has a salinity of 10,000 ppm total dissolved solids (TDS) or greater, such as 20,000 ppm TDS or greater and including 50,000 ppm TDS or greater. “Subterranean geological location” as used herein includes a geological location which is located below ground level. “Ground level” as used herein includes a solid-fluid interface of the Earth's surface, such as a solid-gas interface as found on dry land where dry land meets the Earth's atmosphere, as well as a liquid-solid interface as found beneath the land at the bottom of a body of surface water (e.g., lack, ocean, stream, etc) where solid ground meets the body of water (where examples of this interface include lake beds, ocean floors, etc). As such, the subterranean location can be a location beneath land or a location beneath a body of water (e.g., oceanic ridge). For example, a subterranean location may be a deep geological alkaline aquifer or an underground well located in the sedimentary basins of a petroleum field, a subterranean metal ore, a geothermal field, or beneath an oceanic ridge, among other underground locations.

Brines may be concentrated waste streams from wastewater treatment plants. In one embodiment brines of this invention may be water resulting from dissolution of mineral sources (e.g., oil and gas exploration or extraction) that has been concentrated or otherwise treated. The waste streams from underground sources such as gas or petroleum mining may contain hydrocarbons, carbonates, cations or anions. Treatment of these waste streams to reduce hydrocarbons and the water volume may result in an aqueous mixture rich in carbonates, salinity, alkalinity or any combination thereof. This aqueous mixture may be used to sequester carbon dioxide or may be used in precipitation reactions including precipitating carbonic acid, bicarbonate, or carbonates from an aqueous solution.

The subterranean location may be a location that 100 m or deeper below ground level, such as 200 m or deeper below ground level, such as 300 m or deeper below ground level, such as 400 m or deeper below ground level, such as 500 m or deeper below ground level, such as 600 m or deeper below ground level, such as 700 m or deeper below ground level, such as 800 m or deeper below ground level, such as 900 m or deeper below ground level, such as 1000 m or deeper below ground level, including 1500 m or deeper below ground level, 2000 m or deeper below ground level, 2500 m or deeper below ground level and 3000 m or deeper below ground level. In some embodiments of the invention, a subterranean location is a location that is between 100 m and 3500 m below ground level, such as between 200 m and 2500 m below ground level, such as between 200 m and 2000 m below ground level, such as between 200 m and 1500 m below ground level, such as between 200 m and 1000 m below ground level and including between 200 m and 800 m below ground level. Subterranean brines of the invention may include, but are not limited to compositions commonly known as oil-field brines, basinal brines, basinal water, pore water, formation water, and deep sea hypersaline waters, among others.

Subterranean brines used in the methods, systems and compositions of this invention may be subterranean aqueous saline compositions and in some embodiments, may have circulated through crustal rocks and become enriched in substances leached from the surrounding mineral. As such, the composition of subterranean brines may vary. In some embodiments, the subterranean brines may contain one or more cations. The cations may be monovalent cations, such as Na⁺, K⁺, etc. The cations may also be divalent cations, such as Ca²⁺, Mg²⁺, Sr²⁺, Ba²⁺Mn²⁺, Zn²⁺, Fe²⁺, etc. In some instances, the divalent cations of the subterranean brine are alkaline earth metal cations, e.g., Ca²⁺, Mg²⁺. Subterranean brines of interest may have Ca²⁺ present in amounts that vary, ranging from 100 to 100,000 ppm, such as 100 to 75,000 ppm, including 5000 to 50,000 ppm, for example 1000 to 25,000 ppm. Subterranean brines of interest may have Mg²⁺ present in amounts that vary, ranging from 50 to 25,000 ppm, such as 100 to 15,000 ppm, including 500 to 10,000 ppm, for example 1000 to 5,000 ppm. In brines where both Ca²⁺ and Mg²⁺ are present, the molar ratio of Ca²⁺ to Mg²⁺ (i.e., Ca²⁺:Mg²⁺) in the subterranean brine may vary, and in one embodiment may range between 1:1 and 100:1. In some instance the Ca²⁺:Mg²⁺ may be between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, the molar ratio of Ca²⁺ to Mg²⁺ in subterranean brines of interest may range between 1:1 and 1:10; 1:5 and 1:25; 1:10 and 1:50; 1:25 and 1:100; 1:50 and 1:500; or 1:100 and 1:1000. In some embodiments, the ratio of Mg²⁺ to Ca²⁺ (i.e., Mg²⁺:Ca²⁺) in the subterranean brine ranges between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, the ratio of Mg²⁺ to Ca²⁺ in the subterranean brines of interest may range between 1:1 and 1:10; 1:5 and 1:25; 1:10 and 1:50; 1:25 and 1:100; 1:50 and 1:500; or 1:100 and 1:1000. In particular embodiments the Mg²⁺:Ca²⁺ of a brine may be lower than 1:1, such as 1:2, 1:4, 1:10, 1:100 or lower.

In some embodiments, subterranean brines of the invention contain proton-removing agents. “Proton-removing agent” as used herein includes a substance or compound which possesses sufficient alkalinity or basicity to remove one or more protons from a proton-containing species in solution. In some embodiments, the amount of proton-removing agent is an amount such that the subterranean brine possesses a neutral pH (i.e., pH=7). In particular, the invention in some embodiments involves the removal of a proton from carbonic acid to produce bicarbonate and in some case, removal of a proton from bicarbonate to produce carbonate. For purposes of description, ‘proton removing agents’ includes those agents that under conditions described herein are capable of removing one or both protons from carbonic acid in aqueous solution. In other embodiments, the amount of proton-removing agents in the subterranean brine is an amount such that the subterranean brine is alkaline. By alkaline is meant the stoichiometric sum of proton-removing agents in the subterranean brine exceeds the stoichiometric sum of proton-containing agents. In some instances the alkalinity of the subterranean brine may be between 100 and 2000 mEq/l. In some embodiments the alkalinity of the subterranean brine may be between 500 and 1000 mEq/l. In some instances, the alkaline subterranean brine has a pH that is above neutral pH (i.e., pH>7), e.g., the brine has a pH ranging from 7.1 to 12, such as 8 to 12, such as 8 to 11, and including 9 to 11. In some embodiments, as described in greater detail below, while being basic the pH of the subterranean brine may be insufficient to cause precipitation of the carbonate-compound precipitation material. For example, the pH of the subterranean brine may be 9.5 or lower, such as 9.3 or lower, including 9 or lower.

Proton-removing agents present in subterranean brines of the invention may vary. In some embodiments, the proton-removing agents may be anions. Anions may be halides, such as Cl⁻, F⁻, I⁻ and Br⁻, among others and oxyanions, e.g., sulfate, carbonate, borate and nitrate, among others. In certain embodiments, the proton-removing agent is carbonate. The amount of sulfates present in subterranean brines of the invention may vary. In some instances, the amount of sulfate present ranges from 50 to 100,000 ppm, such as 100 to 75,000 ppm, including 500 to 50,000 ppm, for example 1500 to 20,000 ppm. The amount of carbonates present in subterranean brines of the invention may vary. In some instances, the amount of carbonate present ranges from 50 to 100,000 ppm, such as 100 to 75,000 ppm, including 500 to 50,000 ppm, for example 1000 to 25,000 ppm. As such, in certain embodiments, the proton-removing agents present in the subterranean brines may comprise 5% or more of carbonates, such about 10% or more of carbonates, including about 25% or more of carbonates, for instance about 50% or more of carbonates, such as about 75% or more of carbonates, including about 90% or more of carbonates. In certain embodiments, the proton-removing agent in a subterranean brine may be a borate ion. Borates present in subterranean brines of the invention may be any species of boron, e.g., BO₃³⁻, B₂O₅⁴⁻, B₃O₇⁵⁻, and B₄O₉⁶⁻, among others. The amount of borate present in subterranean brines of the invention may vary. In some instances, the amount of borate present ranges from 50 to 100,000 ppm, such as 100 to 75,000 ppm, including 500 to 50,000 ppm, for example 1000 to 25,000 ppm. As such, in certain embodiments, the proton removing agents present in the subterranean brines may comprise 5% or more of borates, such about 10% or more of borates, including about 25% or more of borates, for instance about 50% or more of borates, such as about 75% or more of borates, including about 90% or more of borates. Where both carbonate and borate are present, the molar ratio of carbonate to borate (i.e., carbonate:borate) in the subterranean brines may be between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, the molar ratio of carbonate to borate in subterranean brines of the invention may be between 1:1 and 1:10; 1:5 and 1:25; 1:10 and 1:50; 1:25 and 1:100; 1:50 and 1:500; or 1:100 and 1:1000. In other embodiments, the ratio of carbonate to borate (i.e., carbonate:borate) in the subterranean brine may be between 1:1 and 2.5:1; 2.5:1 and 5:1; 5:1 and 10:1; 10:1 and 25:1; 25:1 and 50:1; 50:1 and 100:1; 100:1 and 150:1; 150:1 and 200:1; 200:1 and 250:1; 250:1 and 500:1; 500:1 and 1000:1, or a range thereof. For example, the ratio of carbonate to borate in the subterranean brines of the invention may be between 1:1 and 10:1; 5:1 and 25:1; 10:1 and 50:1; 25:1 and 100:1; 50:1 and 500:1; or 100:1 and 1000:1.

In some embodiments, proton-removing agents present in subterranean brines may include an organic base. In some instances, the organic base may be a monocarboxylic acid anion, e.g., formate, acetate, propionate, butyrate, or valerate, among others. In other instances, the organic base may be a dicarboxylic acid anion, e.g., oxalate, malonate, succinate, or glutarate, among others. In other instances, the organic base may be phenolic compounds, e.g., phenol, methylphenol, ethylphenol, or dimethylphenol, among others. In some embodiments, the organic base may be a nitrogenous base, e.g., primary amines such as methyl amine, secondary amines such as diisopropylamine, tertiary amines such as diisopropylethylamine, aromatic amines such as aniline, heteroaromatics such as pyridine, imidazole, or benzimidazole, and various forms thereof. The amount of organic base present in subterranean brines of the invention may vary. In some instances, the amount of organic base present in the brine ranges from 1 to 200 mmol/liter, such as 1 to 175 mmol/liter, such as 1 to 100 mmol/liter, such as 10 to 100 mmol/liter, including 10 to 75 mmol/liter. Thus, in certain embodiments, proton removing agents present in the subterranean brines may be made up of 5% or more of organic base, such about 10% or more of organic base, including about 25% or more of organic base, for instance about 50% or more of organic base, such as about 75% or more of organic base, including about 90% or more of organic base.

In some embodiments, subterranean brines of the invention may have a bacterial content. Examples of the types of bacteria that may be present in subterranean brines include sulfur oxidizing bacteria (e.g., Shewanella putrefaciens, Thiobacillus), aerobic halophilic bacteria (e.g., Salinivibrio costicola and Halomanos halodenitrificans), high salinity bacteria (e.g., endospore-containing Bacillus and Marinococcus halophilus), among others. Bacteria may be present in subterranean brines of the invention in an amount that varies, such as where the concentration is 1×10⁸ colony forming units/ml (cfu/ml) or less, such as 5×10⁶ cfu/ml or less, such as 1×10⁵ cfu/ml or less, such as 5×10⁴ cfu/ml or less, such as 1×10³ cfu/ml or less, and including 1×10² cfu/ml or less. In some embodiments, the concentration of bacteria in the subterranean brines may depend on the temperature of the brine. For example, at temperatures greater than about 80° C., subterranean brines of the invention may have very little bacterial content, such as where the bacterial concentration is 1×10⁵ cfu/ml or less, such as 1×10⁴ cfu/ml or less, such as 5×10³ cfu/ml or less, such as 1×10³ cfu/ml or less, such as 5×10² cfu/ml or less, including 1×10² cfu/ml or less. In some embodiments, where subterranean brines have very little bacterial content, substantially (e.g., 80% or more) the entire alkalinity (i.e., basicity) of the subterranean brine may be derived from organic bases. In these embodiments, 80% or more, such as 90% or more, including 95% or more, up to 100% of the alkalinity of the subterranean brine may be derived from organic bases present in the subterranean brine. At temperatures ranging between 20-80° C., subterranean brines of the invention may have a high bacterial content. In these embodiments, the concentration of bacteria in the subterranean brine may be 1×10⁵ cfu/ml or greater, such as 5×10⁵ cfu/ml or greater, such as 1×10⁶ cfu/ml or greater, such as 5×10⁶ cfu/ml or greater, such as 8×10⁶ cfu/ml or greater, including 1×10⁷ cfu/ml or greater. In some embodiments, where subterranean brines have a high bacterial content, very little of the alkalinity (e.g., 20% or less) of the subterranean brine may be derived from organic bases. In these embodiments, 20% or less, such as 15% or less, such as 10% or less, including 5% or less of the alkalinity of the subterranean brine may be derived from organic bases present in the subterranean brine.

Subterranean brines may be found at higher temperatures and pressures than other naturally occurring bodies of water such as oceans or lakes. The internal pressures brines in subterranean formations of the invention may vary depending on the makeup of the brine as well as the depth and geographic location of the subterranean formation, e.g., ranging from 4-200 atm, such as 5 to 150 atm, such as 5 to 100 atm, such as 5 to 50 atm, such as 5 to 25 atm, such as 5 to 15 atm, and including 5 to 10 atm. In some embodiments, the subterranean brine is thermally active. The internal temperatures of subterranean brines of this invention may vary depending on the makeup of the composition as well as the depth and geographic location of the subterranean formation, ranging from −5 to 250° C., such as 0 to 200° C., such as 5 to 150° C., such as 10 to 100° C., such as 20 to 75° C., including 25 to 50° C. The elevated temperatures and pressures may be used to generate energy to drive one or more process related to the sequestration of carbon dioxide.

In some embodiments, subterranean brines of the invention may have distinct ranges or minimum or maximum levels of elements, ions, or other substances, for example, but not limited to: arsenic, chloride, lithium, sodium, sulfur, sulfide, fluoride, potassium, bromide, silicon, strontium, calcium, boron, magnesium, iron, barium and the like. In some embodiments, subterranean brines of the invention may include arsenic which may be present in certain embodiments from 10 to 500 ppm. In some embodiments, subterranean brines of the invention may include sulfide which may be present in certain embodiments from 10 to 500 ppm. In some embodiments, subterranean brines of the invention may include sulfur which may be present in certain embodiments from 1 to 10,000 ppm ranging in certain embodiments from 7000 to 8000 ppm. In some embodiments, subterranean brines of the invention may include strontium, which may be present in the subterranean brine in an amount of up to 10,000 ppm or less, ranging in certain embodiments from 3 to 10,000 ppm, such as from 5 to 5000 ppm, such as from 5 to 1000 ppm, e.g., 5 to 500 ppm, including 5 to 100 ppm. In other embodiments, subterranean brines of the invention may include barium, which may be present in the subterranean brine in an amount of up to 2500 ppm or less, ranging in certain instances from 1 to 2500 ppm, such as from 5 to 2500 ppm, such as from 10 to 1000 ppm, e.g., 10 to 500 ppm, including 10 to 100 ppm. In other embodiments, subterranean brines of the invention may include iron, which may be present in the subterranean brine in an amount of up to 5000 ppm or less, ranging in certain instances from 1 to 5000 ppm, such as from 5 to 5000 ppm, such as from 10 to 1000 ppm, e.g., 10 to 500 ppm, including 10 to 100 ppm. In other embodiments, subterranean brines of the invention may include sodium, which may be present in the subterranean brine in an amount of up to 100,000 ppm or less, ranging in certain instances from 1000 to 100,000 ppm, such as from 1000 to 10,000 ppm, such as from 1500 to 10,000 ppm, e.g., 2000 to 8000 ppm, including 2000 to 7500 ppm. In other embodiments, subterranean brines of the invention may include lithium, which may be present in the subterranean brine in an amount of up to 500 ppm or less, ranging in certain instances from 0.1 to 500 ppm, such as from 1 to 500 ppm, such as from 5 to 250 ppm, e.g., 10 to 100 ppm, including 10 to 50 ppm. In other embodiments, subterranean brines of the invention may include chloride, which may be present in the subterranean brine in an amount of up to 500,000 ppm or less, ranging in certain instances from 500 to 500,000 ppm, such as from 1000 to 250,000 ppm, such as from 1000 to 100,000 ppm, e.g., 2000 to 100,000 ppm, including 2000 to 50,000 ppm. In other embodiments, subterranean brines of the invention may include fluoride, which may be present in the subterranean brine in an amount of up to 100 ppm or less, ranging in certain instances from 0.1 to 100 ppm, such as from 1 to 50 ppm, such as from 1 to 25 ppm, e.g., 2 to 25 ppm, including 2 to 10 ppm. In other embodiments, subterranean brines of the invention may include potassium, which may be present in the subterranean brine in an amount of up to 100,000 ppm or less, ranging in certain instances from 10 to 100,000 ppm, such as from 100 to 100,000 ppm, such as from 1000 to 50,000 ppm, e.g., 1000 to 25,000 ppm, including 1000 to 10,000 ppm. In other embodiments, subterranean brines of the invention may include bromide, which may be present in the subterranean brine in an amount of up to 5000 ppm or less, ranging in certain instances from 1 to 5000 ppm, such as from 5 to 5000 ppm, such as from 10 to 1000 ppm, e.g., 10 to 500 ppm, including 10 to 100 ppm. In other embodiments, subterranean brines of the invention may include silicon, which may be present in the subterranean brine in an amount of up to 5000 ppm or less, ranging in certain instances from 1 to 5000 ppm, such as from 5 to 5000 ppm, such as from 10 to 1000 ppm, e.g., 10 to 500 ppm, including 10 to 100 ppm. In other embodiments, subterranean brines of the invention may include calcium, which may be present in the subterranean brine in an amount of up to 100,000 ppm or less, ranging in certain instances from 100 to 100,000 ppm, such as from 100 to 50,000 ppm, such as from 200 to 10,000 ppm, e.g., 200 to 5000 ppm, including 200 to 1000 ppm. In other embodiments, subterranean brines of the invention may include boron, which may be present in the subterranean brine in an amount of up to 1000 ppm or more, ranging in certain instances from 10 to 10000 ppm, such as from 100 to 5000 ppm, such as from 2000 to 2500 ppm. In other embodiments, subterranean brines of the invention may include magnesium, which may be present in the subterranean brine in an amount of up to 10,000 ppm or less, ranging in certain instances from 10 to 10,000 ppm, such as from 50 to 5000 ppm, such as from 50 to 1000 ppm, e.g., 100 to 1000 ppm, including 100 to 500 ppm.

In some embodiments, subterranean brines used in methods, compositions and systems of this invention may be obtained from a subterranean location. They may be naturally occurring or produced as a by-product of petroleum or mineral mining. In some embodiments subterranean brines may be found beneath or nearby a metal ore mine or petroleum field. Subterranean brines from any source may be rich in one or more identifiable trace elements (e.g., zinc, aluminum, lead, manganese, copper, cadmium, strontium, barium mercury, selenium, arsenic etc.) depending on the geographic features located near the brine. In embodiments where the brine is located near a mining operation, the type of metal ore mine or petroleum field and its vicinity to the subterranean location where the subterranean brine is obtained may affect the composition of the brine. In some embodiments, brine may be used in mining activities before or after its use in methods of this invention. The brine may be concentrated or otherwise processed after mining activities prior to use in methods of this invention. The concentration and identity of a trace element may provide an identifiable physical profile of a particular brine. In some embodiments, the trace metal element in the subterranean brine is zinc, which may be present in the subterranean brine in an amount of up to 250 ppm or less, ranging in certain instances from 1 to 250 ppm, such as 5 to 250 ppm, such as from 10 to 100 ppm, e.g., 10 to 75 ppm, including 10 to 50 ppm. In other embodiments, the identifying trace metal element in the subterranean brine is lead, which may be present in the subterranean brine in an amount of up to 100 ppm or less, ranging in certain instances from 1 to 100 ppm, such as 5 to 100 ppm, such as from 10 to 100 ppm, e.g., 10 to 75 ppm, including 10 to 50 ppm. In yet other embodiments, the identifying trace metal element in the subterranean brine is manganese, which may be present in the subterranean brine in an amount of up to 200 ppm or less, ranging in certain instances from 1 to 200 ppm, such as 5 to 200 ppm, such as from 10 to 200 ppm, e.g., 10 to 150 ppm, including 10 to 100 ppm. In some embodiments, the subterranean brine may have a molar ratio of different carbonates which varies, e.g., carbonates present in subterranean brines of the invention include but are not limited to carbonates of beryllium, magnesium, calcium, strontium, barium, radium or any combinations thereof.

In some embodiments, the subterranean brine may have an isotopic composition which varies which depends on the factors which influenced its formation and the location from which it is obtained. Many elements have stable isotopes, and these isotopes may be preferentially used in various processes, e.g., biological processes and as a result, different isotopes may be present in a particular subterranean brine in distinctive amounts. An example is carbon, which will be used to illustrate one example of a subterranean brine described herein. However, it will be appreciated that these methods are also applicable to other elements with stable isotopes if their ratios can be measured in a similar fashion to carbon; such elements may include nitrogen, sulfur, and boron. Methods for characterizing a composition by measuring its relative isotope composition (e.g., ^{δ13}C) is described in U.S. patent application Ser. No. 12/163,205; the disclosure of which is herein incorporated by reference. For example, the degree of water-rock exchange and the degree of mixing along fluid flow paths between water and minerals can modify the isotopic composition of the subterranean brine, in some instances the ratio of strontium-87 to strontium-86 (⁸⁷Sr/⁸⁶Sr). In one embodiment, a brine may have a high initial concentration of rubidium, such as brine found in granites formations. One aspect of this invention is that a brine may be characterized by its strontium-87 to strontium-86 ratios. In some embodiments, the strontium-87 to strontium-86 ratio of subterranean brines of the invention may be between 0.71/1 and 0.85/1, such as between 0.71/1 and 0.825/1, such as between 0.71/1 and 0.80/1, such as between 0.75/1 and 0.85/1, and including between 0.75/1 and 0.80/1. Any suitable method may be used for measuring the strontium-87 to strontium-86 ratio, methods including, but not limited to 90°-sector thermal ionization mass spectrometry.

In some embodiments, subterranean brines of the invention may have a composition which includes one or more identifying components which distinguish each subterranean brine from other subterranean brines. As such, the composition of each subterranean brine may be distinct from one another. In some embodiments, subterranean brines may be distinguished from one another by the amount and type of elements, ions or other substances present in the subterranean brine (e.g., trace metal ions, Hg, Se, As, etc.). In other embodiments, subterranean brines may be distinguished from one another by the molar ratio of carbonates present in the subterranean brine. In other embodiments, subterranean brines may be distinguished from one another by the amount and type of different isotopes present in the subterranean brine (e.g., δ¹³C, δ¹⁸O, etc.). In other embodiments, subterranean brines may be distinguished from one another by the isotopic ratio of particular elements present in the subterranean brine (e.g., ⁸⁷Sr/⁸⁶Sr). It will be appreciated that a unique brine profile for any given brine may include one or more of these identifying components.

Methods of the invention disclosed here include contacting CO₂ with a subterranean brine to produce a first reaction product comprising carbonic acid, bicarbonate, or carbonate or a mixture thereof and placing the reaction product in a subterranean location and/or producing a solid material from the reaction product. The reaction product may be a clear liquid. In some embodiments the method includes contacting CO₂ with an aqueous mixture to produce a first reaction product comprising carbonic acid, bicarbonate, or carbonate or mixture thereof and contacting the first reaction product with a subterranean brine to produce a second reaction product. The second reaction product may be placed in an underground location and/or a solid material may be produced from the second reaction product. In some embodiments the method comprises placing a first amount of the reaction product in the underground location and producing the solid product from a second amount of reaction product. The subterranean brine of this invention may comprise one or more proton removing agents (e.g., organic base, borate, sulfate, carbonate or nitrate). In some embodiments the brines of this invention may comprises 10% w/v or 25% w/v or greater of carbonate. In some embodiments, geothermal energy may be utilized to dry the solid material of this invention or to produce the reaction product. In some embodiments geothermal energy may be used to generate a proton removing reagent for producing the first reaction product. The geothermal energy may be derived from the subterranean brine used for methods and compositions of this invention. In some embodiments method of this invention may include obtaining brines from a subterranean location that is 100 meters or more below ground level. In some embodiments method of this invention may include obtaining brines derived from a concentrated waste water stream. In some embodiments CO₂ contacted during methods of this invention may be contacted at or above ground level. In some embodiments the methods of this invention may further include adjusting the composition of the brine before or at the same time as contacting the brine with CO₂. Adjusting the composition of the brine may comprise increasing the concentration of carbonate in the brine or dilution the brine. Methods of this invention may comprise a single source of gas. In some embodiments the gas may comprise an industrial gaseous waste stream comprising CO₂. The industrial gaseous waste stream may be flue gas a power plant, a cement plant, a foundry, a refinery or a smelter. Methods of this invention may utilize CO₂ from a supercritical fluid. Subterranean brine of this invention may or may not be co-located at a hydrocarbon deposit.

Methods and Compostions

Methods of Treating a Subterranean Brine

Aspects of the invention include methods of adjusting the composition of a subterranean based on a desired reaction product of the brine and either gaseous carbon dioxide or an aqueous solution comprising carbonic acid, dissolved carbon dioxide, carbonate, or bicarbonate or any combination thereof. “Altering the composition” as referred to herein includes modifying the subterranean brine such that the brine is changes in some desirable way. Treating a brine to alter the composition or physical properties of that brine may improve the reactivity of the brine with carbon dioxide or other components of a waste gas. Treating a brine may improve the reactivity of the brine with a carbonate or bicarbonate solution. Adjusting the brine may include treating the brine to remove or add components. In some embodiments adjusting the composition includes concentrating or diluting a brine to achieve a desired ionic strength or component concentration. In some embodiments concentrating the brine may occur by nanofiltration. In some embodiments, adjusting the brine may include heating or cooling a brine prior to or during any reaction with a carbon containing material. The brine may be treated in situ. In embodiments of the invention, a single subterranean brine may be employed or a mixture of two or more subterranean brines may be employed. “Single subterranean brine” as used herein includes a subterranean brine which has been obtained from a single, distinct subterranean location (e.g., underground well). A mixture of two or more subterranean brines refers to the mixing of two or more brines, where each subterranean brine is obtained from a distinct subterranean location. In certain embodiments, adjusting the brine includes mixing two or more different brines to produce a brine mixture, where each of the two or more brines is obtained from distinct sources (e.g., man-made brine and subterranean brine or brines from separate subterranean locations). The amount of any one brine in the mixture may vary as desired, ranging in some instances from 0.1% to 99.9% by volume, such as 5% to 95% by volume, including 10% to 90% by volume. Two or more brines may be mixed by any convenient mixing protocol, such as using agitator drives, counterflow impellers, turbine impellers, anchor impellers, ribbon impellers, axial flow impellers, radial flow impellers, hydrofoil mixers, aerators, among others.

Aspects of the invention may include obtaining a brine from a subterranean location for reaction with carbon dioxide, carbonic acid, bicarbonate or carbonate. A subterranean brine can be obtained by any convenient protocol, such as for example by pumping the subterranean brine from the subterranean location using, for example a down-well turbine motor pump, a geothermal well pump or a surface-located brine pump. In some embodiments, obtaining a subterranean brine may include pumping the subterranean brine from the underground location and storing it in an above-ground storage basin. The above-ground storage basin may be any convenient storage basin. In some embodiments, the above-ground storage basin may be a naturally-occurring geological structure such as a tailings pond or dried riverbed or may be a manmade structure, such as a storage tank. Where desired, the subterranean brine may be stored in the above-ground storage basin for a period of time following pumping from the subterranean location and prior to contacting it with a source of CO₂. For example, the subterranean brine may be stored for a period of time ranging from 1 to 1000 days or longer, such as 1 to 500 days or longer, and including 1 to 100 days or longer. In these embodiments, the subterranean brine may be stored at a temperature ranging from 1 to 75° C., such as 10 to 50° C. and including 10 to 25° C. In other embodiments, the subterranean brine may be left in the subterranean location (e.g., in an underground well) until needed and pumped from the underground location directly into the reactor for contacting with CO₂. In other embodiments, the subterranean brine may be left in the subterranean location (e.g., in an underground well) and contacting and/or other operations may be performed underground. Brines may be treated prior to, during or after storage for any length of time.

In certain embodiments, the composition of the brine mixture may be determined, monitored or assessed after mixing the two or more subterranean brines together. Based on the determined composition of the brine mixture, the brine mixture may also be further treated. Where desired, monitoring and adjusting may be performed using “real-time” protocols, such that these two processes are occurring continuously to provide a desired brine.

Changes in the brine that may be achieved upon treatment may vary greatly. For example, the chemical makeup of the brine may be altered in some desirable way, e.g., via production of new chemical species in the brine or augmentation or other alteration of the concentration of a chemical species already present in the brine. In some instances, one or more components of the brine may be removed from the brine. The brine may be altered in such a way that it provides for an improved reagent in a reaction with any component of flue gas. For example the ratio of divalent cations (e.g., Ca²⁺ and Mg²⁺) may be adjusted so that the brine is suitable for the precipitation of carbon dioxide. In one embodiment the brine may be treated to adjust the ratio of Ca²⁺ to Mg²⁺ so that the brine may be used as an improved reagent for the synthesis of a carbonate precipitate. In some embodiments nanofiltration may be used to adjust the ratio of Ca²⁺ or Mg²⁺. In some embodiments systems are provide to adjust the ratio of Ca²⁺ or Mg²⁺. In such embodiments, the filtration unit may comprise a membrane for example a nanofiltration membrane through which Mg²⁺ ions flow through at a different rate than Ca²⁺ ions flow through. In some embodiments, the brine may be treated by the addition of concentrated Ca²⁺ or Mg²⁺, or by the selective removal of Ca²⁺ or Mg²⁺. In one embodiment, the brine may be treated so that the ratio of Ca²⁺:Mg²⁺ is optimized for reaction with CO₂ to produce a cementitious carbonate product (e.g., the Ca²⁺: Mg²⁺ of a brine may adjusted to be 4:1 or greater).

Methods of the invention also include adjusting the composition of a subterranean brine by adding an amount of divalent cations to the subterranean brine to increase the concentration of divalent cations. In some instances, the amount of divalent cations may be added to the subterranean brine prior to contacting the subterranean brine with the source of carbon dioxide. In other instances, the amount of divalent cations may be added at the same time as contacting the subterranean brine with the source of carbon dioxide. In yet other instances, an amount of divalent cations may be added to the subterranean brine after contacting the subterranean brine with carbon dioxide. Where desired, the amount of divalent cations may also be added to the subterranean brine at more than one time during methods of the invention (e.g., before, during or after contacting the subterranean brine with carbon dioxide).

Divalent cations may be added to the subterranean brine using any convenient source. Divalent cations may come from any of a number of different divalent cation sources depending upon availability at a particular location. Such sources include industrial wastes, seawater, brines, hard waters, rocks and minerals (e.g., lime, periclase, material comprising metal silicates such as serpentine and olivine), and any other suitable source. In certain embodiments, the amount of divalent cations added to the subterranean brine ranges from 0.01 to 100.0 grams/liter of brine, such as from 1 to 100 grams/liter of brine, for example 5 to 80 grams/liter of brine, including 5 to 50 grams/liter of brine.

In some embodiments, treating a brine comprises adjusting the composition of the brine and includes introducing additives into the alkaline brine. Additives may be introduced into the alkaline brine to modify a particular physical or chemical property of the alkaline brine, such as for example to increase bicarbonate formation, viscosity, spectroscopic properties, etc. In certain embodiments, the additives are introduced into the alkaline brine prior to contacting the alkaline brine with carbon dioxide or bicarbonate. In other embodiments, the additives may be introduced into the brine at the same time as contacting the brine with carbon dioxide or bicarbonate.

In another example, one or more components may be removed so that the brine is modified in such a way that the “treated” brine may be suitable for disposal, or even agricultural use or human consumption, e.g., as described in greater detail below. Methods of this invention may include a step of assessing the determined composition to identify any desired adjustments to the subterranean brine. The desired adjustments may vary in terms of goal, where in some instances the desired adjustments are adjustments that ultimately result in enhanced efficiency of some desirable process parameter, e.g., energy consumption, reagent consumption, CO₂ sequestration, etc. In some embodiments, where the composition of the subterranean brine has been determined to be at least less than optimal for contacting with CO₂, the composition may be adjusted (e.g., increasing the divalent cation concentration or removing protons) prior to contacting the subterranean brine with the source of CO₂ or an aqueous solution of dissolved carbon dioxide, carbonic acid, bicarbonate, or carbonate or any combination thereof. In other embodiments, where the composition of the subterranean brine has been determined to be at least less than optimal for contacting with CO₂, carbonic acid, carbonate, bicarbonate or any combination thereof, the composition may be adjusted at the same time as contacting the subterranean brine with CO₂, carbonic acid, carbonate, bicarbonate or any combination thereof. In some embodiments it may be determined that no adjustment to the composition of the brine is desired.

In some embodiments, the composition of the subterranean brine may be considered to be less than optimal when the amount of carbonate present in the subterranean brine substantially exceeds the divalent ion concentration, such as where the molar ratio of carbonate to divalent ion is 3:1 or greater, such as 5:1 or greater, such as 7:1 or greater, including 10:1 or greater. In other embodiments, the composition of the subterranean brine may be considered to be less than optimal when the amount of divalent cation concentration substantially exceeds the amount of carbonate present in the subterranean brine, such as where the molar ratio of divalent cation to carbonate is 3:1 or greater, such as 5:1 or greater, such as 7:1 or greater, including 10:1 or greater. As such, in some embodiments, the composition of the subterranean brine may be adjusted by adding carbonate or divalent cations to increase the carbonate or divalent ion concentration present in the subterranean brine.

In some embodiments, the composition of the subterranean brine may be considered to be less than optimal when the amount of organic bases (e.g., acetate, propionate, butyrate, etc.) present in the subterranean brine exceeds the amount of inorganic bases (e.g., borate, carbonate, etc.), such as where the molar ratio of organic base to inorganic bases is 2:1 or greater, such as 5:1 or greater, such as 10:1 or greater, such as 100:1 or greater, including 1000:1 or greater. In other embodiments, the composition of the subterranean brine may be considered to be less than optimal when the amount of inorganic bases present in the subterranean brine exceeds the amount of organic bases, such as where the molar ratio of inorganic base to organic base is 2:1 or greater, such as 5:1 or greater, such as 10:1 or greater, such as 100:1 or greater, including 1000:1 or greater. As such, in some embodiments, the composition of the subterranean brine may be adjusted by adding organic base or inorganic base to increase the amount of organic base or inorganic base present in the subterranean brine.

In some embodiments, the composition of the subterranean brine may be adjusted to optimize reagent consumption. By optimize reagent consumption is meant that substantially all of the reagents are consumed by the reactions of contacting the subterranean brine with CO₂, such as where 80% or more of the reagents are consumed, such as 85% or more, such as 90% or more, such as 95% or more, including 100% of the reagents are consumed by the reactions of contacting the subterranean brine with CO₂.

In some embodiments, the composition of the subterranean brine may be adjusted to enhance the energy efficiency of the methods of the invention. By enhance the energy efficiency is meant that the energy required to practice methods of the invention is reduced, such as by reducing the amount of energy by 2-fold or greater, such as 3-fold or greater, such as 5-fold or greater, including 10-fold or greater, e.g., as compared to a suitable control. For example, energy efficiency may be enhanced by reducing the amount of energy required to precipitate the carbonate-containing precipitation material. In certain embodiments, the amount of energy required to precipitate the carbonate-containing precipitation material is reduced by adding an amount of proton-removing agent to the brine. In these embodiments, adding an amount of proton-removing agent may help to rapidly precipitate the carbonate-containing precipitation material without any extra input of energy, such as required by cooling or agitating the reaction mixture.

In some embodiments, the composition of the subterranean brine may be adjusted to enhance the efficiency of CO₂ sequestration by methods of the invention. By enhance the efficiency of CO₂ sequestration is meant that the amount by weight of CO₂ that is sequestered after the adjustment exceeds the amount by weight of CO₂ that is sequestered before the adjustment. In these embodiments, the enhance due to the adjustment may be 5% or more, such as 10% or more, such as 15% or more, such as 25% or more, such as 50% or more, such as 75% or more, such as 90% or more, such as 95% or more, including by 100% or more, e.g., as compared to a suitable control. For example, in some embodiments, the divalent ion concentration may be increased in order to more efficiently react with the carbonates produced by contacting the subterranean brine with CO₂.

In embodiments where two or more brines are mixed, at least one of the subterranean brines may be chosen to provide a source of one or more cations to the brine mixture. In some embodiments, cations provided to the brine mixture may be monovalent cations, e.g., Na⁺, K⁺. In other embodiments, cations provided to the brine mixture may be divalent cations, e.g., Ca²⁺, Mg²⁺, Sr²⁺, Ba²⁺, Mn²⁺, zn²⁺, Fe²⁺. In some instances, the divalent cations may be alkaline-earth-metal-cations, e.g., Ca²⁺, Mg²⁺. The amount of cations provided by the chosen subterranean brine may vary since subterranean brines vary greatly in their ionic compositions, in some embodiments, ranging from 50 to 100,000 ppm, such as 100 to 75,000 ppm, including 500 to 50,000 ppm, for example 1000 to 25,000 ppm.

In embodiments where two or more subterranean brines are mixed, at least one of the subterranean brines may be chosen to provide a source of one or more proton-removing agents to the brine mixture. In some embodiments, proton-removing agents provided to the brine mixture may be halides, e.g., Cl⁻, F⁻, I⁻ and Br⁻. In other embodiments, proton-removing agents provided to the brine mixture may be oxyanions, such as sulfate, carbonate, borate and nitrate, among others. In some instances, the oxyanion is carbonate, e.g., bicarbonate (HCO₃⁻) and carbonate (CO₃²⁻). The amount of carbonates provided by the chosen subterranean brine to the brine mixture may vary greatly depending on the type of subterranean brine, and ranges from 50 to 100,000 ppm, such as 100 to 75,000 ppm, including 500 to 50,000 ppm, for example 1000 to 25,000 ppm. As such, in certain embodiments, the percentage of proton-removing agents provided to the subterranean brine mixture that are carbonates may be 5% or more, such about 10% or more, including about 25% or more, for instance about 50% or more, such as about 75% or more, including about 90% or more. In other instances, the oxyanion is borate, e.g., BO₃³⁻, B₂O₅⁴⁻, B₃O₇⁵⁻, and B₄O₉⁶⁻. The amount of borates provided by the chosen subterranean brine to the brine mixture may vary greatly depending on the type of subterranean brine, and ranges from 50 to 100,000 ppm, such as 100 to 75,000 ppm, including 500 to 50,000 ppm, for example 1000 to 25,000 ppm. As such, in certain embodiments, the percentage of proton-removing agents provided to the subterranean brine mixture that are borates may be 5% or more, such about 10% or more, including about 25% or more, for instance about 50% or more, such as about 75% or more, including about 90% or more. In some embodiments, the proton removing agent is an organic base, e.g., formate, acetate, propionate, butyrate, valerate, oxalate, malonate, succinate, glutarate, phenol, methylphenol, ethylphenol, and dimethylphenol, among others. The amount of organic base provided by the chosen subterranean brine to the brine mixture may vary greatly depending on the type of subterranean brine, and ranges from 1 to 200 mmol/liter, such as 1 to 175 mmol/liter, such as 1 to 100 mmol/liter, such as 10 to 100 mmol/liter, including 10 to 75 mmol/liter. As such, in certain embodiments, the percentage of proton-removing agents provided to the subterranean brine mixture that is an organic base may be 5% or more, such about 10% or more, including about 25% or more, for instance about 50% or more, such as about 75% or more, including about 90% or more.

In some embodiments, the composition of the subterranean brine may be considered to be less than optimal when the subterranean brine contains a large amount of bacterial content, such as where the concentration of bacteria is 1×10⁵ cfu/ml or greater, such as 5×10⁵ cfu/ml or greater, such as 1×10⁶ cfu/ml or greater, such as 5×10⁶ cfu/ml or greater, including 1×10⁷ cfu/ml or greater. As such, in some embodiments, the composition of the subterranean brine may be adjusted to reduce the amount of bacterial content in the subterranean brine, such as by methods as described in detail below. In some embodiments, adjusting the composition of the subterranean brine includes reducing or eliminating the bacterial content in the subterranean brine. By reducing or eliminating the bacterial content of the subterranean brine is meant that the bacterial concentration of the subterranean brine is decreased by 5-fold or more, such as 10-fold or more, such as 100-fold or more, such as 1000-fold or more, such as 10,000-fold or more, such as 100,000-fold or more, including 1,000,000-fold or more. The bacterial content may be reduced or eliminated by treating the subterranean brine with any convenient protocol, as described in detail below. In some embodiments, methods of the invention also include determining and assessing the composition of the subterranean brine after treating the subterranean brine with a protocol for reducing or eliminating bacterial content.

In some embodiments, the bacterial concentration of the subterranean brine is reduced or eliminated by adding an amount of a bactericidal composition. Bactericidal compositions may be any convenient composition which inactivates or kills bacteria and may include, but are not limited to bacterial disinfectants (e.g., dichloroisocyanurate, iodopovidone, isopropanol, triclosan, tricholorophenol, cetyl trimethyammonium bromide, peroxides, etc.), antibiotics (e.g., penicillin, cephalosporins, monobactams, daptomycin, fluoroquinolones, metronidazole, nitrofurantoin, etc.), antiseptics (e.g., potassium hypochlorite, sodium benzenesulfochlroamide, Lugol's solution, urea perhydrate, sorbic acid, hexachlorophene, Dibromol, etc.). The bactericidal composition may be added to the subterranean brine by any convenient protocol, such as a solid, an aqueous composition, a liquid, etc.

In some embodiments, the bacterial concentration of the subterranean brine is reduced or eliminated by adjusting the temperature of the subterranean brine. The temperature of the subterranean brine may be adjusted by any convenient protocol, such as by heat coils, Peltier thermoelectric devices, solar heating devices, water baths, oil baths, gas-power water boilers, etc. Adjusting the temperature of the subterranean brine to reduce or eliminate bacterial content may vary, such as increasing the temperature of the subterranean brine by 5° C. or more, such as 10° C. or more, such as 15° C. or more, such as 25° C. or more, such as 50° C. or more, such as 75° C. or more, including 100° C. or more.

In other embodiments, the bacterial concentration of the subterranean brine is reduced or eliminated by irradiating the subterranean brine with electromagnetic radiation, e.g., UV light. The subterranean brine may be irradiated with electromagnetic radiation by any convenient protocol, such as by using one or more lamps or lasers. In some instances, the subterranean brine may be irradiated in the storage basin, with or without stirring. In other instances, the subterranean brine may be pumped through UV-transparent (e.g., quartz) pipes and irradiated by one or more lamps or laser while the subterranean brine is pumped. The duration of irradiation may vary depending on the volume of subterranean brine and the desired extent of treatment. In some embodiments, the subterranean brine may be irradiated for 0.5 hours or more, such as 1 hour or more, such as 2 hours or more, such as 5 hours or more, such as 10 hours or more, including 24 hours or more.

Methods of the invention also include treating a subterranean brine by adding an amount of one or more proton removing agents. The dissolution of CO₂ into a subterranean brine produces carbonic acid, a species in equilibrium with both bicarbonate and carbonate. To produce the reaction product, protons are removed from various species (e.g., carbonic acid, bicarbonate, hydronium, etc.) in the subterranean brine to shift the equilibrium toward carbonate. As such, in order to produce carbonate (CO₃²⁻) from carbonic acid, 2 moles of protons must be removed for every 1 mole of CO₂ dissolved in the subterranean brine. As protons are removed, more CO₂ goes into solution. In some embodiments, proton-removing agents and methods may be used while contacting a subterranean brine with CO₂ to increase CO₂ absorption in one phase of the reaction, wherein the pH may remain constant, increase, or even decrease, followed by a rapid removal of protons (e.g., by addition of a base) to cause rapid precipitation of carbonate-containing precipitation material. Protons may be removed from the various species (e.g., carbonic acid, bicarbonate, hydronium, etc.) by any convenient approach, including, but not limited to use of naturally occurring proton-removing agents, use of microorganisms and fungi, use of synthetic chemical proton-removing agents, recovery of man-made waste streams, and using electrochemical proton-removing protocols. In some instances, electrochemical methods are employed to remove protons from various species in a solution, either by removing protons from solute (e.g., deprotonation of carbonic acid or bicarbonate) or from solvent (e.g., deprotonation of hydronium or water). Deprotonation of solvent may result, for example, if proton production from CO₂ dissolution matches or exceeds electrochemical proton removal from solute molecules. In some embodiments, low-voltage electrochemical methods may be used to remove protons, for example, as CO₂ is dissolved in the reaction mixture or a precursor solution to the reaction mixture. In some embodiments, CO₂ dissolved in a subterranean brine may be treated by a low-voltage electrochemical method to remove protons from carbonic acid, bicarbonate, hydronium, or any species or combination thereof resulting from the dissolution of CO₂. A low-voltage electrochemical method operates at an average voltage of 2, 1.9, 1.8, 1.7, or 1.6 V or less, such as 1.5, 1.4, 1.3, 1.2, 1.1 V or less, such as 1 V or less, such as 0.9 V or less, 0.8 V or less, 0.7 V or less, 0.6 V or less, 0.5 V or less, 0.4 V or less, 0.3 V or less, 0.2 V or less, or 0.1 V or less. Low-voltage electrochemical methods that do not generate chlorine gas may be convenient for use in systems and methods of the invention. Low-voltage electrochemical methods to remove protons that do not generate oxygen gas may also be convenient for use in systems and methods of the invention. In some embodiments the invention may utilize a low-voltage electrochemical method that produces no gas at the anode. In some embodiments the invention may utilize low-voltage electrochemical methods that consume hydrogen at the anode; in some of these embodiments, no gas is produced at the anode. In some embodiments, low-voltage electrochemical methods generate hydrogen gas at the cathode and transport it to the anode where the hydrogen gas is converted to protons. Electrochemical methods that do not generate hydrogen gas may also be convenient. In some instances, electrochemical methods to remove protons do not generate any gaseous by-byproduct. Electrochemical methods for effecting proton removal are further described in U.S. patent application Ser. No. 12/344,019, filed 24 Dec. 2008; U.S. patent application Ser. No. 12/375,632, filed 23 Dec. 2008; International Patent Application No. PCT/US08/088242, filed 23 Dec. 2008; International Patent Application No. PCT/US09/32301, filed 28 Jan. 2009; International Patent Application No. PCT/US09/48511, filed 24 Jun. 2009; and U.S. patent application Ser. No. 12/541,055, filed 13 Aug. 2009, each of which are incorporated herein by reference in their entirety.

Treating a brine may include adjusting the concentration of carbonate in the brine at any time, before, during or after a reaction with carbon dioxide. In some embodiments, adjusting the brine includes concentrating carbonate in the brine. “Concentrating” as used herein includes increasing the concentration of carbonate in the alkaline brine. As such, the concentration of carbonate in the brine may be increased, e.g., by 0.1 M or more, such as by 0.5 M or more, such as by 1 M or more, such as by 2 M or more, such as by 5 M or more, including by 10 M or more. In some embodiments, carbonate is concentrated to a concentration of 0.5 M or greater, such as 1.0 M or greater, such as at least 1.5 M or greater, such as 2.0 M or greater, such as 5.0 M or greater, such as 7.5 M or greater, including 10 M or greater. Concentrating carbonate in the brine may be accomplished using any convenient protocol, e.g., distillation, evaporation, among other protocols (i.e., so as to decrease the total volume of the alkaline brine while keeping the mass of carbonate constant). In some embodiments the brine may be concentrated by the use of evaporation ponds to reduce the total volume of water and volatile organic substances in a brine. In some embodiments a brine may be concentrated by the using heat from a power plant in order to evaporate water and volatile organic substances. In some embodiments, carbonate in the brine may be concentrated by adding carbonate to the brine (i.e., so as to increase the mass of carbonate while keeping the total volume of the alkaline brine constant). Carbonate may be added to the alkaline brine by any suitable protocol. For example, sodium carbonate may be added to the brine as a solid or a slurry. In some instances, sodium carbonate may be dissolved in an aqueous solution and the aqueous solution added to the brine. In other embodiments, methods of the invention may include decreasing the carbonate concentration in the alkaline brine. As such, the concentration of carbonate in the brine may be decreased, e.g., by 0.1M or more, such as by 0.5 M or more, such as by 1 M or more, such as by 2 M or more, such as by 5 M or more, including by 10 M or more. In certain embodiments, methods of the invention include decreasing the concentration of carbonate in the brine to a concentration that is 10 M or less, such as 7.5 M or less, such as 5 M or less, such as 2 M or less, such as 1 M or less and including 0.5 M or less. Decreasing the concentration of carbonate in the brine may be accomplished using any convenient protocol for example, diluting the brine with diluent (e.g., water).

Processing a brine may include adjusting the temperature of the brine. The initial temperature of the brine may vary depending on the source of the brine (e.g., subterranean brine), ranging from −5 to 110° C., such as from 0 to 100° C., such as from 10 to 80° C., and including from 20 to 60° C. In certain embodiments, the temperature of the brine may be adjusted (i.e., increased or decreased) as desired, e.g., by 5° C. or more, such as 10° C. or more, such as 15° C. or more, such as 25° C. or more, such as 50° C. or more, such as 75° C. or more, including 100° C. or more. Where desired, the temperature of the brine may be adjusted to a temperature which is equivalent to the temperature of the carbon dioxide contacted with the brine. The temperature of the brine may be adjusted using any convenient protocol, such as for example a thermal heat exchanger, electric heating coils, Peltier thermoelectric devices, gas-powered boilers, among other protocols. In certain embodiments, the temperature may be raised using energy generated from low or zero carbon dioxide emission sources, e.g., solar energy source, wind energy source, hydroelectric energy source, etc. In certain embodiments the temperature of a brine may be lowered and the excess heat energy used for a beneficial purpose. In one embodiment excess thermal energy of a brine may be used to drive one or more processes of this invention. Heat energy may be converted to electrical energy or used as thermal energy. The thermal energy of a brine may be collected via a heat exchanger (e.g., a vertical or horizontal closed loop) and transferred to a process of this invention, for example dewatering a product of this invention. Thermal energy of a brine may be used to generate electrical power (e.g., steam generator). In one embodiment, thermal energy from a brine may be used to heat a product of this invention in order to dry that product (e.g., dry an aggregate carbonate product). In still another embodiment thermal energy from a geothermal source may be converted to electrical energy used to drive the generation of a proton removing reagent of this invention.

Suitable compositions for adjusting the concentration of divalent cations in the subterranean brine include aqueous compositions comprising one or more divalent cations, e.g., alkaline earth metal cations such as Ca²⁺ and Mg²⁺. In some embodiments, the aqueous composition of divalent cations comprises alkaline earth metal cations. In some embodiments, the alkaline earth metal cations include calcium, magnesium, or a mixture thereof. In some embodiments, the aqueous composition of divalent cations comprises calcium in amounts ranging from 50 to 50,000 ppm, 50 to 40,000 ppm, 50 to 20,000 ppm, 100 to 10,000 ppm, 200 to 5000 ppm, or 400 to 1000 ppm. In some embodiments, the aqueous composition of divalent cations comprises magnesium in amounts ranging from 50 to 40,000 ppm, 50 to 20,000 ppm, 100 to 10,000 ppm, 200 to 10,000 ppm, 500 to 5000 ppm, or 500 to 2500 ppm. In some embodiments, where Ca²⁺ and Mg²⁺ are both present, the ratio of Ca²⁺ to Mg²⁺ (i.e., Ca²⁺:Mg²⁺) in the aqueous composition of divalent cations may be between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, in some embodiments, the ratio of Ca²⁺ to Mg²⁺ in the aqueous solution of divalent cations may be between 1:1 and 1:10; 1:5 and 1:25; 1:10 and 1:50; 1:25 and 1:100; 1:50 and 1:500; or 1:100 and 1:1000. In some embodiments, the ratio of Mg²⁺ to Ca²⁺ (i.e., Mg²⁺:Ca²⁺) in the aqueous solution of divalent cations may be between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, in some embodiments, the ratio of Mg²⁺ to Ca²⁺ in the aqueous composition of divalent cations may be between 1:1 and 1:10; 1:5 and 1:25; 1:10 and 1:50; 1:25 and 1:100; 1:50 and 1:500; or 1:100 and 1:1000.

The aqueous composition of divalent cations may, in some embodiments, comprise divalent cations derived from freshwater, brackish water, seawater, or brine (e.g., naturally occurring brines or anthropogenic brines such as geothermal plant wastewaters, desalination plant waste waters), as well as other salines having a salinity that is greater than that of freshwater, any of which may be naturally occurring or anthropogenic. In some embodiments, the water source from which divalent cations are derived is a mineral rich (e.g., calcium-rich and/or magnesium-rich) freshwater source. In some embodiments, the water source from which divalent cations are derived may be a naturally occurring saltwater source selected from a sea, an ocean, a lake, a swamp, an estuary, a lagoon, a surface brine, a deep brine, an alkaline lake, an inland sea, or the like. In some embodiments, the water source from which divalent cation are derived may be an anthropogenic brine selected from a geothermal plant wastewater or a desalination wastewater.

In certain embodiments, the composition of the subterranean brine may be adjusted by adding an amount of two different types of proton-removing agents to the subterranean brine. In these embodiments, the composition of the subterranean brine is adjusted by adding a first proton-removing agent and a second proton-removing agent to the subterranean brine, where the second proton-removing agent is distinct from the first protein-removing agent. In certain instances, both the first and second proton-removing agents are added before contacting the subterranean brine with carbon dioxide. In other instances, both the first and second proton-removing agents are added during the contacting of the subterranean brine with carbon dioxide. In yet other instances, a first proton removing agent is added to the subterranean brine before contacting the subterranean brine with carbon dioxide and a second proton-removing agent is added to the reaction product after contacting the subterranean brine with carbon dioxide. In certain embodiments, the first proton-removing agent and the second proton-removing agent are added sequentially. In certain embodiments, the first proton-removing agent and the second proton-removing agent are added simultaneously.

In certain embodiments, the first proton removing agent is a weak base. By “weak base” is meant a chemical base which does not fully ionize in an aqueous solution. As Bronsted-Lowry bases are proton acceptors, a weak base refers to a chemical base in which protonation is incomplete. For example, a first proton removing agent may be an oxyanion, e.g., sulfate, carbonate, borate and nitrate, among others. In other instances, the first proton removing agent may be an organic base, e.g., monocarboxylic anion, dicarboxylic anion, phenolic compounds, and nitrogenous bases, among others.

In certain embodiments, the second proton removing agent is a strong base. By “strong base” is meant a chemical base which fully ionizes in an aqueous solution. In some instances, the second proton removing agent may be a metal oxide (e.g., calcium oxide (CaO), magnesium oxide (MgO), strontium oxide (SrO), beryllium oxide (BeO), barium oxide (BaO), etc.) or may be a metal hydroxide (e.g., sodium hydroxide (NaOH), potassium hydroxide (KOH), calcium hydroxide (Ca(OH)₂), magnesium hydroxide (Mg(OH)₂, etc.). In certain embodiments, as described in greater detail below, the second proton removing agent may be an electrochemical method for removing protons in solution.

Naturally occurring proton-removing agents may be any proton-removing agents found in the wider environment that may create or have a basic local environment. Some embodiments provide for naturally occurring proton-removing agents including minerals that create basic environments upon addition to solution. Such minerals may include, but are not limited to, lime (CaO); periclase (MgO); iron hydroxide minerals (e.g., goethite and limonite); and volcanic ash. Some embodiments provide for using naturally alkaline bodies of water as naturally occurring proton-removing agents. Examples of naturally alkaline bodies of water include, but are not limited to surface water sources (e.g., alkaline lakes such as Mono Lake in California) and ground water sources (e.g., basic aquifers such as the deep geologic alkaline aquifers located at Searles Lake in California).

In some embodiments, the proton-removing agent is an evaporate or an ophiolite. The term “evaporite” is used in its conventional sense to refer to a mineral deposit which forms when a restricted alkaline body of water (e.g., lake, pond, lagoon, etc.) is dehydrated by evaporation which results in concentration of ions from the alkaline body of water to precipitate out and form a mineral deposit, e.g., the crust along Lake Natron in Africa's Great Rift Valley. Naturally occurring evaporites may be found in evaporite basins, which can be classified into six different depositional settings: continental grabens, geosynclinals basins, artesian basins, stranded marine waters, and arid drainage basins. Ions found within evaporites are derived from the weathering of the rocks and sediments with the watershed and from various types of source water (meteoric, phreatic, marine, etc.). As such, the composition of evaporites may vary. For example, evaporites may contain halides (e.g., halite, sylvite, fluorite, etc.), sulfates (e.g., gypsum, anhydrite, barite, etc.), nitrates (nitratine, niter, etc.), borates (e.g., borax), and carbonates (e.g., calcite, aragonite, dolomite, trona, etc.), among others.

In some embodiments, the evaporite or ophiolites may also be a source of one or more cations. In some embodiments, the cations may be monovalent cations, such as Na⁺, K⁺. In some embodiments, the cations are divalent cations, such as Ca²⁺, Mg²⁺, Sr²⁺, Ba²⁺ Mn²⁺, Zn²⁺, Fe²⁺. The source of divalent cations from evaporites may be in the form of mineral salts, such as sulfate salts (e.g., calcium sulfate), borate salts (e.g., borax) or carbonate salts (e.g., calcium carbonate). In some instances, divalent cations of the evaporite are alkaline earth metal cations, e.g., Ca²⁺, Mg²⁺. The evaporite may have Ca²⁺ present in amounts ranging from 50 to 100,000 ppm, such as 100 to 75,000 ppm, including 500 to 50,000 ppm, for example 1000 to 25,000 ppm. In some embodiments, evaporites of the invention may have Mg²⁺ present in amounts ranging from 50 to 25,000 ppm, such as 100 to 15,000 ppm, including 500 to 10,000 ppm, for example 1000 to 5,000 ppm. Where both Ca²⁺ and Mg²⁺ are present, the molar ratio of Ca²⁺ to Mg²⁺ (i.e., Ca²⁺:Mg²⁺) in the evaporite may be between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, the molar ratio of Ca²⁺ to Mg²⁺ in evaporite of the invention may be between 1:1 and 1:10; 1:5 and 1:25; 1:10 and 1:50; 1:25 and 1:100; 1:50 and 1:500; or 1:100 and 1:1000. In some embodiments, the ratio of Mg²⁺ to Ca²⁺ (i.e., Mg²⁺:Ca²⁺) in the evaporite may be between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, the ratio of Mg²⁺ to Ca²⁺ in the evaporites of the invention may be between 1:1 and 1:10; 1:5 and 1:25; 1:10 and 1:50; 1:25 and 1:100; 1:50 and 1:500; or 1:100 and 1:1000.

In some instances, evaporites of the invention contain carbonate. Carbonates present in evaporites may be any carbonate salt, e.g., sodium bicarbonate (NaHCO₃), calcium carbonate (CaCO₃). The amount of carbonates present in evaporites of the invention may vary. In some instances, the amount of carbonate that is present in the evaporite ranges from 1% to 100% (w/w), such as 5% to 90% (w/w), such as 10% to 90% (w/w), including about 15% to 85% (w/w), for instance about 20% to 75% (w/w), such as 25% to 75% (w/w), such as 25% to 60% (w/w), including about 25% to 50% (w/w).

In certain embodiments, the evaporites contain borate. Borates present in evaporites of the invention may be any borate salt, e.g., Na₃BO₃. The amount of borate present in evaporites of the invention may vary. In some instances, the amount of borate that is present in the evaporite ranges from 1% to 100% (w/w), such as 5% to 90% (w/w), such as 10% to 90% (w/w), including about 15% to 85% (w/w), for instance about 20% to 75% (w/w), such as 25% to 75% (w/w), such as 25% to 60% (w/w), including about 25% to 50% (w/w).

Where both carbonate and borate are present, the molar ratio of carbonate to borate (i.e., carbonate:borate) in the evaporites may vary, ranging between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, the molar ratio of carbonate to borate in evaporites of the invention may be between 1:1 and 1:10; 1:5 and 1:25; 1:10 and 1:50; 1:25 and 1:100; 1:50 and 1:500; or 1:100 and 1:1000. In other embodiments, the ratio of borate to carbonate (i.e., borate:carbonate) in the evaporite may be between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, the ratio of borate to carbonate in the evaporites of the invention may be between 1:1 and 1:10; 1:5 and 1:25; 1:10 and 1:50; 1:25 and 1:100; 1:50 and 1:500; or 1:100 and 1:1000. Evaporites or ophiolites may be obtained using any convenient protocol. For instance, naturally forming surface or subsurface evaporites may be obtained by quarry excavation using conventional earth-moving equipment, e.g., bulldozers, front-end loaders, back hoes, etc. In these embodiments, evaporites or ophiolites may also be further processed after excavation to separate each mineral as desired, such as by rehydration followed by sequential precipitation or by density-based separation methods. In other embodiments, evaporites may be obtained by pond precipitation. In these embodiments, a source evaporite aqueous composition (e.g., surface or subsurface brine) may first be obtained, such as by a surface turbine motor pump or subsurface brine pump, and subsequently dehydrated to produce the evaporite. In certain embodiments, the composition of the source evaporite aqueous composition may be adjusted (i.e., adding or removing components, as desired) prior dehydrating the source water to produce an evaporite of a desired composition. Brines may contain other valuable minerals besides those which impart alkaline value and which can easily form carbonates. Minerals such as lithium may be co-extracted, concentrated and used or sold for profit.

Methods Utilizing a Carbonate Brine

In one aspect, this invention relates to methods for making a carbonate containing solid material using a source of cation and a source of carbon where the source of carbon is a carbonate brine. The carbonate brine may be the sole source of carbon in the precipitate, or may provide more than 90% of the carbon in the precipitate, or it may provide more that 50% of the carbon in the precipitate. In such methods carbon from flue gas my provide no or less that 10% of the carbon in the precipiate In such methods, the source of brine may also provide alkalinity. Optionally a proton removing agent may be added to the source of carbon or the source of cations to optimize the pH of the solution such that the carbonate containing material is formed. Accordingly, in one aspect, there is provided a method comprising contacting a source of cations with a carbonate brine to give a reaction product comprising carbonic acid, bicarbonate, carbonate, or mixture thereof.

“Source of cations” includes any solid or solution that contains mono or divalent cations, such as, sodium, potassium, alkaline earth metal ions, or combination thereof, or any aqueous medium containing sodium, potassium, alkaline earth metals, or combinations thereof. The alkaline earth metals include calcium, magnesium, strontium, barium, etc. Or combinations thereof. In some embodiments, the source of cations contains one or more of the alkaline earth metal ions in an amount of 1% to 99% by wt; or 1% to 95% by wt; or 1% to 90% by wt; or 1% to 80% by wt; or 1% to 70% by wt; or 1% to 60% by wt; or 1% to 50% by wt; or 1% to 40% by wt; or 1% to 30% by wt; or 1% to 20% by wt; or 1% to 10% by wt; or 20% to 95% by wt; or 20% to 80% by wt; or 20% to 50% by wt; or 50% to 95% by wt; or 50% to 80% by wt; or 50% to 75% by wt; or 75% to 90% by wt; or 75% to 80% by wt; or 80% to 90% by wt of the solution containing the alkaline earth metal ions. In some embodiments, the source of cations is seawater. In some embodiments, the source of cations is hard brines.

In some embodiments, brines may serve a dual purpose of providing a source of carbon and a source of alkalinity. In some embodiments, the source of carbon in brine is carbonate. Such brines may be called carbonate brines or carbonate rich brines or soda bearing brines and “carbonate brine” or “soda brine” includes any brine containing carbonate. The brine can be synthetic brine such as a solution of brine containing the carbonate, e.g., sodium bicarbonate or sodium carbonate, or the brine can be a naturally occurring brine, e.g., a subterranean brine. The carbonate in the brines may provide a source of alkalinity as well as the source of carbon to make calcium carbonate compositions of the invention.

The carbonate present in the synthetic or subterranean brines of the invention may include a dissolved CO₂ or any oxyanion of carbon, e.g., bicarbonate (HCO₃⁻), carbonic acid (H₂CO₃), or carbonate (CO₃²⁻). Deposits of sodium carbonate are found in large quantities in countries like United States, China, Botswana, Uganda, Kenya, Mexico, Peru, India, Egypt, South Africa and Turkey. It is found both as extensive beds of sodium minerals and as sodium-rich waters (brines).

Carbonate brines useful in the methods and compositions of the invention can be obtained from, for example, trona deposits located in Utah, California (such as, Searles Lake and Owens Lake), and Wyoming; shallow-water limestones and dolostones of the Conococheague Limestone (Upper Cambrian) of western Maryland; lakes located in East African Rift Valley (e.g., Lake Bogoria, Lake Natron and Lake Magadi); lakes located in Libyan Desert in Egypt (Wadi Natrun system); and lakes located in central Asia (from south-east Siberia to north-east China). The carbonate minerals include, but are not limited to, trona, minor nahcolite, and trace amounts of pirssonite and thermonatrite.

Trona and dolomite are associated throughout the trona zone. Calcite, zeolites, feldspar, and clay minerals are the typical minerals found within the associated rocks of the trona deposit. The trona crystals, which are generally white and/or gray due to impurities, occur in massive units and as disseminated crystals in claystone and shale. Crude trona (“trona ore”) may comprise 80-95% of sodium sesquicarbonate (Na₂CO₃.NaHCO₃.2H₂O) and, in lesser amounts, sodium chloride (NaCl), sodium sulfate (Na₂SO₄), organic matter, and insolubles such as clay and shales. In Wyoming, these deposits are located in 25 separate identified beds or zones ranging from 800 to 2800 feet below the earth's surface and are typically extracted by conventional mining techniques, such as, the room and pillar and longwall methods.

The carbonate ores may require processing in order to recover the carbonate brines. Typically, the sodium carbonate from the Green River deposits is produced from the conventionally mined trona ore via the “monohydrate” process. The “monohydrate” process involves crushing and screening the bulk ore which, as noted above, contains both sodium carbonate (Na₂CO₃) and sodium bicarbonate (NaHCO₃) as well as impurities such as silicates and organic matter. After the ore is screened, it may be calcined (i.e., heated) at temperatures greater than 150° C. to convert sodium bicarbonate to sodium carbonate. The crude soda ash may be dissolved in a recycled liquor which may be then clarified and filtered to remove the insoluble solids. The liquor may be carbon treated to remove dissolved organic matter which may cause foaming and color problems in the final product, and may be again filtered to remove entrained carbon before going to a monohydrate crystallizer unit. This unit has a high temperature evaporator system generally having one or more effects (evaporators), where sodium carbonate monohydrate may be crystallized. The resulting slurry may then be centrifuged, and the separated monohydrate crystals may be sent to dryers to produce soda ash. The soluble impurities may be recycled with the concentrate to the crystallizer where they may be further concentrated. In some embodiments of the invention, alkaline earth metal ions or a solution containing alkaline earth metal ions (e.g., synthetic solution containing calcium or magnesium ions or naturally occurring hard brines) may be added to the ore solution at any stage of the above recited process to precipitate out the carbonate composition of the invention. For example, in some embodiments, the alkaline earth metal ions or a solution containing alkaline earth metal ions may be added to the trona ore solution once ore has been crushed, or calcined, or dissolved in a liquor, or is filtered or centrifuged, as described above.

In some embodiments, the underground ore may be subjected to solution mining where water is injected (or an aqueous solution) into a deposit of soluble ore, the solution may be allowed to dissolve as much ore as possible, and the solution may be pumped to the surface. The solution may be evaporated to produce brines with higher alkalinity or higher concentration of carbonate ions. The alkaline earth metal ions or a solution containing alkaline earth metal ions may be added to this solution to precipitate out the carbonate compositions of the invention.

In some embodiments, the alkaline earth metal ions or the solution containing alkaline earth metal ions is added to the above-ground processes which treat bulk ore that has been conventionally mined. Bulk trona (sodium sesquicarbonate), for example, may be dissolved in an aqueous solvent at high temperatures which may allow for a higher concentration to be achieved. In some embodiments, the alkaline earth metal ions or a solution containing alkaline earth metal ions may be added to solution after the bulk ore has been dissolved in the aqueous solvent. After purification, these liquors may be cooled to recrystallize the carbonate or sesquicarbonate, which may be then calcined and converted to soda ash. In some embodiments, the alkaline earth metal ions or a solution containing alkaline earth metal ions may be added to the liquor before or after crystallization, as explained above.

In some embodiments, the carbonated brines may be sufficiently alkaline to precipitate the carbonate compositions of the invention with the addition of the cations, such as, alkaline earth metal ions or a solution containing alkaline earth metal ions. In some embodiments carbonate brines may contain sufficient carbonate concentration to generate a carbonate precipitation product upon contact with any source of divalent cations without the addition of carbonate ions from any other source (e.g., flue gas, fly ash etc.). In some embodiments, the addition of the alkaline earth metal ions or a solution containing alkaline earth metal ions to the carbonate brine may be accompanied by a proton removing agent, such as an alkali, or a solution containing alkali. Proton removing agents have been described herein. For example, in some embodiments, the proton removing agent may include an industrial waste including, but are not limited to, fly ash, bottom ash, cement kiln dust, slag, red mud, mining waste, or combination thereof. In some embodiments the proton removing agent may include a hydroxide, such as sodium hydroxide, e.g., sodium hydroxide produced by electrochemical methods as described in U.S. patent application Ser. Nos. 12/344,019, titled, “Method of Sequestering CO₂,” filed 24 Dec. 2008; U.S. patent application Ser. No. 12/375,632, titled, “Low Energy Electrochemical Hydroxide System and Method,” filed 23 Dec. 2008; International Patent Application No. PCT/US08/088,242, titled, “Low energy electrochemical hydroxide system and method,” filed 23 Dec. 2008; International Patent Application No. PCT/US09/32301, titled, “Low energy electrochemical bicarbonate ion solution,” filed 28 Jan. 2009; and International Patent Application No. PCT/US09/48511, titled, “Low energy 4-cell electrochemical system with carbon dioxide gas,” filed 24 Jun. 2009, each of which are incorporated herein by reference in their entirety. Any suitable proton-removing agent, alone or in combination with other agents, may be used.

The proton removing agent may be added to increase the pH of the solution to alkaline region such that the carbonate compositions of the invention precipitate out. It is to be understood that the amount of the proton removing agent and the amount of alkaline earth metal ion may vary depending on the pH of the solution and the precipitation conditions. In some embodiments, the amount of the proton removing agent is 1% to 80% by wt; or 1 to 70% by wt; or 1 to 60% by wt; or 1 to 50% by wt; or 1 to 40% by wt; or 1 to 30% by wt; or 1 to 20% by wt; or 1 to 10% by wt; or 1 to 5% by wt; or 5% to 80% by wt; or 5 to 70% by wt; or 5 to 60% by wt; or 5 to 50% by wt; or 5 to 40% by wt; or 5 to 30% by wt; or 5 to 20% by wt; or 5 to 10% by wt; 10% to 80% by wt; or 10 to 70% by wt; or 10 to 60% by wt; or 10 to 50% by wt; or 10 to 40% by wt; or 10 to 30% by wt; or 10 to 20% by wt; 20% to 80% by wt; or 20 to 50% by wt; or 40 to 80% by wt; or 40 to 60% by wt; or 50 to 80% by wt; or 50 to 60% by wt; or 60 to 80% by wt of the solution containing the proton removing agent. For example, in some embodiments, the amount of NaOH is 1% to 80% by wt; or 1 to 70% by wt; or 1 to 60% by wt; or 1 to 50% by wt; or 1 to 40% by wt; or 1 to 30% by wt; or 1 to 20% by wt; or 1 to 10% by wt; or 1 to 5% by wt; or 5% to 80% by wt; or 5 to 70% by wt; or 5 to 60% by wt; or 5 to 50% by wt; or 5 to 40% by wt; or 5 to 30% by wt; or 5 to 20% by wt; or 5 to 10% by wt; 10% to 80% by wt; or 10 to 70% by wt; or 10 to 60% by wt; or 10 to 50% by wt; or 10 to 40% by wt; or 10 to 30% by wt; or 10 to 20% by wt; 20% to 80% by wt; or 20 to 50% by wt; or 40 to 80% by wt; or 40 to 60% by wt; or 50 to 80% by wt; or 50 to 60% by wt; or 60 to 80% by wt of the solution containing NaOH.

The amount of carbonates present in the brines used in the precipitation methods may vary. In some instances, the amount of carbonate present ranges from 50 to 100,000 ppm; or 100 to 75,000 ppm; or 500 to 50,000 ppm; or 1000 to 25,000 ppm.

As such, in certain embodiments, the brines used in the methods may comprise 5% by wt or more of carbonates; or 10% by wt or more of carbonates; or 15% by wt or more of carbonates; or 20% by wt or more of carbonates; or 30% by wt or more of carbonates; or 40% by wt or more of carbonates; or 50% by wt or more of carbonates; or 60% by wt or more of carbonates; or 70% by wt or more of carbonates; or 80% by wt or more of carbonates; or 90% by wt or more of carbonates; or 99% by wt or more of carbonates; or 5-99% by wt of carbonates; or 5-95% by wt of carbonates; or 5-80% by wt of carbonates; or 5-75% by wt of carbonates; or 5-70% by wt of carbonates; or 5-60% by wt of carbonates; or 5-50% by wt of carbonates; or 5-40% by wt of carbonates; or 5-30% by wt of carbonates; or 5-20% by wt of carbonates; or 5-10% by wt of carbonates; or 10-80% by wt of carbonates; or 10-50% by wt of carbonates; or 10-20% by wt of carbonates; or 20-80% by wt of carbonates; or 20-50% by wt of carbonates; or 30-75% by wt of carbonates; or 30-50% by wt of carbonates; or 40-80% by wt of carbonates; or 50-75% by wt of carbonates; or 50-90% by wt of carbonates; or 60-80% by wt of carbonates; or 60-95% by wt of carbonates; or 70-90% by wt of carbonates; or 80-90% by wt of carbonates; or 5% by wt of carbonates; or 10% by wt of carbonates or 20% by wt of carbonates; or 25% by wt of carbonates; or 30% by wt of carbonates; or 40% by wt of carbonates; or 50% by wt of carbonates; or 60% by wt of carbonates; or 70% by wt of carbonates; or 80% by wt of carbonates; or 90% by wt of carbonates. In some embodiments, the amount of carbonate recited above is present in the subterranean brine. In some embodiments, the amount of carbonate recited above is present in the ore above ground. In some embodiments, the amount of carbonate recited above is present in the underground ore. In some embodiments, the amount of carbonate recited above is present in the brine extracted from the ore. In some embodiments, the amount of carbonate recited above is present in the brine after the processing of the ore. Some of the examples of the methods of processing are as described herein.

In addition to carbonates, the carbonate brine may also contain other anions, such as, but not limited to, sulfate, phosphate, chloride etc. In some embodiments, the carbonate brines contain large amounts of sulfur which may be present in various forms, such as, but not limited to, hydrogen sulfide (H₂S), sulfite (SO₃²⁻), and thionates (S₄O₆²⁻).

In some embodiments, the carbonate brine includes one or more of elements including, but not limited to, aluminum, barium, cobalt, copper, iron, lanthanum, lithium, mercury, arsenic, cadmium, lead, nickel, phosphorus, scandium, titanium, zinc, zirconium, molybdenum, and/or selenium. In some embodiments, the carbonate brine includes one or more of elements including, but not limited to, lanthanum, mercury, arsenic, lead, and selenium. In some embodiments, the carbonate brines are processed to remove one or more of the elements, such as, lithium, iron, etc. And the remaining brine is used to make the composition of the invention, and/or the brine may be used to make the composition of the invention and then processed to remove one or more of these elements. The foregoing elements may be considered as markers for identifying reaction products, i.e., carbonate compositions of the invention derived from carbonate brines.

In one aspect, there is provided a cementitious composition, comprising a carbonate, bicarbonate, or mixture thereof and one or more elements including, but not limited to, aluminum, barium, cobalt, copper, iron, lanthanum, lithium, mercury, arsenic, cadmium, lead, nickel, phosphorus, scandium, titanium, zinc, zirconium, molybdenum, and/or selenium, wherein the composition upon combination with water; setting; and hardening has a compressive strength of at least 14 MPa. In some embodiments, the composition comprises a carbonate, bicarbonate, or mixture thereof and one or more elements selected from the group consisting of lanthanum, mercury, arsenic, lead, and selenium, wherein the composition upon combination with water; setting; and hardening has a compressive strength of at least 14 MPa. In some embodiments, the composition comprises a carbonate, bicarbonate, or mixture thereof and one or more elements selected from the group consisting of mercury, arsenic, and selenium, wherein the composition upon combination with water; setting; and hardening has a compressive strength of at least 14 MPa. “Cementitious” as used herein refers to the conventional meaning of cement known in the art. For example, the cementitious composition is a composition that sets and hardens independently or can be used as a supplementary cementitious material (SCM) that can bind with other cement materials, such as Portland Cement, aggregates, other supplementary cementitious materials, or combination thereof.

The carbonate, bicarbonate, or a mixture thereof, present in the composition of the invention, may be a one or more of calcium carbonate, magnesium carbonate, calcium bicarbonate, magnesium bicarbonate, calcium magnesium carbonate, or mixture thereof. In some embodiments, carbonate, bicarbonate, or a mixture thereof present in the composition of the invention is a calcium carbonate, calcium bicarbonate, or mixture thereof.

In some embodiments, these one or more elements serve as a marker to identify or differentiate the calcium carbonate compositions of the invention derived from carbonate brines. Each of these one or more elements are present in the carbonate brine and/or in the composition of the invention in less than 1000 ppm; or less than 500 ppm; or less than 100 ppm; or less than 10 ppm; or less than 1 ppm; or between 0.5-1000 ppm; or between 0.5-500 ppm; or between 0.5-100 ppm; or between 0.5-10 ppm; or between 0.5-5 ppm; or between 5-500 ppm; or between 5-100 ppm; or between 5-50 ppm; or between 5-10 ppm; or between 50-500 ppm; or between 100-500 ppm; or between 500-900 ppm; or between 500-1000 ppm.

In some embodiments of the composition of the invention, the composition upon combination with water; setting; and hardening has a compressive strength of at least 14 MPa; or at least 20 MPa; or at least 30 MPa; or at least 40 MPa; or at least 50 MPa; or at least 60 MPa; or at least 70 MPa; or at least 80 MPa; or at least 90 MPa; or at least 100 MPa; or from 14-100 MPa; or from 14-80 MPa; or from 14-50 MPa; or from 14-28 MPa; or from 14-25 MPa; or from 14-20 MPa; or from 14-18 MPa; or from 14-16 MPa; or from 16-30 MPa; or from 16-25 MPa; or from 16-20 MPa; or from 16-18 MPa; or from 18-28 MPa; or from 18-25 MPa; or from 18-22 MPa; or from 18-20 MPa; or from 17-28 MPa; or from 17-25 MPa; or from 17-20 MPa; or from 20-80 MPa; or from 20-60 MPa; or from 20-40 MPa; or from 20-30 MPa; or from 20-25 MPa; or from 20-22 MPa; or from 30-80 MPa; or from 30-50 MPa; or from 40-80 MPa; or from 50-80 MPa; or from 60-90 MPa; or from 70-90 MPa; or 14 MPa; or 16 MPa; or 18 MPa; or 20 MPa; or 22 MPa; or 24 MPa; or 28 MPa; or 40 MPa; or 50 MPa; or 60 MPa; or 80 MPa; or 100 MPa.

In some embodiments, the composition is in a dry powdered form. In some embodiments, the composition is a particulate composition with an average particle size of 0.1 to 100 microns; or 0.1 to 50 microns; or 0.1 to 40 microns; or 0.1 to 30 microns; or 0.1 to 20 microns; or 0.1 to 10 microns; or 0.1 to 5 microns; or 1 to 50 microns; or 1 to 40 microns; or 1 to 30 microns; or 1 to 20 microns; or 1 to 10 microns; or 1 to 9 microns; or 1 to 8 microns; or 1 to 7 microns; or 1 to 6 microns; or 1 to 5 microns; or 1 to 4 microns; or 1 to 3 microns; or 1 to 2 microns; or 2 to 50 microns; or 2 to 40 microns; or 2 to 30 microns; or 2 to 20 microns; or 2 to 10 microns; or 2 to 9 microns; or 2 to 8 microns; or 2 to 7 microns; or 2 to 6 microns; or 2 to 5 microns; or 2 to 4 microns; or 2 to 3 microns; or 3 to 50 microns; or 3 to 40 microns; or 3 to 30 microns; or 3 to 20 microns; or 3 to 10 microns; or 3 to 9 microns; or 3 to 8 microns; or 3 to 7 microns; or 3 to 6 microns; or 3 to 5 microns; or 3 to 4 microns; or 5 to 50 microns; or 5 to 40 microns; or 5 to 30 microns; or 5 to 20 microns; or 5 to 10 microns; or 5 to 8 microns; or 5 to 7 microns; or 5 to 6 microns; or 6 to 100 microns; or 6 to 50 microns; or 6 to 10 microns; or 10 to 100 microns; or to 50 microns; or 10 to 25 microns; or 20 to 100 microns; or 20 to 50 microns; or 50 to 100 microns; or 50 to 80 microns; or 60 to 100 microns; or 60 to 80 microns; or 1 micron; or 5 micron; or 10 micron. The average particle size may be determined using any conventional particle size determination method, such as, but is not limited to, multi-detector laser scattering or sieving (i.e. <38 microns).

Typically, carbon of plant origin has a different ratio of stable isotopes (¹³C and ¹²C) than carbon of inorganic origin. The plants from which fossil fuels are derived preferentially utilize ¹²C over ¹³C, thus fractionating the carbon isotopes so that the value of their ratio differs from that in the atmosphere in general. This value, when compared to a standard value (PeeDee Belemnite, or PDB, standard), is termed the carbon isotopic fractionation (δ¹³C) value. For example, δ¹³C values for coal are in the range −30 to −20‰; δ¹³C values for methane may be as low as −20‰ to −40‰ or even −40‰ to −80‰; δ¹³C values for atmospheric CO₂ are −10‰ to −7‰; and for marine bicarbonate, 0‰.

In some embodiments, the composition has a δ¹³C of between −5‰ to 25‰. In some embodiments, the composition has a δ¹³C of −5‰ to 25‰; or −5‰ to 20‰; or −5‰ to 10‰; or −5‰ to 5‰; −5‰ to −1‰; or −1‰ to 25‰; or −1‰ to 20‰; or −1‰ to 10‰; or −1‰ to 5‰; or −1‰ to 1‰; 0.1‰ to 25‰; or 0.1‰ to 20‰; or 0.1‰ to 10‰; or 0.1‰ to 5‰; or 0.1‰ to 1‰; or 1‰ to 25‰; or 1‰ to 20‰; or 1‰ to 10‰; or 1‰ to 5‰; or 1‰ to 2‰; or 2‰ to 25‰; or 2‰ to 20‰; or 2‰ to 10‰; or 2‰ to 5‰; or 3‰ to 25‰; or 3‰ to 20‰; or 3‰ to 10‰; or 3‰ to 5‰; or 4‰ to 25‰; or 4‰ to 20‰; or 4‰ to 10‰; or 4‰ to 5‰; or 5‰ to 25‰; or 5‰ to 20‰; or 5‰ to 15‰; or 10‰ to 15‰; or 10‰ to 20‰; or 10‰ to 25‰; or 20‰ to 25‰.

Compositions of the invention may be characterized by measuring its δ¹³C value. Any suitable method may be used for measuring the δ¹³C value, such as mass spectrometry or off-axis integrated-cavity output spectroscopy (off-axis ICOS). Any mass-discerning technique sensitive enough to measure the amounts of carbon, can be used to find ratios of the ¹³C to ¹²C isotope concentrations. The δ¹³C values can be measured by the differences in the energies in the carbon-oxygen double bonds made by the ¹²C and ¹³C isotopes in carbon dioxide. The δ¹³C value of a carbonate may serve as a fingerprint for a source of carbon, as the value can vary from source to source.

In some embodiments, the composition further comprises Portland cement clinker, aggregate, supplementary cementitious material (SCM), or combination thereof. As defined by the European Standard EN197.1, “Portland cement clinker is a hydraulic material which shall consist of at least two-thirds by mass of calcium silicates (3CaO.SiO₂ and 2CaO.SiO₂), the remainder consisting of aluminium- and iron-containing clinker phases and other compounds. The ratio of CaO to SiO₂ shall not be less than 2.0. The magnesium content (MgO) shall not exceed 5.0% by mass.” In certain embodiments, the Portland cement constituent of the invention is any Portland cement that satisfies the ASTM Standards and Specifications of C150 (Types I-VIII) of the American Society for Testing of Materials (ASTM C50-Standard Specification for Portland Cement). ASTM C150 covers eight types of Portland cement, each possessing different properties, and used specifically for those properties. In some embodiments, the amount of Portland cement in the composition may range from 20 to 95%; or 20 to 90%; or 20 to 80%; or 20 to 70%; or 20 to 60%; or 20 to 40%; or 40 to 95%; or 40 to 90%; or 40 to 80%; or 40 to 70%; or 40 to 60%; or 50 to 95%; or 50 to 90%; or 50 to 80%; or 50 to 70%; or 50 to 60%; or 60 to 95%; or 60 to 90%; or 60 to 80%; or 60 to 70%; or 70 to 95%; or 70 to 90%; or 70 to 80%; or 70 to 75%; or 80 to 99%; or 80 to 95%; or 80 to 92%; or 80 to 90%; or 80 to 88%; or 80 to 85%; or 80 to 82%; or 80%.

In certain embodiments, the composition may further include aggregate. Aggregate may be included in the composition to provide for mortars which include fine aggregate and concretes which also include coarse aggregate. The fine aggregates are materials that typically almost entirely pass through a Number 4 sieve (ASTM C 125 and ASTM C 33), such as silica sand. The coarse aggregate are materials that are predominantly retained on a Number 4 sieve (ASTM C 125 and ASTM C 33), such as silica, quartz, crushed round marble, glass spheres, granite, limestone, calcite, feldspar, alluvial sands, sands or any other durable aggregate, and mixtures thereof. As such, the term “aggregate” is used broadly to refer to a number of different types of both coarse and fine particulate material, including, but are not limited to, sand, gravel, crushed stone, slag, and recycled concrete. The amount and nature of the aggregate may vary widely. In some embodiments, the amount of aggregate may range from 1 to 95%; or 1 to 90%; or 1 to 80%; or 1 to 70%; or 1 to 60%; or 1 to 40%; or 1 to 20%; or 25 to 90%; or 25 to 85%; or 25 to 80%; or 25 to 70%; or 25 to 60%; or 25 to 50%; or 25 to 40%; or 25 to 30%; or 40 to 80%; or 40 to 70%; or 40 to 60%; or 40 to 50%; or 50 to 80%; or 50 to 70%; or 50 to 60%; or 60 to 80%; or 70 to 80% w/w of the total composition made up of both the composition and the aggregate. In some embodiments, the SCM is slag, fly ash, silica fume, or calcined clay.

In yet another aspect there is provided a system comprising (a) an input for a source of cation, (b) an input for a carbonate brine, and (c) a reactor connected to the inputs of step (a) and step (b) that is configured to give a reaction product comprising carbonic acid, bicarbonate, carbonate, or mixture thereof.

An input for a source of cation may be a structure, such as, but is not limited to, a pipe or a conduit connected to a source of cation, such as, ocean or a tank filled with the cation containing water. An input for the carbonate brine may be a structure, such as, but is not limited to, a pipe or a conduit connected to a source of carbonate brine, such as, a subterranean location or a tank filled with the carbonate brine. The reactor may be connected to the two inputs and is configured to make the carbonate precipitate. The charger and precipitation reactor may be configured to include any number of different elements, such as temperature regulators (e.g., configured to heat the water to a desired temperature), chemical additive elements, e.g., for introducing chemical pH elevating agents (such as NaOH) into the water, electrolysis elements, e.g., cathodes/anodes, etc. This reactor may operate as a batch process or a continuous process.

Methods of Assessing a Region

As summarized above, aspects of the invention include methods of assessing a region for probability of finding a source of brine that may be reacted with a source of carbon dioxide or an aqueous solution comprising carbonic acid, dissolved carbon dioxide, carbonate, bicarbonate or any combination thereof. The region may be assessed using data associated with the presence of reactive brines as well data used for indicating the proximity of these brines to sources of anthropogenic carbon dioxide In one embodiment the subterranean brine may be a hard brine (i.e., containing divalent cations). Data associated with the presence of hard brines (e.g., the presence of calcium containing rocks) may be collected and assessed. In another embodiment the brine may be an alkaline brine (i.e. pH greater than 7 or an alkalinity greater than 100 mEq/l). Data associated with the presence of alkaline brines (e.g., the presence of evaporite rock formations) may be collected and assessed. The brine may be wastewater from a mining operation. The brine may contain divalent cations. Any geographical region may be assessed by reviewing physical data (e.g., surface, mining, petroleum maps, and lithographical, hydrological surveys), and anthropogenic data (e.g., population maps, power grid maps) about a region. The assessment may include reviewing existing data and/or acquiring new anthropogenic or physical data about a region or any combination of data. New data may be acquired by any means (e.g., satellite data, air surveys, ground surveys, hydrological surveys, seismic surveys, infra red, mobile NMR geophysical tomography magnetic robotic mapping or the like). Physical data of a region may include maps of seismic, lithological, geographical data, as well as maps of mineral and petroleum deposits. Anthropogenic data may include population surveys, maps of power sources and sources of anthropogenic carbon dioxide. The data and/or maps may be collected and a representation may be created to capture the relevant data. The representation may be a map, table, matrix, computer program or any combination thereof. The data may be combined by means such as a software program to create a map of a region indicating the confluence of physical and anthropogenic features of a region. An example of a suitable software program for creating representations of this invention includes, MetaCarta™. Software programs may utilize searches of available published data of brine locations. Searches may be limited by specific key word ‘search terms’. Search terms that may facilitate searches for alkaline brines and include, but are not limited by such terms as Alkaline Brines, Alkaline Springs, Pickle Weed(s), Alkaline Plants, Alkaliophiles, Halotolerant, and Calcium Carbonate. Search terms that may facilitate searches for hard brines and include, but are not limited by such terms as Calcium Chloride, Albitization, Anorthite Weathering, Calcium Plagioclase, Skarn, Divalent cations and Non-Marine Evaporites. In some embodiments of this invention a representation may be generated which combines desired data into a single machine readable or human readable form and indicates likely locations of brines suitable for methods, compositions, and systems of this invention.

Legal data (e.g., status of real estate, water, mineral rights) of a particular region may also be included in any assessment of a region, such as licensee status of land, mineral, petroleum or hydrological rights to portions of a region to be assessed. Algorithms may be used to combine such data and provide estimates of physical suitability and/or legal availability of brine in a region to be assessed. The legal rights to water and mineral use in a region may be pursued. The ‘Beneficial Use’ rights may be pursued to obtain water rights to a region. Beneficial use may include the right to utilize real property, including light, air, water and access to it, in any lawful manner to gain a profit, advantage, or enjoyment from it. This includes the right to enjoy real or personal property held by a person who has equitable title to it while legal title is held by another.

A beneficial use involves greater rights than a mere right to possession of land, since it extends to the light, water and air in and over the land and access to it, which may be infringed by the beneficial use of other property by another owner. Beneficial use rights may be acquired simply by diverting and using the water, posting a notice of appropriation at the point of diversion, and recording a copy of the notice with the County Recorder. Beneficial use rights may be acquired by application through a State Water Board. Any entity intending to appropriate water may be required to file an application for a water right permit with a State Water Board. An application for a new water appropriation may be approved if it is determined to be for a useful or beneficial purpose and if water is available for appropriation. In evaluating an application, the Board may consider the relative benefits derived from the beneficial uses, possible water pollution, and water quality. If a permit is approved, it may be approved in full or it may be subject to specified conditions. While the time frame involved in obtaining a license for water rights may be highly variable, the pursuit of water rights may occur by following predetermined steps outline in state water board regulations. Permit decisions may be required to be reached within six months on accepted applications for non-protested projects which do not require extensive environmental review. Applications with unique requirements for environmental review and/or require protest resolution, may extend the time frame by months and even years. In one embodiment of this invention, Beneficial Use water rights may be pursued in the state of California. The process to obtain a permit in the state of California is outlined in Table 1.

TABLE 1
Steps to Obtain a Beneficial Use Water Permit in California

| Step | Board's Role | Applicant's Tasks |
|---|---|---|
| File | If you need assistance Board engineers will | Prepare an application which meets |
| Application | help you prepare application forms, small | specific requirements, including a |
| | project maps, and other documents. | filing fee. |
| | Incomplete applications won't be accepted. | |
| Acceptance of | Board notifies you within 30 days that either | Provide any additional information |
| Application | your application is incomplete or that it has | requested by the Board within 60 days |
| | been accepted. Acceptance of your application | of notification. |
| | establishes your priority as the date of filing. | |
| Environmental | Your proposed project is assessed to determine | Assume cost for preparation of any |
| Review | to what extent it could alter the environment. | required environmental studies. |
| Public Notice | The Board will send you a public notice | For small projects, - Post the notice for |
| | describing your proposed project. Copies of | 40 consecutive days in two |
| | the notice are also sent to known interested | conspicuous places near your project |
| | parties and to post offices in the area of your | location. |
| | project for posting. | For large projects - Publish the notice |
| | | in a newspaper at least once a week for |
| | | three consecutive weeks. |
| Protests | During the noticing period, the Board may | Respond to any protest in writing and |
| | receive protests against your proposed project | attempt to reach agreements so that |
| | from interested individuals or groups. | protests can be withdrawn. |
| Hearings | If protests cannot otherwise be resolved, you | In case of protest - prepare testimony |
| | and the protestant present your cases at a field | and exhibits for presentation at the |
| | investigation or during a hearing conducted by | hearing and cooperate with the Board |
| | the Board. The Board issues a decision on | and protestant toward reaching a |
| | protested applications based on information | satisfactory resolution. |
| | gathered at the field investigation or on | |
| | evidence presented during the hearing. | |
| Permit | A water right permit is issued when protests, if | Prior to issuance of a permit, you must |
| Issuance | any, are resolved or dismissed, or when the | submit a permit fee as directed by the |
| | Board approves the application by decision | Board. If water conservation measures |
| | following a hearing. In addition, a permit fee | are required, they will be included as a |
| | must be paid. During this phase, the Board | condition of your permit. |
| | determines whether water conservation | |
| | measures are needed. | |

Preferable properties of a region that may yield suitable brine include a region with substantial quantities of accessible subterranean brine. The brine may be accessible by any means such as though existing bore holes or rock amenable to drilling or permeable rock, (e.g., a permeability of greater than 50 mD (milliDarcys)). Other desirable properties of region may be the presence of calcium in the existing rock. Other desirable properties include the availability of legal rights to the water or minerals in the region. The subterranean brine that is employed in embodiments of the invention may be from any convenient subterranean brine. The term “subterranean brine” is employed in its conventional sense to include naturally occurring or anthropogenic concentrated aqueous saline compositions obtained from a subterranean geological location. The brine may be associated with a petrochemical deposit. The brine may be within 5 surface miles of a source of anthropogenic carbon. In some embodiments, the brine may be with 10, 15, 25, or 100 surface miles from a source of anthropogenic carbon. Anthropogenic sources of carbon may be power plants utilizing fossil fuels, or from cement manufacture or from smelters or any other source. Desirable properties of a brine in a region include the proximity of a power source to the source of brine. The brine may be within 5 surface miles of a source of power. In some embodiments, the brine may be with 10, 15, 25, or 100 surface miles from a source of power. In some embodiment the power sources may be solar or wind farms. In some embodiment the power source may be a coal, nuclear or gas power plants. In methods of the invention, a subterranean brine may be contacted with carbon dioxide to produce a reaction product. The location of brine relative to the location of a source of anthropogenic carbon dioxide may also be assessed.

In some embodiments the invention provides methods for assessing a region for suitability of sequestering carbon dioxide The methods may include creating a representation (e.g., a map) of the region comprising a combination of physical data wherein the physical data comprises data indicative of the presence or absence of sources either of divalent cations or alkalinity and anthropogenic data comprising data indicative of the presence or absence of sources of anthropogenic carbon dioxide, and determining the proximity of sources either of divalent cations or alkalinity to sources of anthropogenic carbon dioxide. In some embodiments, the physical data comprises geographical, lithographical, hydrological, seismic data or the combination thereof. In some embodiments, the source of anthropogenic carbon is a power plant, cement plant or smelter. The representation may include the depth of one or more subterranean brines in a region. The hydrostatic pressure (e.g., static and dynamic head strength) of subterranean brines may be included in any representation of this invention. Hydrostatic pressure, well depth and divalent cation concentration of a subterranean brine may be used to determine the probability that a subterranean brine in a region is suitable for contact with CO₂ for the methods of this invention. Values corresponding to hydrostatic pressure, well depth and divalent cation concentration of a subterranean brine may be compiled by the use of an algorithm to calculate a quantitative value for the suitability of a subterranean brine. In some embodiments the quantitative value may further include the total dissolved solids of a brine. In some embodiments the quantitative value may include the Ca⁺² concentration of a brine. In some embodiments the quantities value may further include the total alkalinity of a brine. In some embodiments, the representation of the region further comprises data indicative of the legal status of water rights, mineral rights or a combination thereof. In some embodiments, the physical data about the region comprises lithographic data indicating the presence and/or abundance of calcium. In some embodiments, the physical data about the region comprises seismic data indicating the presence and/or abundance of permeable rock. In some embodiments, physical data about the region further comprises hydrological data indicating the presence or absence of a subterranean brine. In some embodiments, the representation of the region comprises data indicating the proximity of the subterranean brine to the source of anthropogenic carbon dioxide. In some embodiments, the proximity of the source of anthropogenic carbon dioxide to the subterranean brine is less than five surface miles. In some embodiments, the method includes generating new physical data about the region, such as drilling a well. In some embodiments new data may be acquired by seismic, infrared, geophysical tomographic, magnetic, robotic, aerial, or ground mapping methods or any combination thereof.

Methods of Assessing a Subterranean Brine

Once a region has been assessed for the suitability of sequestering anthropogenic source of carbon dioxide, the brine in that region may be located and assessed in greater detail for reactivity with carbon dioxide. “Assessing” as used herein includes a human (either alone or with the assistance of a computer, if using a computer-automated process initially set up under human direction), evaluates the determined composition of the subterranean brine. In some embodiments a subterranean brine may be assessed to determine the suitability of the subterranean brine for contacting with a gas comprising CO₂ in order to remove some or all of the CO₂ from the gas. In some embodiments a subterranean brine may be assessed to determine the suitability of the subterranean brine for contacting with an aqueous solution comprising dissolved carbon dioxide, carbonic acid, bicarbonate, carbonates or any combination thereof and forming a reaction product. In some embodiments, the reaction may be a precipitation reaction comprising divalent cations. In some embodiments, the reaction may be a deprotonation reaction.

Methods of the invention also include, in some embodiments, determining the properties of the subterranean brine or brines. Determining the properties of a subterranean brine refers to the analysis of one or more of the properties and/or the components present in a subterranean brine. Determining the composition of subterranean brine may include, but is not limited to, determining the metal composition, salt composition, ionic composition, organometallic composition, organic composition, bacterial content, pH, physical properties (e.g., boiling point), electrochemical properties, spectroscopic properties, acid-base properties, polydispersities, isotopic composition, and partition coefficient of the subterranean brine. The brine may be assessed remotely using testing equipment delivered to a brine location via a bore well. The brine may be assessed after removal from the subterranean site using any available method for testing the physical properties of a brine sample. Any convenient protocol may be employed to determine the composition of the subterranean brine. In some embodiments, prior to analysis, a sample of the subterranean brine may be obtained and filtered (e.g., by vacuum filtration) to separate the solid components from the liquid components. Methods for analyzing the properties of a subterranean brine may include, but are not limited to the use of inductively coupled plasma emission spectrometry, inductively coupled plasma mass spectrometry, ion chromatography, X-ray diffraction, gas chromatography, infrared or mass spectrometry, flow-injection analysis, scintillation counting, acidimetric titration, and flame emission spectrometry or any method known in the art for assessing the properties of a brine.

In some embodiments, determining the properties of a subterranean brine includes determining the pH of the subterranean brine. The pH can be determined using any convenient protocol, e.g., a glass electrode coupled to a pH meter. In certain embodiments, determining the pH of the subterranean brine includes a brine-specific pH measurement that accounts for potential interference from sodium ions. By brine-specific pH measurement is meant a pH measurement which distinguishes the relative contributions to the alkalinity of the brine, such as for example, alkalinity resulting from carbonates, sulfates, borates, nitrates, or organic bases, among others.

The properties of the subterranean brine may be determined at any phase during methods of the invention. For example, the composition of a subterranean brine may be determined before contacting the subterranean brine with CO₂, during contacting with CO₂, or even after contacting the subterranean brine with CO₂. In some embodiments, methods also include monitoring the subterranean brine throughout the entire procedure. In some embodiments, monitoring the subterranean brine includes collecting real-time data (e.g., pH, conductivity, spectroscopic data, etc.) about the subterranean brine, such as by employing a detector in the reactor to monitor the reaction product. In other embodiments, the subterranean brine may be monitored by determining the composition of the subterranean brine at regular intervals, e.g., determining the composition every 1 minute, every 5 minutes, every 10 minutes, every 30 minutes, every 60 minutes, every 100 minutes, every 200 minutes, every 500 minutes, or some other interval.

One or more brines in region may be assessed for suitability for reaction with carbon dioxide or aqueous solutions comprising carbonates, bicarbonate, or carbonic acid by assessing the properties of the brine in a region and then determining if the properties of the brine are suitable for reaction. If after assessing that the determined composition of the subterranean brine contains the desired components (e.g., is suitable for contacting with CO₂), the subterranean brine may be contacted with CO₂ or the aqueous solution without any further adjustments. The reactivity of a brine and carbon dioxide may result in any product, such as, but not limited to a solution of carbonic acid, carbonates or bicarbonates, a carbonate containing precipitate, or a cementitious material. The reactivity of the brine and an aqueous solution comprising carbonic acid, carbonate, or carbonate may result any product such as bun not limited to a carbonate containing precipitate or a cementitious material. Subterranean brines of the invention may be subterranean aqueous saline compositions and in some embodiments, may have circulated through crustal rocks and become enriched in substances leached from the surrounding mineral. As such, the ionic composition of subterranean brines may vary. Brines may be assessed to determine the ionic composition, for example concentration and identity of any divalent cations present in the brine. Methods of this invention may include assessing a brine for the conductivity, ionic strength and ionic composition to determine the suitability of a brine for reaction with carbon dioxide. In some embodiments, the subterranean brines may be assessed to determine the composition and concentration of one or more cations. The cations may be monovalent cations, such as Na⁺, K⁺, etc. In some instances the brines of interest may be substantially free of divalent cations or contain substantial amounts of divalent cations, such as Ca²⁺, Mg²⁺, Sr²⁺, Ba²⁺Mn²⁺, Zn²⁺, Fe²⁺, etc. In some instances, the divalent cations of the subterranean brine are alkaline earth metal cations, e.g., Ca²⁺, Mg²⁺. In some instances the Ca⁺² concentration of a brine that is suitable for reaction an aqueous solution comprising carbonates, bicarbonates or carbonic acid may be between 100 ppm and 100,000 ppm.

The brine may be assessed to determine the pH. In some embodiments, subterranean brines of the invention contain proton-removing agents. The brine may be assessed to determine composition of any proton removing agents. “Proton-removing agent” as used herein includes a substance or compound which possesses sufficient alkalinity or basicity to remove one or more protons from a proton-containing species in solution. In some embodiments, the amount of proton-removing agent is an amount such that the subterranean brine possesses a neutral pH (i.e., pH=7). In other embodiments, the amount of proton-removing agents in the subterranean brine is an amount such that the subterranean brine is alkaline. In some embodiments a subterranean brine suitable for reaction with CO₂ has an alkalinity between 100 and 2000 mEq/l. The brine may be assessed to determine the chemical nature of the proton-removing agents present. In some embodiments the alkalinity of the brine may be measured by quantifying the amount of borate, carbonate and hydroxyl components of the brine.

In some embodiments, subterranean brines of the invention may be assessed for bacterial content. Examples of the types of bacteria that may be present in subterranean brines include sulfur oxidizing bacteria (e.g., Shewanella putrefaciens, Thiobacillus), aerobic halophilic bacteria (e.g., Salinivibrio costicola and Halomanos halodenitrificans), high salinity bacteria (e.g., endospore-containing Bacillus and Marinococcus halophilus), among others. Brines may be assessed by sampling brines sources and culturing samples in an appropriate medium. Brines may be assessed using light microscopy, electron microscopy, epifluorescent microscopy or photography. A brine may be assessed to determine the temperature or pressure of the brine at the subterranean location. A brine may be assessed to determine the conductivity of the brine using method s known in the art for measuring conductivity.

Methods of Contacting an Aqueous Mixture with Carbon Dioxide

As discussed above, conventional carbon capture and sequestration (CCS) has shortcomings, many of which are associated with the properties of supercritical CO₂. As described further herein, CO₂ from a CO₂-containing gas or a supercritical fluid may be converted to a product comprising carbonate species of carbonate that removes CO₂ from the atmosphere. Aqueous solutions of carbonate species may include dissolved carbon dioxide, carbonic acid, bicarbonate, carbonate, or any combination thereof. In some embodiments, a portion of this product may be placed in a subterranean location, e.g., a geological formation, with significantly less risk than the storage of supercritical CO₂. Aqueous solutions of carbonic acid, bicarbonate, or carbonate, or any combination thereof may be combined with cations to form precipitated carbonate species (CaCO₃, NaHCO₃), which may also be stored in a subterranean location or made into a useful product. Any combination of aqueous mixtures of carbonic acid, bicarbonate, carbonate, or precipitated reaction products may provide for a denser sequestration of carbon dioxide that sequestration by supercritical carbon dioxide methods. Sequestration products of this invention may comprise being safely stored underground in a beneficially broader range of subterranean locations than supercritical carbon dioxide. In some embodiments of this invention, carbon dioxide may be combined with a brine to produce a reaction product.

Dissolution of Carbon Dioxide

Without being bound by theory, carbon dioxide may react with water to form four primary species in aqueous solution: dissolved carbon dioxide, aqueous carbonic acid, aqueous bicarbonate, and aqueous carbonate, the distribution of which is largely dependent upon pH. The conversion of carbonic acid into bicarbonate and carbonate may be accomplished through the addition of a proton-removing agent (e.g., a base). Chemically, aqueous dissolution of CO₂ may be described by the following set of equations:

CO₂(g)⇄CO₂(aq)(in the presence of water) (I)

CO₂(aq)+H₂O⇄H₂CO₃(aq) (II)

Conversion to bicarbonate may described by the following equations:

H₂CO₃(aq)+HO⁻(aq)⇄HCO₃⁻(aq)+H₂O (III)

CO₂(aq)+HO⁻(aq)⇄HCO₃⁻(aq) (IV)

Conversion to carbonate may described by the following equation:

HCO₃⁻(aq)+HO⁻(aq)⇄CO₃²⁻(aq)+H₂O (V)

CO₂(aq)+2OH⁻⇄CO₃²⁻(aq)+H₂O (VI)

In the methods described herein, at least some of the captured carbon dioxide is converted to bicarbonate or carbonate ions through the addition of proton-removing agents.

As described in detail below, contacting the alkaline solution with a source of CO₂ may employ any convenient protocol, such as for example by employing gas bubblers, contact infusers, fluidic Venturi reactors, spargers, components for mechanical agitation, stirrers, components for recirculation of the source of CO₂ through the contacting reactor, gas filters, sprays, trays, or packed column reactors, and the like, as may be convenient.

Aspects of the invention also include methods for contacting a solution with carbon dioxide to produce a carbon containing reaction product (e.g., an aqueous solution comprising carbonic acid, bicarbonate, carbonate or combination thereof). The reaction product may be a clear liquid. In some embodiments of methods of this invention, the gaseous reagent comprises CO₂ levels greater than those found in the atmosphere. A gas comprising CO₂ levels greater than those found in the atmosphere may be contacted with an aqueous mixture under conditions that do not include a flow of other gases that do on comprise CO₂. The aqueous mixture may be an alkaline solution. As discussed in detail below, in certain embodiments of the invention, a portion of reaction product produced by contacting carbon dioxide with an alkaline solution may be further sequestered in a subterranean site, effectively sequestering carbon dioxide in the form of any combination of a carbonic acid, bicarbonate and carbonate mixture. Alternatively, or in addition to sequestering the reaction product, the carbonic acid, bicarbonate, carbonate, carbonate composition may further be contacted with a source of one or more proton-removing agents and/or a source of one or more divalent cations to produce a precipitated material comprising carbonates and/or bicarbonates. A portion of the precipitated material may be sequestered in a subterranean site or used as a building material. In some embodiments sequestering the reaction product may comprise placing the reaction product in a subterranean location.

Alkaline solution” as used herein includes an aqueous composition which possesses sufficient alkalinity or basicity to remove one or more protons from proton-containing species in solution. Proton removing agents are discussed in greater detail above. The stoichiometric sum of proton-removing agents in the alkaline solution exceeds the stoichiometric sum of proton-containing agents. In some instances, the alkaline solution has a pH that is above neutral pH (i.e., pH>7), e.g., the solution has a pH ranging from 7.1 to 12, such as 8 to 12, such as 8 to 11, and including 9 to 11. For example, the pH of the alkaline solution may be 9.5 or higher, such as 9.7 or higher, including 10 or higher.

In some embodiments, the alkaline solution may be a subterranean brine. A subterranean brine may contain proton removing agents that promote the formation of carbon containing reaction products. Subterranean brines may provide for an advantageously convenient source of proton removing agents situated close to a source of anthropogenic carbon dioxide. Subterranean brines may provide for a less expensive source of proton removing agents than conventional sources of proton removing agents. The subterranean brines of this invention may occur naturally or may be the by-product of underground mining or petroleum operations. The subterranean brines may be treated to increase the alkaline properties of the brine, as described in detail above.

As reviewed above, when CO₂ is dissolved into an aqueous composition, carbonic acid may be produced. In some embodiments, alkaline solutions of the invention possess an alkalinity or basicity that is sufficient to deprotonate carbonic acid to produce bicarbonate and thus, some or all of the CO₂ contacted with the alkaline solution is converted to bicarbonate. In these embodiments, after dissolution of CO₂ into the alkaline solution, the alkaline solution may be substantially all bicarbonate, such as where the molar ratio of bicarbonate to carbonic acid (HCO₃⁻/H₂CO₃) is 200/1 or greater, such as 500/1 or greater, such as 1000/1 or greater, such as 5000/1 or greater, including 10,000/1 or greater.

In various embodiments, one or more additional components may be formed (i.e., in addition to carbonic acid, bicarbonate, carbonate, or mixtures thereof) by contacting an aqueous solution comprising cations (e.g., alkaline earth metal ions such as Ca²⁺ and Mg²⁺) with a CO₂-containing waste gas stream. Sulfates and/or sulfites of calcium and/or magnesium may be produced from waste gas streams comprising SOx (e.g., SO₂). Magnesium and/or calcium may react to form CaSO₄, MgSO₄, as well as other calcium- and/or magnesium-containing sulfur compounds (e.g., sulfites), effectively removing sulfur from the flue gas stream without a desulfurization step such as flue gas desulfurization (“FGD”). In addition, CaCO₃, MgCO₃, and related compounds may be formed without additional release of CO₂. In instances where the aqueous solution of cations contains high levels of sulfur compounds (e.g., sulfate), the aqueous solution may be enriched with calcium and/or magnesium so that calcium and/or magnesium are available to form carbonate compounds after, or in addition to, formation of CaSO₄, MgSO₄, and related compounds. In some embodiments, a desulfurization step may be staged to coincide with precipitation of carbonate-containing precipitation material, or the desulfurization step may be staged to occur before precipitation. In some embodiments, multiple reaction products (e.g., carbonate-containing precipitation material, CaSO₄, etc.) are collected at different stages, while in other embodiments a single reaction product (e.g., precipitation material comprising carbonates, sulfates, etc.) is collected. In step with these embodiments, other components, such as arsenic or heavy metals (e.g., mercury, mercury salts, mercury-containing compounds), may be trapped in the carbonate-containing precipitation material or may precipitate separately. In some embodiments, precipitation material (if any is produced) is not collected. In such embodiments, the solution resulting from contact of the CO₂-containing gas comprising additional components (e.g., SOx, NOx) is injected into a subterranean site (e.g., a geological formation) as described herein. Other combinations of processing the solution resulting from contact of the CO₂-containing gas comprising additional components (e.g., criteria pollutants) are also possible, as described herein.

In embodiments of this invention a subterranean brine may be used as source of divalent or monovalent cations. The subterranean brines of this invention may have high Ca²⁺:Mg²⁺ ratios (e.g., greater than 5:1) beneficially providing for a reaction product that comprises predominately calcium carbonate. In some embodiments divalent cation containing subterranean brines may be contacted with reaction products containing carbonic acid, bicarbonate, carbonate, or combinations thereof, to form a reaction product. The reaction product may be a solution, slurry, solid or any combination thereof. In some embodiments, the reaction products may be prepared for injection into subterranean locations or used for a beneficial purpose. In some embodiments, the subterranean brines and reaction products may be subjected to conditions that induce precipitation of a precipitation material. The precipitation material may be CaCO₃. The precipitation material may form particular polymorphs of CaCO₃ such as vaterite, aragonite calcite or amorphous calcium carbonate. Subterranean brines of this invention may be used as a source of monovalent cations. Cations, as described above, may come from any of a number of different cation sources depending upon availability at a particular location. While monovalent cations (e.g., cations such as K¹⁺ and Na¹⁺), useful for producing reaction products, may be found in industrial wastes, seawater, hard water, minerals, and many other suitable sources, subterranean brines may be advantageously close to a source of anthropogenic carbon. Subterranean brines may also provide for a source of divalent cations that require minimal processing for reaction with carbon dioxide, carbonic acid, bicarbonate, carbonate, or combinations thereof.

In embodiments of this invention, divalent cation-containing minerals (e.g., mafic and ultramafic minerals such as olivine, serpentine, feldspar, arkosic sands and other suitable materials) may be reacted with carbon dioxide or aqueous solutions comprising carbonic acid, carbonate, bicarbonate or a combination thereof using any convenient protocol. Other minerals such as wollastonite may also be used. The minerals may be reacted as solids in the aqueous reaction mixtures of this invention. Dissolution of the mineral may be accelerated by increasing surface area, such as by milling by conventional means or by, for example, jet milling, as well as by use of, for example, ultrasonic techniques. In addition, mineral dissolution may be accelerated by exposure to acid or base. Advantageously, metal silicates and the like digested with aqueous alkali hydroxide may be used directly to produce compositions of the invention. In addition, base value from the reaction mixture used to prepare one or more compositions of the invention may be recovered and reused to digest additional metal silicates and the like.

A portion of the gaseous waste stream (i.e., not the entire gaseous waste stream) from an industrial plant may be used to produce compositions of the invention. In these embodiments, the portion of the gaseous waste stream that is employed in producing the compositions may be 75% or less, such as 60% or less, and including 50% and less of the gaseous waste stream. In yet other embodiments, substantially (e.g., 80% or more) the entire gaseous waste stream produced by the industrial plant is employed in producing the composition. In these embodiments, 80% or more, such as 90% or more, including 95% or more, up to 100% of the gaseous waste stream (e.g., flue gas) generated by the source may be employed for producing the composition.

As such, the invention provides methods for sequestration (e.g., geological sequestration) of carbon dioxide in a subterranean site. In some embodiments, an amount of carbon dioxide is captured from a gaseous source of carbon dioxide or supercritical carbon dioxide into an aqueous stream. The aqueous stream may be any stream containing water and includes, but is not limited to, freshwater, seawater, retentate from desalination processes, geological brines, and streams resulting from dissolution of mineral sources of cations. The aqueous stream may also be a slurry comprising both liquid and solid phases. In this process at least some portion of the carbon dioxide from the anthropogenic source is converted to carbonic acid, carbonates or bicarbonates through reaction with a natural or manufactured base. Carbonates, bicarbonates, or mixtures thereof may be mineralized into solid forms or remain as dissolved as ions in solution. Streams comprising carbonates, bicarbonates, or mixtures thereof may then be deposited in a subterranean location (e.g., a geological formation) suitable for long-term storage. The stream may be liquids such as clear liquids substantially free of any solid or slurry. These formations include, but are not limited to, saline aquifers, petroleum reservoirs, deep coal seams, and sub-oceanic formations. The subterranean location may be an aquifer containing water with greater than 10,000 ppm total dissolved solids. The capacity of a subterranean location such as a geological formation may be increased by removal of an aqueous stream from the subterranean site. The aqueous stream may then become a source of cations or alkalinity for formation of carbonates, bicarbonates, or mixtures thereof. These ions may be returned to the subterranean site, returned to another subterranean site, formed into solids for use as building materials or other products, or some combination thereof.

In a method for conversion to bicarbonate and/or carbonate prior to injection, CO₂ may be absorbed from a CO₂-containing gas into an aqueous phase, which may be either a liquid (e.g., a clear liquid) or a slurry stream. At least some portion of the CO₂ in the aqueous phase may then be converted into carbonic acid, bicarbonate ions, carbonate ions or any mixture thereof through the addition of a base as described above. The resulting composition, which may or may not comprise precipitation material, may then be injected underground into a suitable subterranean site (e.g., geological formation) for long-term storage. Precipitation material, if present, may include any mineral form comprising has carbonate and/or bicarbonate. In some embodiments, additional CO₂ (e.g., from a conventional CCS process) may be added to the composition prior to deposition, increasing the concentration of and shifting the partition between the species of carbon oxides to be deposited.

This method addresses many of the issues associated with conventional CCS (i.e., capture of CO₂ and storage as supercritical carbon dioxide in a geological formation). First, the costs of compression and transportation will be greatly reduced as compared with conventional CCS, which utilized supercritical CO₂. Compression requirements for liquids and slurries are much lower than that for vapor phase streams. Because liquids and slurries are approximately incompressible, the change in material density with pressure is minimal. Thus the transportation pressures may be significantly lower and storage site depth requirements are lower. The risk associated with CO₂ leaks from high-pressure pipelines is also alleviated. Secondly, the risks associated with underground storage are also alleviated. Over very long time periods (typically years), it is thought that CO₂ injected in conventional CCS processes will “mineralize” into bicarbonates and/or carbonates. These more stable forms of carbon would reduce the risks associated with leaks from underground formations. In methods of the invention, at least a portion of the injected CO₂ would already be in one of the more stable ionic forms, reducing the overall risk. These more stable forms also may make viable certain subterranean sites (e.g., geological formations), which would otherwise be unsuitable for supercritical carbon sequestration. In some embodiments the subterranean site may less than 1 km below the surface. For example, if a large fraction of the injected carbon where in the form of bicarbonates and/or carbonates, the risk of cap rock rupture would be reduced, enabling some marginal formations to become viable. In some embodiments cap rock is not necessary above a subterranean storage site of this invention. Porosity as used herein includes the fraction of void space in the material, where the void may contain, for example, air or water. It may be defined by the ratio Vᵥ/Vₜ=φ, where Vᵥ is the volume of void-space (such as fluids) and V_{T} is the total or bulk volume of material, including the solid and void components. Porosity may be a percent between 0 and 100, typically ranging from less than 1% for solid granite to more than 50% for peat and clay.

In some embodiments a storage site for reaction products of this invention may have a porosity of greater than 1%, 5% 10%. The porosity of rock above the storage site may be greater than 0%. In some embodiments the porosity of rock above a storage site may be greater than 1%, 5%, or 10%. In some embodiment the storage site for reaction products of this invention may be substantially free of cap rock. In some embodiments there may be less than 100% cap rock above a geological storage site of this invention. In some embodiments the storage site for reaction products of this invention may be geological formations that are unsuitable for sequestration of supercritical CO₂. The formations may be unsuitable for supercritical CO₂ storage due to the presence of porous or fractured rock above the storage site. “Cap rock” as used herein includes gas or supercritical fluid-impermeable rock that confines reservoirs and prevents the migration or leakage of reservoir hydrocarbons, gases, or supercritical fluids.

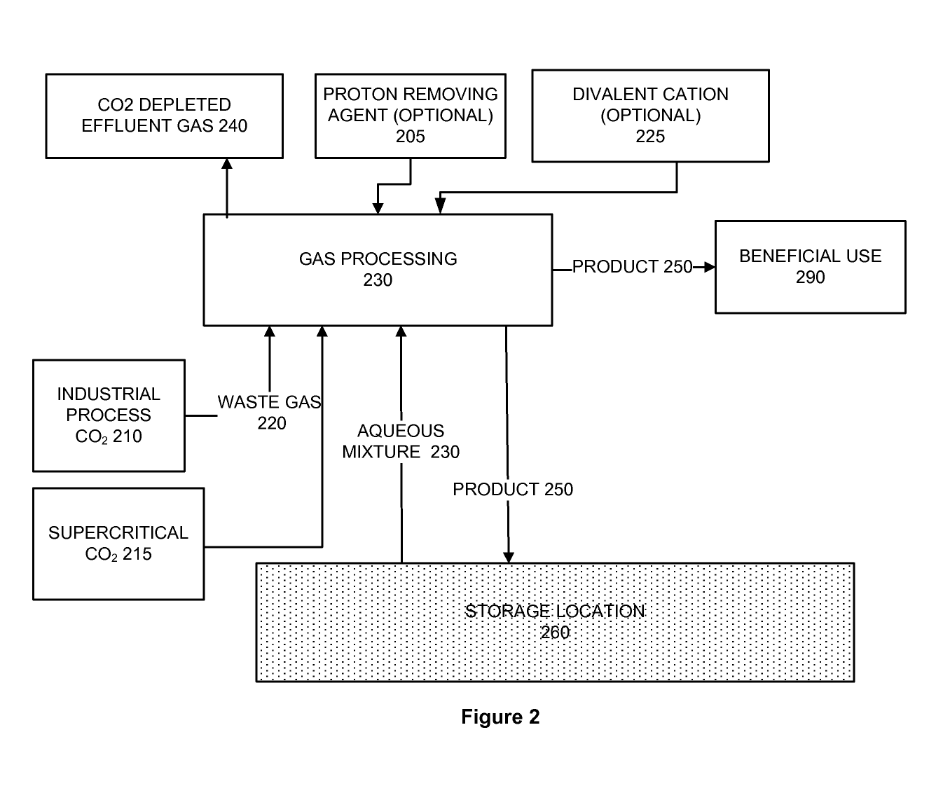

FIG. 2 shows one embodiment of the invention that provides a process in which carbon dioxide from an industrial process [210] or from a source of supercritical carbon dioxide [215] is processed [230] to create product [250] and an effluent gas [240] that is reduced in carbon dioxide relative to the incoming waste carbon dioxide. The product may be a liquid, solid slurry or combination thereof. The sequestration process [230] may take in a proton removing agent [205] and/or a divalent cation [225]. In separate embodiments, the proton removing agent and the divalent cations may be added to the sequestration process [230] simultaneously or sequentially. The origin of the proton removing agent [205] may be any convenient source of alkalinity (e.g., metal oxides, subterranean brine) as discussed above. The divalent cation [225] may be from any convenient source (e.g., mineral solutions, subterranean brine) as discussed above. The waste gas [220] may originate from an industrial process that produces carbon dioxide, such as the burning of a fossil fuel or calcining in a cement plant or smelting. In one embodiment the product [250] resulting from the sequestration process may be a clear liquid. In another embodiment, the product [250] may contain precipitated material. The product may be a mixture or slurry that is at least 20% by weight solids. In some embodiments the mixture or slurry is at least 40% by weight solids. The product may be transported to a storage location [260] for long-term storage and sequestration of the carbon from the carbon dioxide-containing waste gas. The storage location [260] may be any convenient storage location, e.g., a subterranean geological formation, an ocean floor, or a settling pond. The product may stably sequester carbon dioxide at a higher density than supercritical carbon dioxide at its critical point. In one embodiment the reaction product may stably store carbon at a density greater than 21 moles of carbon/100 cm³. In another embodiment, the method of this invention may comprise forming a product with a carbon density of 0.45 g/cm³. In still another embodiment, the reaction product may have a carbon density of 0.91 g/cm³. In one embodiment, the storage site may be a geological feature that is not covered by a cap rock formation.

In some aspects of methods for increasing the capacity of geological reservoirs by removal of aqueous solutions from a geological reservoir and conversion to bicarbonates and/or carbonates upon contact CO₂, of at least a portion of the aqueous fluid removed from a subterranean location. In some embodiments, the aqueous fluid that is removed from a subterranean location (e.g., geological formation) may contain some divalent cations. In some embodiments, the aqueous fluid that is removed from a subterranean location (e.g., geological formation) may contain some proton removing species. At least a portion of those proton removing species may be used to form bicarbonates and/or carbonates upon contact with CO₂. The removal of the aqueous fluid may increase the capacity of the geological formation for additional carbon storage either as supercritical CO₂ from conventional CCS or as bicarbonate/carbonate ions or some combination thereof. In some embodiments, the bicarbonates and/or carbonates are returned to the same subterranean location (e.g., geological formation) that the reactive aqueous solution was removed from. They may be returned to the same geological formation or a placed in a different geological formation. In one embodiment, the aqueous solution may be removed from the same well bore that is used to transfer the carbon containing reaction products into the subterranean location. In some embodiments, a portion the bicarbonates and/or carbonates may be converted to mineralized (solid) forms outside of the subterranean location. In some embodiments, outside of the subterranean location may be at or above ground. This method addresses several key limitations of conventional CCS methods; that is, the removal of brines from geological reservoirs may improve reservoir capacity and facilitate achieving reservoir balance. This method may also advantageously maximize the density of the carbon containing reaction product by generating precipitated solids before sequestration of either supernatant or precipitated reaction product into a subterranean location. This method utilizes those brines to sequester additional CO₂ in the form of bicarbonate; carbonate ions carbonate solids or a mixture thereof. This method advantageously may convert CO₂ from either a waste gas or a supercritical fluid into a composition that may be stored in a geological formation without the requirement for a cap rock formation or rock porosity below 1% above the storage location.

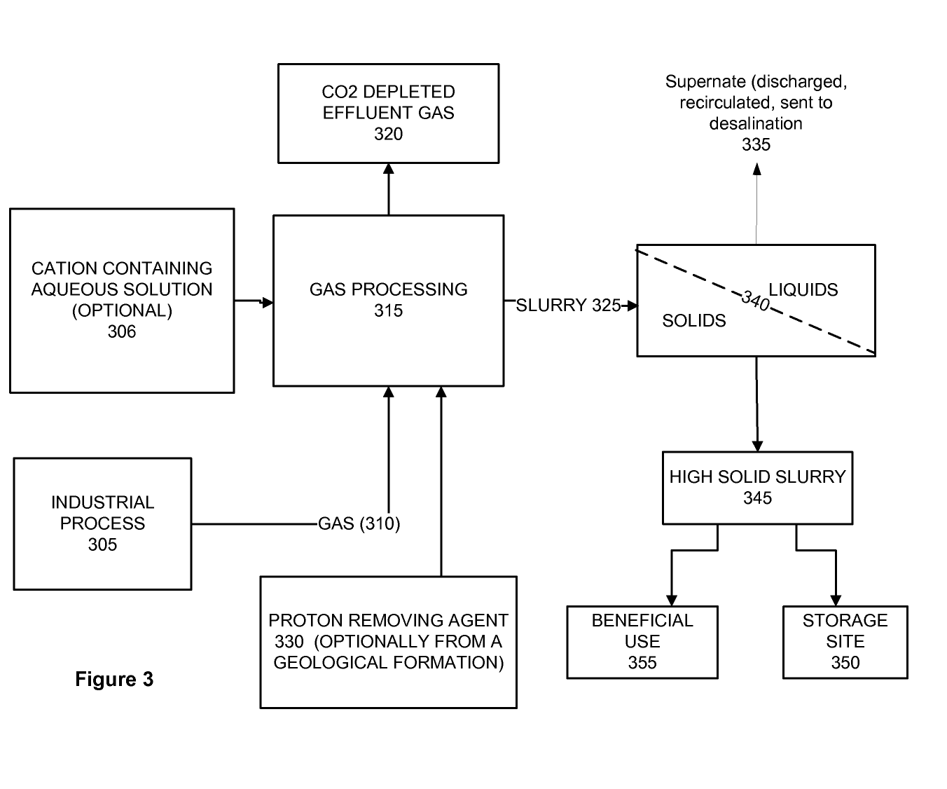

FIG. 3 shows one embodiment of the invention that provides a process in which carbon dioxide is sequestered from a waste gas from industrial process [305] gas to create a slurry [325] comprising carbonic acid, bicarbonates, carbonates, or a mixture thereof and an effluent gas [320] that is reduced in carbon dioxide relative to the incoming waste gas. The sequestration process [315] may take in a proton removing agent [330], waste gas [310] from an industrial process [305] and optionally, a cation containing aqueous solution [306]. The origin of the divalent cation solution [306] may be any convenient source of divalent cation-containing solution including, but not limited to, a saline aquifer, a lake, a sea, an ocean, a repository for desalination waste brine, a repository of an industrial waste brine, or a repository for divalent cation-containing solution formed from, e.g., minerals, arkosic sands or industrial waste such as fly ash, cement kiln dust, or red mud. The cation may come from a subterranean brine. The waste gas may originate from an industrial process that produces carbon dioxide, such as the burning of a fossil fuel or calcining in a cement plant. The origin of the proton removing agent [330] may be any convenient source of alkalinity (e.g., metal oxides). The proton removing agent may come from the same or a different subterranean brine. The effluent gas [320] resulting from the sequestration process may be reduced not only in carbon dioxide but also in sulfur oxides. The slurry [325] resulting from the sequestration process contains solid precipitates containing carbonates. These solid precipitates contain some of the carbon dioxide from the waste gas. The carbonate solids are optionally separated from the supernatant solution in a separation system [340] to form a high solid slurry [345] that may be used in further beneficial reuse [355] materials and/or processes such as, but not limited to, building materials fabrication processes, soil amendment composition production, lubricant production, paint production, or land fill processes, or sent to a storage location [350]. The effluent supernatant solution may be disposed to the reservoir (e.g. subterranean location) from whence it came, recalculated to the precipitator, sent to a desalination process, pH treated and released to an ocean, lake, or sea, or used in any other appropriate process.

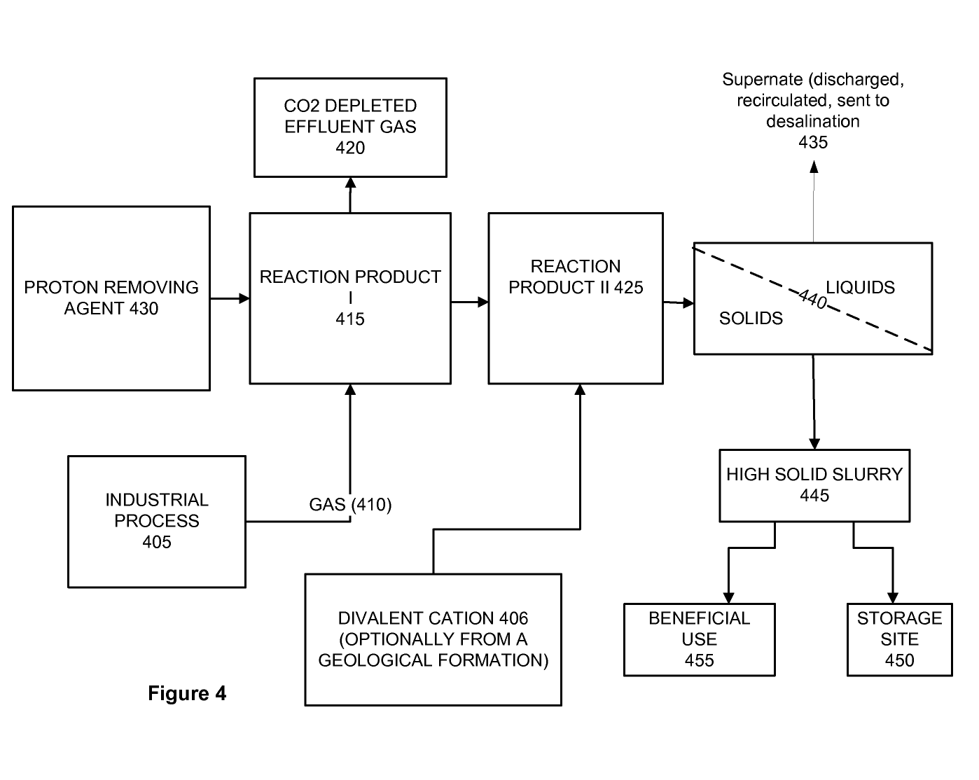

FIG. 4 shows one embodiment of the invention that provides a process in which carbon dioxide is sequestered from a waste gas from industrial process [405] gas to create a first reaction product [415] and then after a second reaction, a second reaction product [425]. The first reaction product may be a liquid such as a clear liquid comprising water, carbonic acid, bicarbonates, carbonates, or a mixture thereof and release an effluent gas [420] that is reduced in carbon dioxide relative to the incoming waste gas. The second reaction product [425] may be a slurry. The first reaction process may take in a proton removing agent [430], waste gas [410] from an industrial process [405]. The second reaction product may take in a divalent cation containing aqueous solution [406]. The origin of the divalent cation solution [406] may be any convenient source of divalent cation-containing solution including, but not limited to, a subterranean brine, a saline aquifer, a lake, a sea, an ocean, a repository for desalination waste brine, a repository of an industrial waste brine, or a repository for divalent cation-containing solution formed from, e.g., minerals or industrial waste such as fly ash, cement kiln dust, or red mud. The divalent cation may come from a subterranean brine. The waste gas may originate from an industrial process that produces carbon dioxide, such as the burning of a fossil fuel or calcining in a cement plant or smelting. The origin of the proton removing agent [430] may be any convenient source of alkalinity as discussed above. In some embodiments, the proton removing agent may come from a subterranean brine. The effluent gas [420] resulting from the sequestration process may be reduced not only in carbon dioxide but also in sulfur oxides. The second reaction product [425] resulting from the sequestration process may contain solid precipitates containing carbonates. These solid precipitates contain some of the carbon dioxide from the waste gas. The carbonate solids may be optionally separated from the supernatant solution in a separation system [440] to form a high solid slurry [445] that may be used in further beneficial reuse [455] materials and/or processes such as, but not limited to, building materials fabrication processes, soil amendment composition production, lubricant production, paint production, or land fill processes, or sent to a storage site [450] (e.g., a subterranean storage site). The effluent supernatant solution may be disposed to the reservoir from whence it came, recalculated to the precipitator, sent to a desalination process, pH treated and released to an ocean, lake, or sea, or used in any other appropriate process.

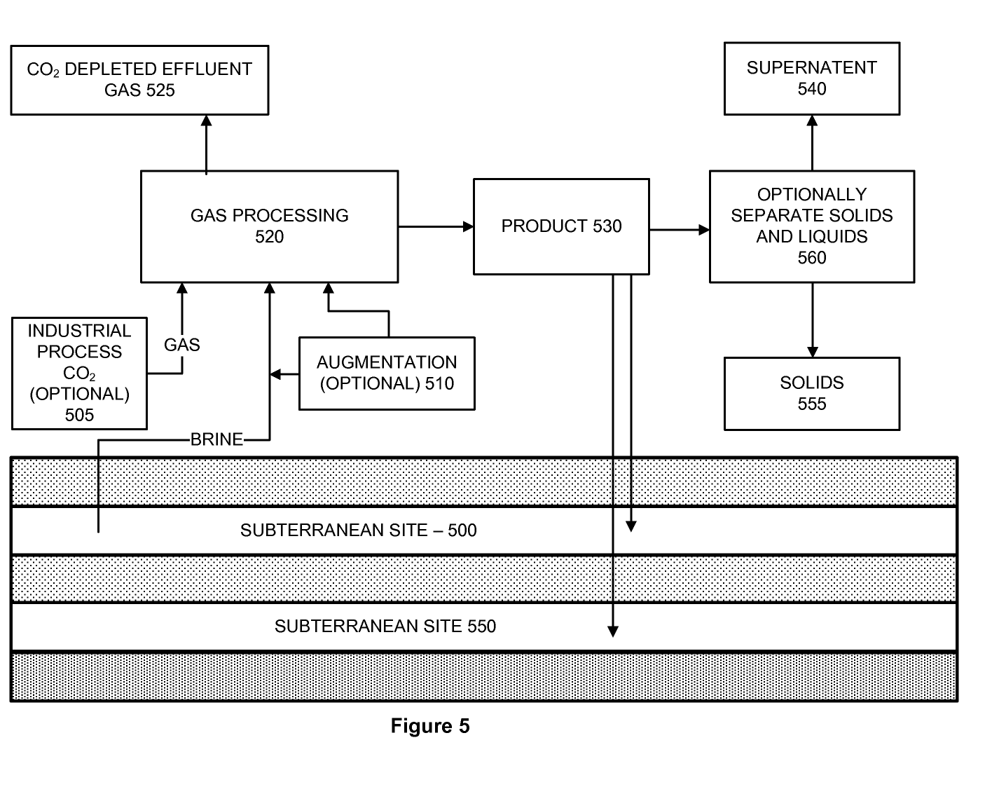

FIG. 5 provides a process in which carbon dioxide is sequestered from a industrial process [505] to create a carbon containing product made up of carbonic acid, bicarbonate, carbonate or a mixture thereof [530] and an effluent gas [525] that is reduced in carbon dioxide relative to the incoming waste gas. The sequestration process [520] may take in an aqueous brine from a subterranean location [500] and CO₂ from an industrial process [505]. In some embodiments, the brine may be a source of carbon and preclude the use of a gaseous source of carbon dioxide to form carbonates. The brine may be optionally augmented [510] or adjusted to improve the reactivity with carbon dioxide or other species in a waste gas. Augmentation [510] or treatment may occur before or during contact with carbon dioxide from the industrial process. The aqueous brine may be used without treatment in the gas sequestration process [520], or it may be adjusted by any convenient means to improve conditions under which the carbon dioxide of the waste gas can be sequestered into a product. Methods of this invention for ajusting brines are disclosed above. The origin of the aqueous brine may be a subterranean location [500], e.g., a geological formation. The waste gas may originate from an industrial process [505] that produces carbon dioxide, such as the burning of a fossil fuel or calcining in a cement plant or smelting. The effluent gas [525] resulting from the sequestration process may be reduced not only in carbon dioxide but also in sulfur oxides as well. During, the sequestration process, [520] a waste gas that contains carbon dioxide may contacted with an aqueous solution, which may be solely the aqueous brine or an aqueous brine with augmentation. The reaction product [530] resulting from the sequestration process may be a clear liquid. In some embodiments the reaction product may be a slurry that contains solid precipitates comprising any combination of bicarbonates and/or carbonates and liquid comprising and combination of bicarbonates and carbonic acid. The reaction product may be a solid material comprising vaterite, amorphous calcium carbonate, aragonite or a combination thereof. The reaction product [530] may be transported to a storage site, such as a subterranean location [550], e.g., geological formation. The subterranean location may be the same [500] or a separate [550] subterranean location as the location of the subterranean brine used to react with carbon dioxide. In some embodiments, the product may be separated into solid and liquid components [560], including the bicarbonate and/or carbonate solids. In some embodiments, the solids [555] may be used further in beneficial reuse materials and/or processes such as, but not limited to, building materials fabrication processes, soil amendment composition production, lubricant production, paint production, land fill processes or a combination of any of these processes. The effluent supernatant solution [540] may be disposed to a subterranean site (e.g., the same or different location as the location from which subterranean brine used to react with carbon dioxide was removed). In some embodiments the supernatant solution [540] may be disposed of from the reservoir from whence it came, recirculated to the precipitator, sent to a desalination process, pH treated and released to an ocean, lake, or sea, or used in any other appropriate process. The effluent supernatant [540] may be optionally fed into the proton removing process to regenerate material to process the waste gas.

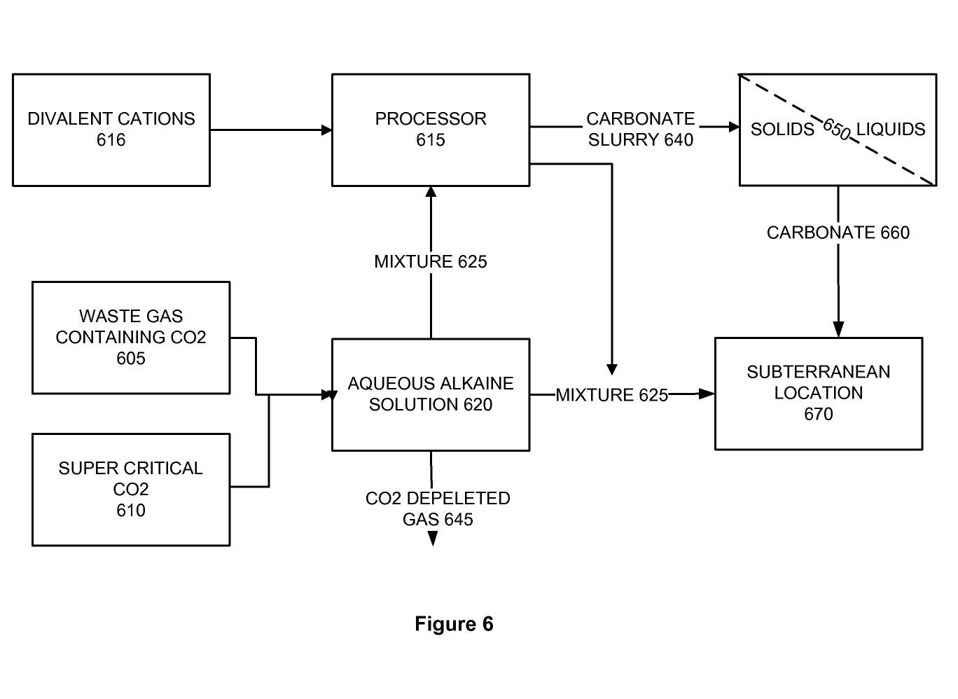

FIG. 6 provides a process in which carbon dioxide may be sequestered from an industrial waste gas [605] and/or super critical carbon dioxide [610]. The waste gas [605] may originate from an industrial process that produces carbon dioxide, such as the burning of a fossil fuel or calcining in a cement plant. The waste gas [605] may be directed to an alkaline aqueous solution [620], for example, an aqueous solution from a naturally occurring or augmented brine, or an alkaline aqueous solution derived from an electrochemical process. A solution or slurry such as bicarbonate, or carbonate mixture [625] may be produced. In the aqueous alkaline solution, carbon dioxide may be converted to any species such as carbonic acid, carbonate, or bicarbonate, to produce an effluent gas [645], in which the content of carbon dioxide has been reduced, and a carbonate mixture [625] that has incorporated carbon dioxide from the waste gas. The carbonate mixture [625] may be transported to a subterranean location [670]. Alternatively, the mixture may be transported to a processor [615], to which a solution containing divalent cations [616] may be added. The origin of the divalent cation solution may be any convenient source of divalent cation-containing solution as disclosed above including, but not limited to, a saline aquifer, a lake, a sea, an ocean, a repository for desalination waste brine, a repository of an industrial waste brine, or a repository for divalent cation-containing solution formed from, e.g., minerals or industrial waste such as fly ash, cement kiln dust, red mud or a subterranean brine. The processor [615] may be configured to produce conditions that favor the formation of a carbonate-containing slurry [640] from the bicarbonate [630] and divalent cation solution [620]. The carbonate slurry [640] may comprise solid precipitates containing carbonates. These solid precipitates may contain some of the carbon dioxide from the waste gas [605] or purified CO₂ [610]. The carbonate slurry may be sequestered in a subterranean location. The carbonate solids [660] may be optionally separated from the supernatant solution in a separation system [630] and may be used in further materials and/or processes such as, but not limited to, building materials fabrication processes, soil amendment composition production, lubricant production, paint production, land fill processes, or sent to a storage location. The effluent supernatant solution may be disposed to a reservoir, recirculated to the precipitator, sent to a desalination process, pH treated and released to an ocean, lake, or sea, or used in any other appropriate process. In an alternative embodiment, the carbonate slurry [640] may be transported to a subterranean location [670].

In embodiments of the invention, the source of one or more proton-removing agents and the source of one or more divalent cations may be contacted with the bicarbonate composition in any order while practicing methods of the invention. In some instances, the bicarbonate composition is contacted with the proton removing agent and the divalent cations simultaneously. In other instances, the bicarbonate composition is contacted with the proton removing agent and the divalent cations sequentially. In certain instances, a first portion of the bicarbonate composition may be contacted with the proton removing agent and the divalent cations simultaneously and a second portion of the bicarbonate composition may be contacted with the proton removing agent and the divalent cations sequentially.

Contacting the bicarbonate composition with a source of one or more proton removing agents and a source of one or more divalent cations may produce a carbonate-containing reaction mixture. The proton removing agents and or the divalent cations may be derived from a subterranean brine. In some embodiments, methods of the inventions include subjecting the carbonate-containing reaction product to precipitation conditions to produce a carbonate-containing precipitation material and a depleted brine. The carbonate-containing precipitation material of the invention includes precipitated crystalline and/or amorphous carbonate compounds. The carbonate compound compositions of the invention may include metastable carbonate compounds (e.g., CaCO₃). The reaction product may be subjected to carbonate compound precipitation conditions one or more times, sufficient to produce a carbonate-containing precipitation material and a depleted brine from the carbonate-containing reaction product. In some embodiments, the carbonate-containing compound is a carbonate-containing precipitation material. Some or all of the bicarbonate composition may be employed in producing a carbonate-containing precipitation material. In some embodiments, 1% or greater of the bicarbonate composition may be employed in producing a carbonate-containing precipitation material, such as 5% or greater of the bicarbonate composition, such as 10% or greater of the bicarbonate composition, such as 25% or greater of the bicarbonate composition, such as 50% or greater of the bicarbonate composition, such as 75% or greater of the bicarbonate composition, such as 90% or greater of bicarbonate composition, such as 95% or greater of the bicarbonate composition, and including 99% or greater of the bicarbonate composition.

As described above, when carbon dioxide is contacted with a solution that possesses sufficient alkalinity, some or all of the carbon dioxide that is contacted with the solution is converted to bicarbonate. As such, in these embodiments, the alkaline solution requires only one mole of additional proton-removing agent for every one mole of CO₂ contacted with the alkaline solution to produce carbonate (CO₃²⁻). In other words, when the alkaline solution possesses sufficient alkalinity to deprotonate carbonic acid to produce a bicarbonate composition, producing carbonate from the bicarbonate composition according to methods of the invention may require a 1:1 molar ratio of proton-removing agent to CO₂.

In some embodiments, producing a carbonate-containing precipitation material from the bicarbonate composition includes contacting the bicarbonate composition with an amount of one or more proton-removing agents. Depending on the alkalinity of the solution, in some embodiments, the bicarbonate composition may be a mixture of bicarbonate and carbonic acid. For example, the molar ratio of bicarbonate to carbonic acid (HCO₃⁻/H₂CO₃) in the bicarbonate composition may vary, e.g., 1/1 or greater, such as 2/1 or greater, such as 5/1 or greater, such as 10/1 or greater, such as 50/1 or greater, such as 100/1 or greater, such as 1000/1 or greater, such as 10,000/1 or greater, such as 100,000/1 or greater, including 1,000,000/1 or greater. As such, the amount of proton-removing agent added to the bicarbonate composition to produce carbonate may vary. In embodiments of the invention, the molar ratio of proton-removing agent to carbon dioxide contacted with the alkaline brine (proton-removing agent/CO₂) ranges from 1/1 to 2/1, such as 1.1/1, such as 1.25/1, such as 1.5/1, such as 1.75/1, such as 1.9/1, including 1.95/1. Where the bicarbonate composition is entirely bicarbonate, only one mole of proton-removing agent is required for every one mole of carbon dioxide contacted with the alkaline solution. The alkaline solution may utilize a proton removing agent as described above.

In some embodiments of the invention a solution or slurry is produced that contains at least 25% of the carbon dioxide that supercritical carbon dioxide does per unit volume. In some embodiments, a solution or slurry contains at least 25% of the carbon dioxide contained in the same volume of supercritical carbon dioxide at 73.8 bars and 30.95° C. In some embodiments, a solution or slurry contains at least 10%, at least 15%, at least 20%, at least 30%, at least 35%, at least 40%, at least 45%, at least 50%, at least 55%, at least 60%, at least 65%, at least 70%, at least 75%, at least 80%, at least 85%, at least 90%, at least 95% of the carbon contained in the same volume of supercritical carbon dioxide. In some embodiments, a solution or slurry contains at least 100% of the carbon contained in the same volume of supercritical carbon dioxide. In some embodiments the solution or slurry may contain more than 101% of the carbon contained in the same volume of supercritical carbon dioxide at 73.8 bars and 30.95° C. In some embodiments the reaction product may be a solution or slurry that has a density of carbon that is at least 0.45 g/cm³, in some cases at least 0.91 g/cm³.

In some embodiments, a solution or slurry used in the methods of the invention, e.g., for subterranean storage, contains at least 0.0025 mol/cm³ of CO₂ or carbon. In some embodiments, a solution or slurry contains at least 0.0010 mol/cm³, at least 0.0015 mol/cm³, at least 0.0020 mol/cm³, at least 0.0030 mol/cm³, at least 0.0035 mol/cm³, at least 0.0040 mol/cm³, at least 0.0045 mol/cm³, at least 0.0050 mol/cm³, at least 0.0055 mol/cm³, at least 0.0060 mol/cm³, at least 0.0065 mol/cm³, at least 0.0070 mol/cm³, at least 0.0075 mol/cm³, at least 0.0080 mol/cm³, at least 0.0085 mol/cm³, at least 0.0090 mol/cm³, at least 0.0095 mol/cm³, at least 0.001066 mol/cm³ of carbon. In some cases a reaction product of this invention may contain at least 0.0103 mol/cm³ of carbon. In the cases where a slurry is used, the slurry includes particulates that include carbonates and/or bicarbonates. In some embodiments, the slurry comprises at least 10% solids (by weight). In some embodiments, the slurry comprises at least 20% solids (by weight). In some embodiments, the slurry comprises at least 30% solids (by weight). In some embodiments, the slurry comprises at least 5%, at least 15%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 35%, at least 40%, at least 45% solids. In some embodiments, the slurry comprises 10% to 30% solids (by weight). In some embodiments, the slurry comprises 15% to 25% solids (by weight). In some embodiments, the slurry comprises 18% to 22% solids (by weight). In some embodiments, the slurry comprises 15% to 35% solids (by weight). In some embodiments, the slurry comprises 20% to 30% solids (by weight). In some embodiments, the slurry comprises 22% to 27% solids (by weight). In some embodiments, the slurry comprises 20% to 40% solids (by weight). In some embodiments, the slurry comprises 25% to 35% solids (by weight). In some embodiments, the slurry comprises 28% to 32% solids (by weight). The solutions or slurries in some embodiments are used as alternatives to supercritical carbon dioxide in subterranean storage.

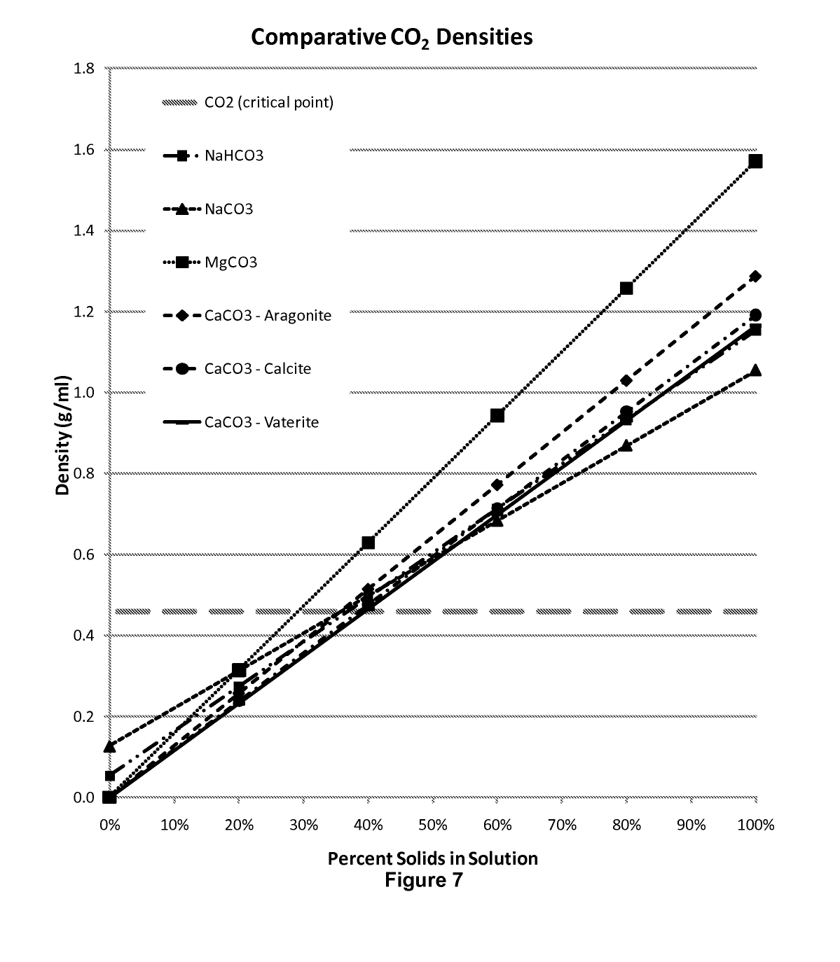

FIG. 7 shows a comparison of the grams of carbon dioxide per unit volume (milliliter or cubic centimeter) of slurries of carbonate or bicarbonate materials and pure water as a function of the percent solids for each type of slurry. A line is marked on the graph indicating the grams per unit volume for pure carbon dioxide gas at its critical point, such that it is supercritical carbon dioxide. That value is approximately 0.46 g/ml 0.46 g/cm³). It can be seen that at 40% solids and above, all slurries have at least as much carbon dioxide by mass per unit volume as supercritical carbon dioxide.

As described in detail above, any convenient precipitation conditions may be employed, which conditions result in the production of a carbonate-containing precipitation material and a depleted cation solution (e.g., depleted brine). For example, precipitation conditions to produce a carbonate-containing precipitation material from the carbonate-containing reaction product include, in certain embodiments, adjusting the temperature, pH or concentration of proton removing agents and divalent cations. Precipitation conditions may also include adjusting parameters such as mixing rate, forms of agitation such as ultrasonics, and the presence of seed crystals, catalysts, membranes, or substrates. In some embodiments, precipitation conditions include employing supersaturated conditions or concentration gradients, or cycling or changing any of these parameters. The protocols employed to prepare carbonate-containing precipitation material according to the invention may be batch or continuous protocols. It will be appreciated that precipitation conditions may be different to produce a given precipitation material in a continuous flow system compared to a batch system.

Contacting a bicarbonate composition with a source of one or more proton removing agents and a source of one or more divalent cations may occur before or during the time when the bicarbonate composition is subjected to precipitation conditions. Accordingly, embodiments of the invention include methods in which the bicarbonate composition may be contacted with a source of one or more proton removing agents and a source of one or more divalent cations prior to subjecting the bicarbonate composition to precipitation conditions. Embodiments of the invention also include methods in which the bicarbonate composition may be contacted with a source of one or more proton removing agents and a source of one or more divalent cations while the bicarbonate composition is being subjected to precipitation conditions. Embodiments of the invention also include methods in which the bicarbonate composition may be contacted with a source of one or more proton removing agents and a source of one or more divalent cations both prior to and at the same time as subjecting the bicarbonate composition to precipitation conditions.

In one embodiment a bicarbonate composition may result from contact between and alkaline brine and a divalent cation contain brine. A first brine may be alkaline due to the presence of carbonate or bicarbonate. A second brine may contain high levels of divalent cations (e.g., calcium). Also present in one or both of the brines may be silica, iron, and boron. In one embodiment of this invention a first alkaline brine may exist in close proximity to a second divalent cation containing brine. Divalent cations present in brine may include magnesium, calcium or some mixture thereof. When mixed, a supernatant and precipitate may form comprising metal ion carbonates and/or bicarbonates, including calcium carbonates. Precipitated carbonates of this invention may form particular polymorph conformations. In one embodiment the precipitated carbonate may form vaterite, aragonite, amorphous calcium carbonate or some combination thereof. Precipitated carbonates of this invention may have calcium: magnesium ratios that facilitate the formation of a particular polymorph configuration. In embodiments of this invention, the calcium:magnesium ratio of the precipitated carbonate may be between 10:1 and 1000:1 such as between 50:1 and 500:1. Such carbonate precipitates may optionally incorporate silica found in the either the carbonate brine or the divalent cation containing brine. The resulting carbonate and/or bicarbonate containing precipitates may be used for non-cementitious applications such as filler for paper, paint, lubricants, food products, and medicines, etc. The precipitates may also be used to produce cementitious compositions such as SCM, cement, concrete, aggregate, soil stabilization mixtures, etc.

Where there are alkaline brines and divalent cations available in close proximity to CO₂ source, (e.g., a fossil fuel fired power plant), products as described above may be precipitated utilizing CO₂ from a waste gas or super critical fluid for a portion of the precipitated carbonate species. In an alternative embodiment, the resultant supernatant may be used to sequester CO₂ as a bicarbonate solution or slurry, either by using remaining brine carbonate alkalinity, or by adding additional alkalinity to the supernatant prior to or at the same time as exposure of the supernatant to the CO₂.

Business Methods

Reduction of carbon dioxide release into the atmosphere can be accomplished through storage, sequestration, and avoidance. Avoidance includes using alternate methods or materials to accomplish a task or produce an article. An example of avoidance is using a cementitious material that does not require calcination and does not release CO₂ into the air in because of calcination to fabricate a building material. Storage is the act of capturing and trapping carbon dioxide in a structural or hydrodynamic manner, which is potentially a shorter-term method. An example of storage is the compression of carbon dioxide gas after capture to create super-critical carbon dioxide, which is then injected into subterranean geological formations of suitable impermeability and stability. Sequestration requires capturing carbon dioxide and bonding the carbon in geologically stable form. An example of sequestration is the formation of carbonate materials from the interaction of carbon dioxide gas with solutions or solids.

Quantification of the amount of carbon dioxide captured or avoided may be quantified using any convenient method. In avoidance, knowledge of the amount carbon dioxide typically produced in a conventional process is needed. The amount of carbon dioxide produced by the alternate method is subtracted from the amount of carbon dioxide produced in a conventional method to yield the carbon dioxide avoided. In capture and storage, the amount of compressed carbon dioxide gas or super-critical carbon dioxide liquid pumped into receptacles can be actually measured. Alternatively, measurements of the gas from which the carbon dioxide was captured and the effluent gas from the capture process can be taken to determine the amount of carbon dioxide that the process removed. In capture and sequestration, the same type of measurement of the carbon dioxide containing gas before and after the capture and sequestration process can be done to quantify the amount of carbon dioxide sequestered. Alternatively, the amount of carbon-containing material produced by the sequestration process can be measured, and the amount of carbon dioxide sequestered can be calculated based upon the chemical reactions involved in the process.

There exist numerous agencies for the exchange of quantified amounts of captured and/or sequestered carbon dioxide as tradable commodities. Such agencies and methods of creating and trading commodities based upon sequestered carbon dioxide are discussed in more detail in U.S. patent application Ser. No. 12/557,492, herein incorporated by reference in its entirety.

In some embodiments there are two entities that capture and sequester or store CO₂, Entity 1 and Entity 2. The entities benefit by working together in that a source material for Entity 1's process originates in a storage location for Entity 2, thereby increasing the amount of CO₂ that can be sequestered by both entities. This increase in sequestered CO₂ results in increased eligibility for tradable commodities based upon carbon.

| Source Material for Entity 1 | Source |
|---|---|
| Aqueous solution | Subterranean location |
| | (storage location for Entity 2) |
| Carbon dioxide containing gas | Flue gas from industrial process or |
| | Carbon capture process (Entity 2) |
| Source Material for Entity 2 | Source |
| Carbon dioxide gas, purified | Carbon capture process |
| | or Entity 1 |
| Repository | Entity 1 or Other |
| | suitable and available |
| | subterranean location |
| Products of Entity 1 | Uses |
| Solution containing CO₂ | Discharge to body of water or |
| | beneficial reuse |
| Slurry containing CO₂ | Discharge to body of water, land-based |
| | storage location, or beneficial reuse |
| Separated Precipitated and Solid | Discharge to body of water, land-based |
| Material containing CO₂ | storage location, or beneficial reuse |
| Products of Entity 2 | Uses |
| Stored Super-Critical CO₂ | Obtain carbon-based tradable |
| | commodities |
| Super-critical CO₂ | Source material for Entity 1 |

Entity 1 utilizes an aqueous solution that includes cations to contact a source of carbon dioxide, typically a flue gas from an industrial plant or process. In this embodiment, the aqueous solution is a brine originating in a subterranean location, such as an aquifer. Entity 1 creates either a solution, slurry, or separated precipitate particulates from the contact between the carbon dioxide and aqueous solution. The carbon dioxide-sequestering solution, slurry, or separated precipitate may be released to a body of water for long-term storage. The carbon dioxide-sequestering slurry or precipitate material may also be disposed of to land-based storage locations, both subterranean and above ground. Subterranean storage locations include industrial excavations, such as mines or wells that are no longer in service, and geological formations, some of which are unsuitable for storage of supercritical carbon dioxide due to potential leakage or instability. The slurry and precipitated material may also be used in beneficial reuse materials and processes. Beneficial reuse indicates that the material replaces one that emits a significant amount of carbon dioxide in its processing. An example of beneficial reuse, is the substitution of conventional cement with carbon dioxide-sequestering precipitated material. The cement fabrication process emits much carbon dioxide in the calcining of limestone to create lime. Replacing some conventional cement material with another material that does not involve calcination avoids emission some of carbon dioxide due to calcination. Entity 1 may also create a stream of high-purity carbon dioxide gas. This stream of gas may be transferred to Entity 2 for conversion to supercritical CO₂ for storage.

Entity 2 creates a stream or supply of supercritical carbon dioxide and places supercritical carbon dioxide is a suitable subterranean location. In the event that a subterranean location is unsuitable for storage, Entity 2 may collaborate with Entity 1.

In one embodiment, Entity 1 removes geological brine from an aquifer owned by Entity 2 to render it useable by Entity 2. In this embodiment, Entity 2 benefits by obtaining additional storage space which translates into more carbon dioxide sequestered (stored) and potentially more tradable commodities obtained. Entity 1 benefits by obtaining an aqueous solution for sequestering carbon dioxide. Entity 2 compensates Entity 1 for the energy required to empty the aquifer in either money or a percentage of the tradable commodities obtained by Entity 2.

In another embodiment, Entity 1 removes geological brine from an aquifer owned by Entity 2. The aquifer is not suitable for storage of supercritical carbon dioxide because of the possibility of instability or leakage. Entity 2 passes supercritical CO₂ to Entity 1. Entity 1 creates a carbon dioxide-sequestering slurry by contacting the supercritical CO₂ from Entity 2 with the brine from the aquifer. Entity 1 places the slurry in the aquifer for long-term storage. In some cases, Entity 1 may remove some of the liquid component of the slurry to increase the percent solids of the slurry. The removed liquid component may be recycled or disposed of by Entity 1. Entity 2 benefits by sequestering the supercritical carbon dioxide that it captured in a stable form and obtains tradable commodities based upon the captured and sequestered carbon dioxide. Entity 1 benefits by being compensated by Entity 2 for the process of creating a stable material for storage of captured CO₂ and placing the material in the aquifer.

In yet another embodiment, Entity 1 removes geological brine from an aquifer owned by Entity 2. The aquifer is not suitable for storage of supercritical carbon dioxide because of the possibility of instability or leakage. Entity 2 passes supercritical CO₂ to Entity 1. Entity 1 creates carbon dioxide-sequestering particulate material and an effluent liquid by contacting the supercritical CO₂ from Entity 2 with the brine from the aquifer. Entity 1 uses the carbon dioxide-sequestering precipitate material in beneficial reuse applications or materials. The effluent liquid component may be recycled or disposed of by Entity 1. The effluent liquid may be disposed of to the aquifer from which the brine was removed. Entity 2 benefits by sequestering the supercritical carbon dioxide that it captured in a stable form and obtains tradable commodities based upon the captured and sequestered carbon dioxide. Entity 1 benefits by being compensated by Entity 2 for the process of creating a stable material for storage of captured CO₂ and placing some of material and/or effluent liquid in the aquifer. Entity 1 may also benefit by earning tradable commodities for carbon dioxide avoided through beneficial reuse.

In another embodiment, Entity 1 removes geological brine from an aquifer owned by Entity 2 to render it useable by Entity 2. Entity 1 produces a stream of high-purity CO₂ that is passed to Entity 2. Entity 2 processes the stream of high-purity CO₂ gas into supercritical CO₂ and places it in the useable aquifer along with supercritical CO₂ gas from other carbon dioxide capture activities. Entity 1 also produces either a slurry or precipitation material that sequesters carbon dioxide as well. Entity 1 disposes of the slurry or precipitation material as is most beneficial to Entity 1. Entity 1 and Entity 2 have agreed to exchange the stream of high-purity CO₂ gas without compensation paid by either entity. Entity 1 has agreed to remove brine from the aquifer without compensation. Entity 1 benefits by earning tradable commodities for carbon dioxide avoided through beneficial reuse. Entity 2 benefits by obtaining additional storage space and carbon dioxide, which translates into more carbon dioxide sequestered (stored) and potentially more tradable commodities obtained.

In one embodiment, a collaboration between two entities may occur, wherein one entity removes brine from an aquifer, creates a carbonate and/or bicarbonate slurry from a divalent cation solution derived from the brine, and a carbon dioxide source. Another entity may deposit supercritical carbon dioxide into the aquifer that the brine was removed from. An alternative collaboration may be one in which one entity removes brine from an aquifer, creates a carbonate and/or bicarbonate slurry from a divalent cation solution derived from the brine, and a carbon dioxide source, creates a carbon dioxide gas stream suitable for supercritical carbon dioxide formation, and another entity creates and stores the supercritical carbon dioxide in a suitable subterranean repository. Further permutations of collaborations may be configured such that more than two entities are involved. Following the steps of carbon dioxide capture, storage, sequestration, beneficial reuse, and avoidance, the amount of carbon dioxide kept from reaching the earth's atmosphere is calculated. From those calculations, exchangeable items, e.g., carbon credits, carbon allowances, are obtained and used to the benefit of the entities involved in the process.

Monitoring Product Formation

In some embodiments, methods of the invention include monitoring the reaction product that is produced by contacting carbon dioxide with an alkaline solution (e.g., a subterranean brine). In some embodiments, methods of the invention also include monitoring a reaction product that is produced by contacting an aqueous solution comprising carbonic acid, bicarbonate, carbonate or any mixture thereof with the divalent cation solution. The reaction product may be compositions such as aqueous mixtures, slurries or precipitates comprising carbonic acid, bicarbonate, carbonate or any mixture thereof. For example, monitoring a reaction product may include, but is not limited to, monitoring the chemical makeup (e.g., inorganic composition, bicarbonate concentration, organic composition, and isotopic composition), physical properties (e.g., pH, boiling point, and polydispersity), spectroscopic properties and electrochemical properties of the reaction product of this invention.

In some embodiments, monitoring the chemical makeup of the product of the methods of this invention includes determining the inorganic composition of the reaction product. Depending on the aqueous mixture from which the reaction product is produced, the inorganic composition may vary. In some embodiments, the product may contain metal cations. In some instances, the metal cations may be one or more monovalent cations, such as Li⁺, Na⁺, K⁺, etc. Alternatively or in addition, the metal cations may be one or more divalent cations, such as Ca²⁺, Mg²⁺, Sr²⁺, Ba²⁺Mn²⁺, Cu²⁺, Zn²⁺, Fe²⁺, etc. The amount of metal cations present in the reaction product may vary, for example, ranging from 50 to 100,000 ppm, such as 100 to 90,000 ppm, such as 250 to 75,000 ppm, such as 500 to 50,000 ppm, such as 750 to 40,000 ppm, such as 1000 to 30,000 ppm, including 1000 to 25,000 ppm, for example 1500 to 10,000 ppm.

The aqueous mixture that is the product of this invention may, in some embodiments, be derived from brines obtained from locations rich in trace metal elements (e.g., metal ore mines, petroleum fields, etc.). The carbonate containing compositions of the invention may also include one or more trace metals. For example, the bicarbonate composition may contain aluminum, lead, cesium and cadmium among other trace metals. The amount of trace metals in the bicarbonate composition may vary, for example, ranging from 1 to 250 ppm, such as 5 to 250 ppm, such as from 10 to 200 ppm, such as from 15 to 150 ppm, such as from 20 to 100 ppm, including 25 to 75 ppm.

In some instances, determining the inorganic composition of the carbonate composition of this invention includes determining the anion composition of the composition. As noted above, depending on the aqueous mixture from which the composition is produced, the types of anions present in the composition may vary. In some embodiments, anions present in the carbonate composition may include halides, such as Cl⁻, F⁻, I⁻, and Br⁻. Alternatively or in addition, anions present in a bicarbonate composition may include oxyanions, e.g., sulfate, borate, nitrate, among others. The amount of anions present in bicarbonate compositions of the invention may vary, the amount ranging, from 50 to 100,000 ppm, such as 100 to 90,000 ppm, such as 250 to 75,000 ppm, such as 500 to 50,000 ppm, such as 750 to 40,000 ppm, such as 1000 to 30,000 ppm, including 1000 to 25,000 ppm, for example 1500 to 10,000 ppm.

In some embodiments, monitoring the chemical makeup of reaction products of this invention includes determining the concentration of bicarbonate in the reaction products. In embodiments of the invention, the concentration of bicarbonate may vary, as desired, and may be 0.1M or greater, such as 0.5 M or greater, such as 0.75 M or greater, such as 1.0 M or greater, such as 1.5 M or greater, such as 2.0 M or greater, such as 5.0 M or greater, such as 7.5 M or greater, including 10 M or greater. As such, the percent by weight of the bicarbonate composition that is bicarbonate may be, in some instances, 0.01% bicarbonate by weight or greater, such as 0.1% bicarbonate by weight or greater, such as 0.5% bicarbonate by weight or greater, such as 1% bicarbonate by weight or greater, such as 5% bicarbonate by weight or greater, such as 10% by weight or greater, such as 25% by weight or greater, and including 50% bicarbonate by weight or greater.

In some embodiments, monitoring the chemical makeup of the reaction products (e.g., bicarbonate composition) includes determining the organic composition of the bicarbonate composition. “Organic” as used herein includes to the class of compounds which contain carbon and are composed of one or more carbon-carbon, carbon-hydrogen, carbon-nitrogen or carbon-oxygen bonds. Depending on the brine from which the reaction products are produced, organic compounds present in the bicarbonate composition may vary and may include but are not limited to formate, acetate, propionate, butyrate, valerate, oxalate, malonate, succinate, glutarate, phenol, methylphenol, ethylphenol, and dimethylphenol. The amount of organic compounds present in the bicarbonate composition may range, for example, from 1 to 200 mmol/liter, such as 1 to 175 mmol/liter, such as 1 to 100 mmol/liter, such as 10 to 100 mmol/liter, including 10 to 75 mmol/liter.

In some embodiments, monitoring the chemical makeup of the composition includes determining the isotopic composition of the aqueous mixture comprising carbonic acid, carbonate, bicarbonate or any combination thereof. As discussed in detail above, when the aqueous mixture comprises a brine, the isotopic composition may vary depending on the factors which influenced its formation and the location from which it is obtained. Many elements have stable isotopes, and these isotopes may be preferentially used in various processes, e.g., biological processes and as a result, different isotopes (e.g., carbon, oxygen, sulfur, nitrogen, etc.) may be present in bicarbonate composition in distinctive amounts.

In some embodiments, the δ¹³C value of carbon present in compositions of this invention may vary, ranging between −1‰ to −50‰. In some embodiments the carbon in the product and method of this invention has a δ¹³C value of between 0 and +20‰. In some embodiments the carbon in the product and method of this invention has a δ¹³C value of less than −10‰. In some embodiments, the δ¹³C value for the bicarbonate composition may be between −1‰ and −50‰, between −5‰ and −40‰, between −5‰ and −35‰, between −7‰ and −40‰, between −7‰ and −35‰, between −9‰ and −40‰, or between −9‰ and −35‰. In some embodiments, the δ¹³C value for the bicarbonate composition may be less than (i.e., more negative than) −3‰, −5‰, −6‰, −7‰, −8‰, −9‰, −10‰, −11‰, −12‰, −13‰, −14‰, −15‰, −16‰, −17‰, −18‰, −19‰, −20‰, −21‰, −22‰, −23‰, −24‰, −25‰, −26‰, −27‰, −28‰, −29‰, −30‰, −31‰, −32‰, −33‰, −34‰, −35‰, −36‰, −37‰, −38‰, −39‰, −40‰, −41‰, −42‰, −43‰, −44‰, or −45‰, wherein the more negative the δ¹³C value, the more rich the bicarbonate composition is in ¹²C.

In some embodiments, methods of the invention also include determining the ratio of strontium-87 to strontium-86 (⁸⁷Sr/⁸⁶Sr) in the bicarbonate composition. The strontium-87 to strontium-86 ratio of bicarbonate compositions of the invention may vary, ranging between 0.71/1 and 0.85/1, such as between 0.71/1 and 0.825/1, such as between 0.71/1 and 0.80/1, such as between 0.75/1 and 0.85/1, and including between 0.75/1 and 0.80/1.

In other embodiments, monitoring the bicarbonate composition may include monitoring the physical properties of the bicarbonate composition. In some instances, monitoring the physical properties of the bicarbonate composition includes determining the pH of the bicarbonate composition. Depending on the concentration of bicarbonate in the bicarbonate composition, as described above, the pH of the bicarbonate composition may vary. In some instances, the bicarbonate composition has a pH ranging from 7.1 to 11, such as 8 to 11, such as 8 to 10, and including 8 to 9. For example, the pH of the alkaline brine may be 7.5 or higher, such as 8.0 or higher, including 8.5 or higher.

In other instances, monitoring the physical properties of the aqueous mixture includes determining the boiling point. “Boiling point” as used herein refers to the temperature at which the vapor pressure of a liquid equals to the surrounding pressure around the liquid. Depending on the concentration of bicarbonate aqueous mixture, as described above, the boiling point may vary. In some instances, the boiling point of aqueous mixture is 90° C. or greater, such as for example, 100° C. or greater, such as 105° C. or greater, such as 110° C. or greater, such as 115° C. or greater, including 120° C. or greater.

In other instances, monitoring the physical properties of the reaction product of this invention includes determining the polydispersity of solid bicarbonate particles in the aqueous mixture. In some embodiments, depending on the conditions employed to produce the reaction product, the aqueous mixture may contain an amount of precipitated bicarbonate. As such, the reaction product may be a colloidal suspension composed of solid bicarbonate particles in a bicarbonate aqueous solution or may be a viscous slurry of bicarbonate. “Polydispersity” as used herein refers to the distribution (i.e., range) of sizes of solid particles of bicarbonate in the reaction product. In some embodiments, the size of bicarbonate particles in the bicarbonate composition ranges greatly, such as from 0.01 μm to 10 μm, such as 0.025 to 5 μm, such as 0.050 to 25 μm, such as 0.075 to 2 μm, including 0.1 to 1 μm.

In some embodiments, methods of the invention include assessing and regulating the amount of reaction product (e.g., aqueous solution comprising carbonic acid, bicarbonate, carbonate, or combinations thereof), that is sequestered and the amount of reaction product that is employed in producing a carbonate-containing compound. In some instances, the amount of the reaction product sequestered may be 1% or greater of a bicarbonate composition, such as 5% or greater, such as 10% or greater, such as 25% or greater, such as 50% or greater, such as 75% or greater, such as 90% or greater, such as 95% or greater, and including 99% or greater of a bicarbonate composition. In these instances, the remainder of the bicarbonate composition may be employed to produce a carbonate-containing compound or alternatively, may be employed for some other function, as desired, e.g., acid-neutralization protocols. As such, the molar ratio of reaction product that is sequestered to reaction product that is employed to produce a carbonate-containing compound may vary, and in some instances may range between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, the molar ratio of reaction product that is sequestered to reaction product that is employed to produce a carbonate-containing compound may range between 1:1 and 1:10; 1:5 and 1:25; 1:10 and 1:50; 1:25 and 1:100; 1:50 and 1:500; or 1:100 and 1:1000. In other embodiments, the molar ratio of bicarbonate composition that is employed to produce a carbonate-containing compound to bicarbonate composition that is sequestered ranges between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, the molar ratio of a bicarbonate composition that is employed to produce a carbonate-containing compound to bicarbonate composition that is sequestered may range between 1:1 and 1:10; 1:5 and 1:25; 1:10 and 1:50; 1:25 and 1:100; 1:50 and 1:500; or 1:100 and 1:1000.

The amount of the bicarbonate composition sequestered or employed to produce a carbonate-containing compound may be regulated by any convenient protocol. In some embodiments, regulating the amount of bicarbonate composition sequestered or employed to produce a carbonate-containing compound includes regulating the output flow of the bicarbonate composition from the bicarbonate composition production reactor (i.e., CO₂-contacting reactor). In embodiments of the invention, the output of the bicarbonate composition from the bicarbonate composition production reactor is adjustable at any time. By “adjustable” is meant that the intended destination (e.g., sequestration location, carbonate-compound production plant, etc.) and amount of bicarbonate composition conveyed from the bicarbonate composition production reactor can be changed or modified at any time. The output of the bicarbonate composition may be adjusted using any convenient protocol, such as for example, a manual control valve, a mechanical control valve, a digital control valve, a flow-control valve system, a flow regulator, or any other convenient protocol. In some instances, controlling the output of the bicarbonate composition to a sequestration location or to a carbonate-compound production plant may include employing a computer (where the flow regulator is computer-assisted or controlled entirely by a computer) that is configured to provide a user with input and output parameters to control the output of the bicarbonate composition from the bicarbonate composition production reactor.

Profile of Product Derived from a Subterranean Brine

The properties of a brine may impact the products of a reaction with carbon dioxide or the reaction conditions needed for reaction between the brine and carbon dioxide. The properties of the brine may also provide for an identifiable profile that may be detectable in the products of a reaction between a brine and carbon dioxide. Since subterranean brines may be obtained from varying locations, the factors which influence their composition may vary greatly, e.g., type of rock formations, amount of meteoric watering, proximity to a petroleum field or metal ore, etc. In addition, brine from different levels of the same aquifer may have differing and distinct compositions. As such, the composition of subterranean brines of this invention may vary. As the product compositions derived from methods of the invention may be from a subterranean brine, they may include one or more identifying component or ratio of components that are also present in the subterranean brine, where these identifying components or ratios thereof are collectively referred to herein as subterranean brine identifiable profile or ‘fingerprint’. In one embodiment of this invention, a carbon containing reaction product may be analyzed to determine if a particular subterranean brine is a component of the reaction product. In some embodiments the method comprises creating a profile of the reaction product and comparing it to a profile of a particular subterranean brine. In some embodiments obtaining the profile of the reaction product comprises determining the composition of trace elements or major components in a precipitate derived from that brine and carbon dioxide.

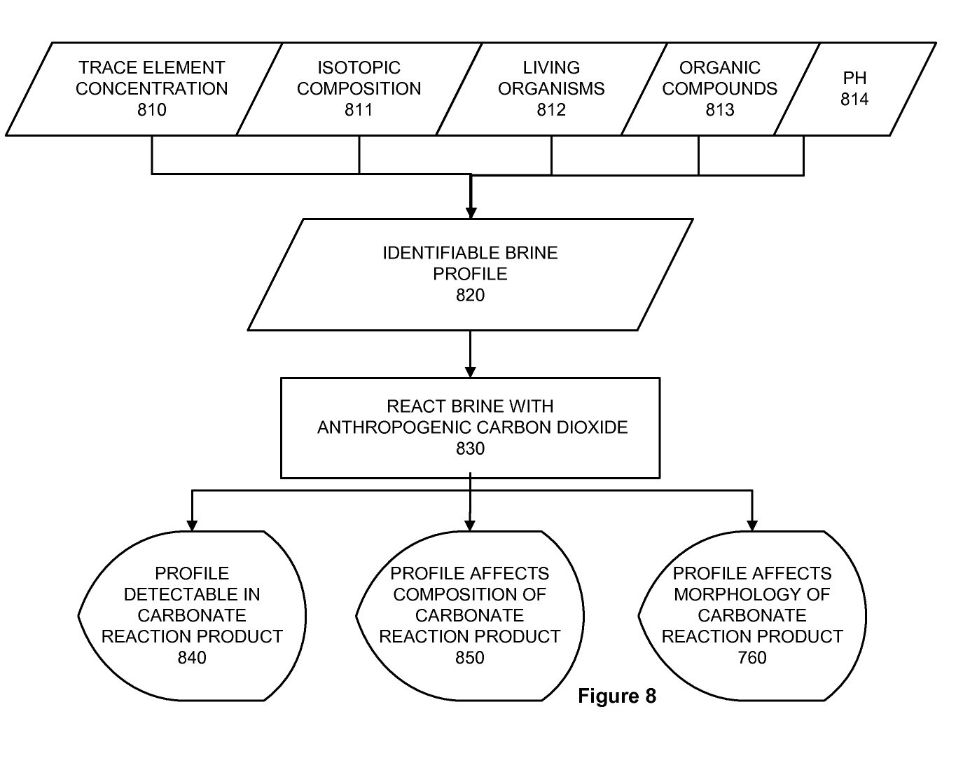

In some embodiments, subterranean brines of this invention may have distinct ranges or minimum or maximum levels of elements, ions, isotopes organic compounds, living organisms or other substances, which may create a distinct elemental profile in a carbon product of this invention. As outlined in FIG. 8, the properties of a brine may affect the reaction product [830] of the brine and carbon dioxide or the brine and an aqueous mixture of carbonic acid, carbonate, or bicarbonate. Aspects of the properties of a brine may be detectable as a trace component [840] or affect the composition [850] or morphology [860] of a reaction product with carbon dioxide. In some embodiments of this invention, the composition of a brine may be determined by determining properties of a precipitate derived from that brine and carbon dioxide.

The reaction product of a brine and carbon dioxide may be a carbonic acid, bicarbonate or carbonate or any combination thereof. In some embodiments the carbonate or bicarbonate composition maybe derived from alkaline brines obtained from locations rich in trace metal elements (e.g., metal ore mines, petroleum fields, etc.) or rare earth elements (e.g., lanthanum). Alkaline earth elements, rare earth elements or trace elements [810] that may become part of a precipitated material of this invention upon reaction with carbon dioxide may include for example, but not limited to: arsenic, selenium, mercury, lithium, sulfur, fluoride, potassium, bromide, silicon, strontium, boron, magnesium, iron, barium, neodymium and the like. In some embodiments, the products of this invention may include strontium, which may be present an amount of up to 10,000 ppm or less, ranging in certain embodiments from 3 to 10,000 ppm, such as from 5 to 5000 ppm, such as from 5 to 1000 ppm, e.g., 5 to 500 ppm, including 5 to 100 ppm. In other embodiments, the products of this invention may include barium, which may be present in the subterranean brine reactant or carbon containing product in an amount of up to 2500 ppm or less, ranging in certain instances from 1 to 2500 ppm, such as from 5 to 2500 ppm, such as from 10 to 1000 ppm, e.g., 10 to 500 ppm, including 10 to 100 ppm. In other embodiments, subterranean brines of the invention may include iron, which may be present in the carbon containing product in an amount of up to 5000 ppm or less, ranging in certain instances from 1 to 5000 ppm, such as from 5 to 5000 ppm, such as from 10 to 1000 ppm, e.g., 10 to 500 ppm, including 10 to 100 ppm. For example, the bicarbonate composition may contain aluminum, lead, cesium and cadmium among other trace metals. The amount of trace metals in the bicarbonate composition may vary, for example, ranging from 1 to 250 ppm, such as 5 to 250 ppm, such as from 10 to 200 ppm, such as from 15 to 150 ppm, such as from 20 to 100 ppm, including 25 to 75 ppm. In some embodiments the carbon in reaction products of this invention may have a δ¹³C of −10‰ or less and include at least one alkaline or rare earth element. In other embodiments the reaction products may have a second rare or alkaline earth element.

In other embodiments, subterranean brines of the invention may include lithium, which may be present in the subterranean brine reactant or the carbon containing product in an amount of up to 500 ppm or less, ranging in certain instances from 0.1 to 500 ppm, such as from 1 to 500 ppm, such as from 5 to 250 ppm, e.g., 10 to 100 ppm, including 10 to 50 ppm. In other embodiments, subterranean brine reactants or the carbon containing products of the invention may include fluoride, which may be present in the subterranean brine in an amount of up to 100 ppm or less, ranging in certain instances from 0.1 to 100 ppm, such as from 1 to 50 ppm, such as from 1 to 25 ppm, e.g., 2 to 25 ppm, including 2 to 10 ppm. In other embodiments, subterranean brine reactants or the carbon containing products of the invention may include potassium, which may be present in the subterranean brine reactant or the carbon containing product in an amount of up to 100,000 ppm or less, ranging in certain instances from 10 to 100,000 ppm, such as from 100 to 100,000 ppm, such as from 1000 to 50,000 ppm, e.g., 1000 to 25,000 ppm, including 1000 to 10,000 ppm. In other embodiments, subterranean brines of the invention may include bromide, which may be present in the subterranean brine reactant or the carbon containing product in an amount of up to 5000 ppm or less, ranging in certain instances from 1 to 5000 ppm, such as from 5 to 5000 ppm, such as from 10 to 1000 ppm, e.g., 10 to 500 ppm, including 10 to 100 ppm. In other embodiments, subterranean brines of the invention may include silicon, which may be present in the subterranean brine reactant or the carbon containing product in an amount of up to 5000 ppm or less, ranging in certain instances from 1 to 5000 ppm, such as from 5 to 5000 ppm, such as from 10 to 1000 ppm, e.g., 10 to 500 ppm, including 10 to 100 ppm. In other embodiments, subterranean brines of the invention may include boron, which may be present in the subterranean brine reactant or the carbon containing product in an amount of up to 1000 ppm or less, ranging in certain instances from 1 to 1000 ppm, such as from 10 to 1000 ppm, such as from 20 to 500 ppm, e.g., 20 to 250 ppm, including 20 to 100 ppm. In other embodiments, subterranean brines of the invention may include neodymium, which may be present in the subterranean brine reactant or the carbon containing product in an amount of up to 1000 ppm or less, ranging in certain instances from 1 to 1000 ppm, such as from 10 to 1000 ppm, such as from 20 to 500 ppm, e.g., 20 to 250 ppm, including 20 to 100 ppm. The distinct amount of individual elements and the ratios of particular elemental pairs dissolved in a brine may be found in a carbon containing product of this invention in identifiable amounts that are indicative of a brine's origin. The carbon containing product of this invention may have an identifiable physical profile that correlates to a particular brine and includes amounts of individual elements or ratios of pairs of elements.

In some embodiments, subterranean brines may be obtained from a subterranean location beneath or nearby a metal ore mine or petroleum field and as such, may be rich in one or more trace metal elements (e.g., zinc, aluminum, lead, manganese, copper, cadmium, etc.) depending on the type of metal ore mine or petroleum field and its vicinity to the subterranean location where the subterranean brine is obtained. In some embodiments, the trace metal element in the subterranean brine is zinc, which may be present in the subterranean brine reactant or the carbon containing product in an amount of up to 250 ppm or less, ranging in certain instances from 1 to 250 ppm, such as 5 to 250 ppm, such as from 10 to 100 ppm, e.g., 10 to 75 ppm, including 10 to 50 ppm. In other embodiments, the identifying trace metal element in the subterranean brine is lead, which may be present in the subterranean brine in an amount of up to 100 ppm or less, ranging in certain instances from 1 to 100 ppm, such as 5 to 100 ppm, such as from 10 to 100 ppm, e.g., 10 to 75 ppm, including 10 to 50 ppm. In yet other embodiments, the identifying trace metal element in the subterranean brine is manganese, which may be present in the subterranean brine in an amount of up to 200 ppm or less, ranging in certain instances from 1 to 200 ppm, such as 5 to 200 ppm, such as from 10 to 200 ppm, e.g., 10 to 150 ppm, including 10 to 100 ppm. The trace metal may be found in the precipitated carbon product of this invention in amounts that are indicative of the source of brine reacted with the anthropogenic carbon dioxide.

In some embodiments, the subterranean brine may have an isotopic composition [811] which is determined during brine formation and the location from which it is obtained. In some embodiments, the carbon containing product of this invention may have an isotopic composition that is indicative of the subterranean brine reactant. Many elements have stable isotopes, and these isotopes may be preferentially used in various processes, e.g., biological processes and as a result, different isotopes may be present in each subterranean brine in distinctive amounts. An example is carbon, which will be used to illustrate one example of a subterranean brine described herein. However, it will be appreciated that these methods are also applicable to other elements with stable isotopes if their ratios can be measured in a similar fashion to carbon; such elements may include nitrogen, sulfur, and boron.

Reactions between water and minerals, dissolved species, associated gases, and other liquids with which they come into contact can modify the isotopic composition of water and minerals in a brine. It is understood that the isotopic profile of carbon and oxygen in a reaction product of brine and carbon dioxide may be affected by the isotopic profile of both the brine and carbon dioxide reaction components. In some embodiments, the δ¹³C value of carbon present in subterranean brines of interest may vary, ranging between −1‰ to −50‰. In some embodiments, the δ¹³C value for the subterranean brine may be different than that of anthropogenic carbon dioxide reactant. The δ¹³C value may be between −1‰ and −50‰, between −5‰ and −40‰, between −5‰ and −35‰, between −7‰ and −40‰, between −7‰ and −35‰, between −9‰ and −40‰, or between −9‰ and −35. The carbon in the carbon reaction product of this invention may have a δ¹³C that is proportional to the combination of the δ¹³C value of the brine reactant and the δ¹³C value of the anthropogenic carbon dioxide reactant. In one embodiment of this invention, the composition of a brine may be determined by determining the isotopic distribution of one or more elements of a precipitate derived from that brine and carbon dioxide.

The degree of water-rock exchange and the degree of mixing along fluid flow paths between water and minerals can modify the isotopic composition of the subterranean brine for elements other than carbon and oxygen. In some instances the ratio of strontium-87 to strontium-86 (⁸⁷Sr/⁸⁶Sr) may be indicative of a brine of particular origin. For example, rocks having high initial concentrations of rubidium, such as granites, may be characterized by high strontium-87 to strontium-86 ratios. In some embodiments, the strontium-87 to strontium-86 ratio of subterranean brine reactants and carbon containing products of this invention may vary, ranging between 0.71/1 and 0.85/1, such as between 0.71/1 and 0.825/1, such as between 0.71/1 and 0.80/1, such as between 0.75/1 and 0.85/1, and including between 0.75/1 and 0.80/1. Any suitable method may be used for measuring the strontium-87 to strontium-86 ratio, methods including, but not limited to 90°-sector thermal ionization mass spectrometry. In some embodiments, subterranean brines of the invention may have a composition which includes one or more identifying components which distinguish each subterranean brine from other subterranean brines. As such, the composition of each subterranean brine may be distinct from one another. In some embodiments, subterranean brines may be distinguished from one another by the amount and type of elements, ions or other substances present in the subterranean brine (e.g., trace metal ions). In other embodiments, subterranean brines may be distinguished from one another by the molar ratio of carbonates present in the subterranean brine. In other embodiments, subterranean brines may be distinguished from one another by the amount and type of different isotopes present in the subterranean brine (e.g., δ¹³C, δ¹⁸O, etc). In another instance, the ratio of lithium-7 to lithium-6 (⁷Li/⁶Li,) may be indicative of a particular brine. Other isotopic ratios that may be measured in order to describe a identify brine profile in a reaction product include, but are not limited to ⁸⁰Se/⁷⁶Se, ²⁶Mg/²⁴Mg, ⁴⁴Ca/⁴³Ca, ⁴⁴Ca/⁴²Ca, ⁴⁸Ca/⁴²Ca, ⁶⁵Cu/⁶³Cu, ¹⁴⁷Sm/¹⁴³Nd, ²⁰⁷Pb/²⁰⁸Pb, ²²⁶Ra/²²⁸Ra, ¹³⁸Ba/¹³⁷Ba, or other isotopic ratios. Any suitable method may be used for measuring the isotope ratios of a brine and a carbon containing product, methods including, but not limited to 90°-sector thermal ionization mass spectrometry. In some embodiments, the carbonate containing product has a composition that is indicative of a mixture of more than one subterranean brines.

In some instances, the product of this invention may contain an identifying element that is indicative of the carbonate-containing precipitation material being derived from a first subterranean brine and may contain a different element which is indicative of the carbonate-containing precipitation material being derived from a second subterranean brine. In other instances, the composition may contain an identifying element indicative of being derived from a first subterranean brine and an isotopic identifier that is indicative of being derived from a second subterranean brine. In yet other instances, the composition may contain an isotopic identifier indicative of being derived from a first subterranean brine and a different isotopic identifier that is indicative of being derived from a second subterranean brine.

In some embodiments, the subterranean brine profile of a reaction product may be the molar ratio of different carbonates present in a brine that are also present in a product produced by methods of the invention, e.g., carbonates produced by methods of the invention include but are not limited to carbonates of beryllium, magnesium, calcium, strontium, barium, radium or any combinations thereof. Since the molar ratio of calcium to magnesium in subterranean brines is much higher than is found in seawater, in some embodiments, the invention provides compositions which include carbonate-containing precipitation material that has a calcium to magnesium (Ca:Mg) molar ratio that is indicative of a subterranean brine origin. In some instances, the ratio may range between 1000:1 to 15:1, such as 750:1 to 15:1, such as 500:1 to 15:1, such as 200:1 to 15:1, such as 100:1 to 50:1, and including 100:1 to 75:1. In some embodiments, the carbonate-containing precipitation material is substantially all calcium, such as where the molar ratio of calcium to magnesium (Ca:Mg) is 200:1 or greater, such as 500:1 or greater, such as 1000:1 or greater, such as 5000:1 or greater, including 10,000:1 or greater.

In some embodiments the brine may contain living organisms [812] or the residues of living organisms that may be detectable in the reaction product of brine and carbon dioxide. The presence of living organisms in a brine (e.g., Oscillatoria, Gleocapsa, Chlorella, diatoms, Penicillium and bacteria etc. . . . ) may affect the polymorphic composition of the precipitated reaction products of brine and carbon dioxide.

Depending on the alkaline brine from which a bicarbonate composition is produced, the types of anions present in the bicarbonate composition may vary. In some embodiments, the physical profile of a carbonate composition may include halides, such as Cl⁻, F⁻, I⁻, and Br⁻. Alternatively or in addition, anions present in a bicarbonate composition may include oxyanions, e.g., sulfate, borate, nitrate, among others. The amount of anions present in bicarbonate compositions of the invention may vary, the amount ranging, from 50 to 100,000 ppm, such as 100 to 90,000 ppm, such as 250 to 75,000 ppm, such as 500 to 50,000 ppm, such as 750 to 40,000 ppm, such as 1000 to 30,000 ppm, including 1000 to 25,000 ppm, for example 1500 to 10,000 ppm.

In some embodiments the brine may contain one or more organic compounds [813] (e.g., acetate, propionate, butyrate, phenolic compounds, n-alkanes, alkylcyclohexanes, isoprenoids, bicyclic alkanes, steranes, hopanes, diasieranes etc.). Organic compounds may be detectable in a carbonate product formed from a reaction with brine and carbon dioxide or an aqueous mixture of carbonate and/or bicarbonate as a spectator compound. In some embodiments, the reaction product of a brine and carbon dioxide may be a carbonate product that contains organic compounds found in a brine. Depending on the brine from which the carbonate or bicarbonate composition is produced, organic compounds present in the composition may vary and may include but are not limited to formate, acetate, propionate, butyrate, valerate, oxalate, malonate, succinate, glutarate, phenol, methylphenol, ethylphenol, and dimethylphenol. The amount of organic compounds present in a carbonate or bicarbonate composition may range, for example, from 1 to 200 mmol/liter, such as 1 to 175 mmol/liter, such as 1 to 100 mmol/liter, such as 10 to 100 mmol/liter, including 10 to 75 mmol/liter. Organic compounds may influence the polymorphic composition 260 of a precipitated carbonate product in a reaction with carbon dioxide and brine.

Brines may be found at a wide range of acidity or alkalinity [814]. The nature of the proton remover or donor of a brine may be detectable in the brine and in the reaction product formed [840] upon reaction of a subterranean brine with carbon dioxide or an aqueous mixture of carbonates and/or bicarbonates. In some embodiments, the composition of the proton remover may affect the composition of the carbonate product [850].

The nature of the brine component may affect the morphology of the reaction product [860] by templating a particular crystalline polymorph for a reaction product. Additives or components may be present in a brine and influence the nature of the precipitate that is produced [840-860]. For example, vaterite, a highly unstable polymorph of CaCO₃ which precipitates in a variety of different morphologies and converts rapidly to calcite, may be obtained at very high yields by the presence trace amounts of lanthanum as lanthanum chloride in a brine. Other brine components beside lanthanum that are of interest include, but are not limited to transition metals and the like. For instance, the addition of ferrous or ferric iron is known to favor the formation of disordered dolomite (protodolomite) where it would not form otherwise. The nature of the precipitate can also be influenced by selection of appropriate major ion ratios. Major ion ratios also have considerable influence of polymorph formation. For example, as the magnesium:calcium ratio in the water increases, aragonite becomes the favored polymorph of calcium carbonate over low-magnesium calcite. At low magnesium:calcium ratios, low-magnesium calcite is the preferred polymorph. As such, a wide range of magnesium:calcium ratios may be found in brine including, e.g., 100/1, 50/1, 20/1, 10/1, 5/1, 2/1, 1/1, 1/2, 1/5, 1/10, 1/20, 1/50, 1/100. In some embodiments the magnesium:calcium ratios may be between 1/1 and 1/1000. When silica is present in a brine, silica may be incorporated with the carbonate precipitate or may affect the polymorph formed by the carbonate precipitate. In one embodiment of this invention, the composition of a brine may be determined by determining the polymorph distribution of a precipitate derived from that brine and carbon dioxide or an aqueous solution comprising carbonic acid, carbonates and/or bicarbonates. The higher the pH is, the more rapid the precipitation is and the more amorphous the precipitate may be. It will be appreciated that precipitation conditions may be altered for a single brine profile to provide for a different precipitate. It will be appreciated that any quantifiable feature of a brine may be used to define an identifiable physical brine profile [820]. Furthermore, different precipitate compositions may occur in a continuous flow system compared to a batch system.

Sequestration of Carbon Containing Product

Aspects of the invention also include methods for sequestering the reaction products of an aqueous mixture with carbon dioxide or an aqueous solution of carbonic acid, carbonate, and or bicarbonate or any combination thereof such that the carbon dioxide is absorbed by the aqueous mixture. In some embodiments the reaction product may be an aqueous mixture may wherein the concentration of carbon dioxide is higher than the concentration of carbon dioxide before contacting with carbon dioxide. The reaction product may be a carbonate composition that comprises any combination of carbonic acid, carbonate, and or bicarbonate in any proportion. The carbonate composition may be a solid, liquid, slurry or any combination thereof. In some embodiments methods of this invention may sequester carbon at a greater density than the density of supercritical carbon dioxide. In some embodiments the carbon containing product of this invention may sequester carbon dioxide in composition that is denser than supercritical CO₂ (e.g., 0.47 g/ml at 304.2 K (31.2° C.) and 72.8 atm). In some embodiments, the reaction product of this invention may be stored at 1 atmosphere. In some embodiments, the reaction product of this invention may be an aqueous solution containing bicarbonate, carbonate, carbonic acid or any combination thereof. In some embodiments, some or the entire reaction product may be sequestered, such as for example by introducing and maintaining the composition in a sequestration location. By “maintaining” the reaction product in a sequestration location is meant the composition is maintained in the sequestration location after introduction without significant, if any, degradation for extended durations, e.g., 1 year or longer, 5 years or longer, 10 years or longer, 25 years or longer, 50 years or longer, 100 years or longer, 250 years or longer, 1000 years or longer, 10,000 years or longer, 1,000,000 years or longer, or 100,000,000 years or longer, or 1,000,000,000 years or longer. In some embodiments, 1% or greater of the reaction product may be sequestered, such as 5% or greater of the reaction product, such as 10% or greater of the reaction product, such as 25% or greater of the reaction product, such as 50% or greater of the reaction product, such as 75% or greater of the reaction product, such as 90% or greater of reaction product, such as 95% or greater of the reaction product, and including 99% or greater of the reaction product. In some embodiments, the reaction product may be a bicarbonate solution.

Any convenient sequestration location may be employed. In certain embodiments, the bicarbonate composition may be sent to a tailings pond or may be stored in a man-made above or underground storage facility. In certain embodiments, the bicarbonate composition produced by methods of the invention may be stored in a temporary storage location prior to disposal in a long term sequestration location. For example, the bicarbonate composition may be temporarily stored for a period of time ranging from 1 to 1000 days or longer, such as 1 to 10 days or longer, including 1 to 100 days or longer. In other embodiments, the bicarbonate composition may be conveyed to the sequestration location directly from the bicarbonate composition production reactor (i.e., CO₂-contacting reactor). Any convenient protocol for transporting the bicarbonate composition to the sequestration location may be employed, and will vary depending on the relative locations of the bicarbonate composition production reactor and the sequestration location. In certain embodiments, a pipeline or analogous conveyance structure is employed, where approaches may include active pumping, gravitational mediated flow, etc., as desired.

In some embodiments, the sequestration location is a subterranean formation. “Subterranean formation” includes a geological formation found in a location which is below ground level, i.e., a region located beneath the Earth's surface. As such, subterranean formations of the invention may be a deep geological aquifer or an underground well located in the sedimentary basins of a petroleum field, a subterranean metal ore, a geothermal field, or an oceanic ridge, among other underground locations. In some embodiments, the subterranean formation may be spent oil wells, salt domes, abandoned mines (e.g., coal mines), lava tubes or other hollow underground geological chambers. In some embodiments, the subterranean formation may be the location from which a subterranean brine was obtained. Where the sequestration location is a subterranean formation, the subterranean formation may be located 100 m or deeper below ground level, such as 200 m or deeper below ground level, such as 300 m or deeper below ground level, such as 400 m or deeper below ground level, such as 500 m or deeper below ground level, such as 600 m or deeper below ground level, such as 700 m or deeper below ground level, such as 800 m or deeper below ground level, such as 900 m or deeper below ground level, such as 1000 m or deeper below ground level, such as 1500 m or deeper ground level, such as 2000 m or deeper below ground level, such as 2500 m or deeper below ground level, and including 3000 m or deeper below ground level.

Where desired, the reaction product may be processed prior to or during conveyance into the sequestration location. For example, the volume of the reaction product (e.g., a carbonate/carbonic acid/bicarbonate composition) may be reduced before conveyance into the sequestration location, such as by evaporation or concentrating reaction product. In other instances, the pressure, temperature or composition of the bicarbonate composition may be adjusted. In yet other instances, it may be determined that no adjustment to the bicarbonate composition is desired and the bicarbonate composition may be conveyed into the sequestration location without further adjustment.

In some embodiments, processing the bicarbonate composition includes adjusting (e.g., increasing or decreasing) the bicarbonate concentration in the bicarbonate composition. In some embodiments, the bicarbonate concentration in the bicarbonate composition is increased. For example, the bicarbonate concentration in the bicarbonate composition may be increased by 0.1 M or more, such as by 0.5 M or more, such as by 1 M or more, such as by 2 M or more, such as by 5 M or more, including by 10 M or more. In some embodiments, bicarbonate is concentrated to a concentration of 0.5 M or greater, such as 1.0 M or greater, such as 1.5 M or greater, such as 2.0 M or greater, such as 2.5 M or greater, such as 5.0 M or greater, such as 7.5 M or greater, including 10 M or greater. Concentrating bicarbonate in the bicarbonate composition may be accomplished using any convenient protocol, e.g., distillation, evaporation, among other protocols. In other embodiments, methods of the invention may include decreasing the bicarbonate concentration in the bicarbonate composition. As such, the concentration of bicarbonate in the bicarbonate composition may be decreased, e.g., by 0.1M or more, such as by 0.5 M or more, such as by 1 M or more, such as by 2 M or more, such as by 5 M or more, including by 10 M or more. In certain embodiments, methods of the invention include decreasing the concentration of bicarbonate in the bicarbonate composition to a concentration that is 5 M or less, such as 2 M or less, such as 1 M or less, including 0.5 M or less. Decreasing the concentration of bicarbonate in the bicarbonate composition may be accomplished using any convenient protocol, e.g., diluting the bicarbonate composition with diluents (e.g., water), among other protocols.

In some embodiments, processing the bicarbonate composition includes adjusting the temperature of the bicarbonate composition. For example, prior to introducing the bicarbonate composition into the sequestration location, the temperature of the bicarbonate composition may be adjusted (i.e., increased or decreased) as desired, e.g., by 5° C. or more, such as 10° C. or more, such as 15° C. or more, such as 25° C. or more, such as 50° C. or more, such as 75° C. or more, including 100° C. or more. Where the sequestration location is a subterranean formation, in some embodiments, the temperature of the bicarbonate composition may be adjusted to a temperature which is equivalent to the internal temperature of the subterranean formation. In these instances, prior to adjusting the temperature of the bicarbonate composition, methods of the invention further include determining the temperature of the subterranean formation, as described in detail below. The temperature of the bicarbonate composition may be adjusted using any convenient protocol, such as for example a thermal heat exchanger, electric heating coils, Peltier thermoelectric devices, gas-powered boilers, among other protocols. In certain embodiments, the temperature may be raised using energy generated from low or zero carbon dioxide emission sources, e.g., solar energy source, wind energy source, hydroelectric energy source, etc. In one embodiment of this invention, the composition of a reaction product may be adjusted using geothermal energy derived from subterranean brines used to react with carbon dioxide.

Processing the bicarbonate composition may also include pressurizing the bicarbonate composition. The term “pressurizing” is used in its conventional sense to refer to increasing the ambient pressure on the bicarbonate composition. Accordingly, the ambient pressure may be increased by 0.1 atm or more, such as 0.05 atm or more, such as 1 atm or more, such as 5 atm or more, such as 10 atm or more, such as 25 atm or more, such as 50 atm or more, and including 100 atm or more. In some instances, the bicarbonate composition is pressurized to a pressure that is greater than atmospheric pressure, e.g., 1.5 atm or greater, such as 2 atm or greater, such as 5 atm or greater, such as 10 atm or greater, such as 25 atm or greater, such as 50 atm or greater, including 100 atm or greater. Where the sequestration location is a subterranean formation, the bicarbonate composition may be pressurized to a pressure that is equivalent to the internal pressure within the subterranean formation. In these instances, prior to pressurizing the bicarbonate composition, methods of the invention further include determining the internal pressure of the subterranean formation, as described in detail below. The bicarbonate composition may be pressurized using any convenient fluid compression protocol. In some embodiments, pressurizing the bicarbonate composition may employ positive displacement pumps (e.g., piston or gear pumps), static or dynamic fluid compression protocols, radial flow centrifugal-type compressors, helical blade-type compressors, rotary compressors, reciprocating compressors, liquid-ring compressors, among other types of fluid compression protocols.

Assessing a Storage Location

Where the reaction product is sequestered by introducing and maintaining the aqueous solution (e.g., comprising carbonic acid, bicarbonate, carbonate or mixture thereof) in a subterranean formation, aspects of the invention may also include methods for assessing the subterranean formation. By “assessing” the subterranean formation is meant that a human (or a computer, if using a computer monitored process), evaluates a subterranean formation and determines whether the subterranean formation is suitable or unsuitable for storing a aqueous solution comprising carbonic acid, bicarbonate, carbonate or mixture thereof. Assessing the subterranean formation may include, but is not limited to determining the internal pressure, internal volume, size, internal temperature, porosity, and composition of the subterranean formation.

In some embodiments, assessing the subterranean formation includes determining the internal pressure within the subterranean formation. The internal pressures of suitable subterranean formations of the invention may vary depending on the makeup of the bicarbonate composition as well as the depth and geographic location of the subterranean formation, e.g., ranging from 4-200 atm, such as 5 to 150 atm, such as 5 to 100 atm, such as 5 to 50 atm, such as 5 to 25 atm, such as 5 to 15 atm, and including 5 to 10 atm. The internal pressure of the subterranean formation can be determined using any convenient protocol, such as for example by permanent down-hole pressure gauges, piezoresistive strain gage pressure sensors, capacitive pressure sensors, electromagnetic pressure sensors, potentiometric pressure sensors, among other protocols.

In some embodiments, assessing the subterranean formation includes determining the internal temperature within the subterranean formation. The internal temperatures of suitable subterranean formations of the invention may vary depending on the makeup of the reaction product to be stored as well as the depth and geographic location of the subterranean formation, ranging from −5 to 250° C., such as 0 to 200° C., such as 5 to 150° C., such as 10 to 100° C., such as 20 to 75° C., including 25 to 50° C. The internal temperature of the subterranean formation may be determined using any convenient protocol, such as for example by permanent down-hole temperature gauges, gas thermometers, thermocouples, thermistors, resistance temperature detectors, pyrometers, infrared radiation sensors, among other protocols.

In some embodiments, assessing the subterranean formation includes determining the size and internal volume of the subterranean formation. The size and internal volume of suitable subterranean formations of the invention may vary greatly depending on the desired amount of bicarbonate composition to be introduced. By “size” of the subterranean formation is meant the total amount of space occupied by the subterranean formation as measured by the dimensions of the external surfaces which are in contact with the outside environment. In some embodiments, the size of the subterranean formation may be 10³ liters or greater, such as 10⁴ liters or greater, such as 10⁵ liters or greater, such as 10⁶ liters or greater, such as 10⁷ liters or greater, such as 10⁸ liters or greater and including 10⁹ liters or greater. By “internal volume” is meant the total amount of space found within the subterranean formation which is not in direct contact with the outside environment (e.g., ocean). In some embodiments, the internal volume of the subterranean formation may be 10³ liters or greater, such as 10⁴ liters or greater, such as 10⁵ liters or greater, such as 10⁶ liters or greater, such as 10⁷ liters or greater, such as 10⁸ liters or greater and including 10⁹ liters or greater. Depending upon the thickness of external walls and number of segregating walls within the subterranean formation, in certain embodiments, the size and internal volume may differ, e.g., by 5% or more, such as 10% or more, such as 25% or more, such as 30% or more, such as 40% or more, such as 50% or more, including 75% or more. The size and internal volume of the subterranean formation can be determined using any convenient protocol, such as for example by geophysical diffraction tomography, X-ray tomography, hydroacoustic survey, among other protocols.

In some embodiments, assessing the subterranean formation includes determining the porosity of the subterranean formation. “Porosity” as referred to herein includes the ratio of the total volume of its void or pore spaces (i.e., pore volume) to its gross bulk internal volume. In other words, the porosity of the subterranean formation is a measure of the capacity within the subterranean formation which is available for storing a fluid composition. Depending on the type of subterranean formation, the porosity of suitable subterranean formations of the invention may vary. In some embodiments, the porosity of subterranean formations ranges between 0.01 to 1.0, such as 0.01 to 0.95, such as 0.05 to 0.9, such as 0.1 to 0.75, such as 0.2 to 0.7 and including 0.25 to 0.55. The size of the pores within the subterranean formation may also vary. In some embodiments, subterranean formations of the invention may have pores size which are 50 nm or greater in diameter, such as 60 nm or greater in diameter, such as 75 nm or greater in diameter, such as 100 nm or greater in diameter, such as 250 nm or greater in diameter, including 500 nm or greater in diameter. In other embodiments, subterranean formations of the invention may have pore sizes which are less than 50 nm in diameter, such as less than 40 nm in diameter, such as less than 25 nm in diameter, such as less than 10 nm in diameter, such as less than 5 nm in diameter, and including less than 2 nm in diameter. The porosity of the subterranean formation can be determined using any convenient protocol, such as for example by magnetic resonance imaging, computed tomography scanning, geophysical diffraction tomography, hydroacoustic survey, gas expansion analysis, among other protocols. Depending on the porosity of the subterranean formation, the amount of available volume within the subterranean formation occupied by the introduced bicarbonate composition may be 5% or more, such as 10% or more, such as 25% or more, such as 50% or more, such as 75% or more, such as 95% or more, and including 99% or more of the available volume within the subterranean formation.

In some embodiments, assessing the subterranean formation may also include determining the composition of the subterranean formation. Determining the composition of the subterranean formation refers to the analysis of the components which make up the subterranean formation. Determining the composition of the subterranean formation may include, but is not limited to determining the mineralogy, metal composition, salt composition, ionic composition, organometallic composition, and organic composition of the subterranean formation. Any convenient protocol can be employed to determine the composition of the subterranean formation. In some embodiments, prior to conveying the bicarbonate composition into the subterranean formation, a sample of the subterranean formation may be obtained by for example, pump excavation or side wall drilling to determine the composition. Methods for analyzing the composition of the subterranean formation may include, but are not limited to the use of inductively coupled plasma emission spectrometry, inductively coupled plasma mass spectrometry, ion chromatography, X-ray diffraction, gas chromatography, gas chromatography-mass spectrometry, flow-injection analysis, scintillation counting, acidimetric titration, and flame emission spectrometry, among other protocols.

Where the aqueous solution comprising carbonic acid, bicarbonate, carbonate or mixture thereof is sequestered by introducing the solution into a subterranean formation, one or more pipelines or analogous conduits may be employed to convey the solution to the subterranean formation. As such, methods of the invention may also include producing one or more bore holes (i.e., well bore) in the subterranean formation. One or more bore holes can be produced in the subterranean formation by employing any convenient protocol. For instance, bore holes may be produced using conventional excavation drilling techniques, e.g., particle jet drilling, rotary mechanical drilling, rotary blasthole drilling, hole openers, rock reamers, flycutters, turbine-motor drilling, thermal spallation drilling, high power pulse laser drilling or any combination thereof. The bore holes may be drilled to any depth as desired, depending upon the thickness of the walls and porosity of the subterranean formation. In some embodiments, the bore holes may extend to a depth of 1 meter or deeper into the subterranean formation, such as 5 meters or deeper into the subterranean formation, such as 10 meters or deeper into the subterranean formation, such as 20 meters or deeper into the subterranean formation, such as 30 meters or deeper into the subterranean formation, such as 40 meters or deeper into the subterranean formation, such as 50 meters or deeper into the subterranean formation, such as 75 meters or deeper into the subterranean formation, and including 100 meters or deeper into the subterranean formation. The diameter of the bore hole may also vary, depending upon the nature of the bicarbonate composition (e.g., viscosity) and the porosity of the subterranean formation. In some embodiments, the diameter of the bore hole ranges, e.g., from 5 to 100 cm, such as 10 to 90 cm, such as 10 to 90 cm, such as 20 to 80 cm, such as 25 to 75 cm, and including 30 to 50 cm.

After producing one or more bore holes in the subterranean formation, methods of the invention may also include inserting one or more conduits into the bore hole. The term conduit is used in its general sense to refer to a tube, pipeline or analogous structure configured to convey a gas or liquid from one location to another. Conduits of the invention may vary in shape, where the cross-section of the conduit may be circular, rectangular, oblong, square, etc. The diameter of the conduit may also vary greatly, depending on the size of the bore hole as well as the nature of the bicarbonate composition (e.g., viscosity), ranging from 5 to 100 cm, such as 10 to 90 cm, such as 10 to 90 cm, such as 20 to 80 cm, such as 25 to 75 cm, and including 30 to 50 cm. Depending on the depth of the subterranean formation, the wall thicknesses of the conduit may vary considerably, ranging in certain instances from 0.5 to 25 cm or thicker, such as 1 to 15 cm or thicker, such as 1 to 10 cm or thicker, including 1 to 5 cm or thicker. In certain embodiments, conduits of the current invention may be designed in order to support high internal pressure from the flow of the bicarbonate composition. In other embodiments, the conduit may be designed to support high external loadings (e.g., external hydrostatic pressures, earth loads, etc.). Conduits of the invention may be inserted to any depth into the subterranean formation, as desired, e.g., to a depth of 0.5 meter or deeper into the subterranean formation, such as 1 meters or deeper into the subterranean formation, such as 2 meters or deeper into the subterranean formation, such as 3 meters or deeper into the subterranean formation, such as 4 meters or deeper into the subterranean formation, such as 5 meters or deeper into the subterranean formation, and including 10 meters or deeper into the subterranean formation. In some embodiments, conduits of the invention are two-way delivery units. By “two-way” is meant that a single conduit may be employed to both introduce a fluid composition into the subterranean formation as well as withdraw a fluid composition from within the subterranean composition. For example, in some instances a conduit may be employed to introduce the bicarbonate composition into the subterranean formation. In other instances, the same conduit may be employed to withdraw the bicarbonate composition from within the subterranean formation at a later time. In some embodiments, bicarbonate composition may be withdrawn from within the subterranean formation and employed to produce a carbonate-containing compound, as described in detail below. In other words, conduits of the invention may be configured to both convey a fluid composition into the subterranean formation as well as withdraw a fluid composition from within the subterranean formation.

In some embodiments, prior to conveying the solution into the subterranean formation, methods of the invention may also include removing an amount of the liquid contents disposed within a subterranean formation. In other words, before the solution is conveyed into the subterranean formation, a step for evacuating the subterranean formation may be desirable. By removing an amount of the liquid contents from within the subterranean formation, more of the composition may be conveyed into the subterranean formation. For example, liquid compositions which may be found within subterranean formations include crude petroleum, deep sea hypersaline waters, subterranean brines, connate waters, underground formation waters, etc. In some embodiments, the liquid composition found within the subterranean formation may occupy 5% or more of the available volume within the subterranean formation, such as 10% or more, such as 25% or more, such as 50% or more, such as 75% or more, including 90% or more of the available volume within the subterranean formation. As such, methods of the invention may include removing an amount of the liquid contents such that the available volume occupied by the liquid contents within the subterranean formation is decreased by 5% or more, such as 10% or more, such as 20% or more, such as 30% or more, such as 40% or more, such as 50% or more, such as 75% or more, such as 90% or more, and including 95% or more. In other embodiments, the bicarbonate composition may be conveyed into the subterranean formation directly, without removing any of the liquid contents from within of the subterranean formation. Liquid contents disposed within the subterranean formation may be removed by any convenient protocol, such as for example by employing an oil-field pump, down-well turbine motor pump, rotary lobe pump, hydraulic pump, fluid transfer pump, geothermal well pump, a water-submergible vacuum pump, or surface-located brine pump, among other protocols. Liquid contents disposed within the subterranean formation may be used in any methods of this invention, for example as a source of alkalinity or divalent cations in a reaction with carbon dioxide or a an aqueous solution aqueous solution comprising carbonic acid, bicarbonate, carbonate or mixture thereof.

Aspects of the invention also include conveying the reaction products of this invention into the subterranean formation. The reaction products may be conveyed into the subterranean formation by any convenient protocol, such as for example by active pumping, gravitational mediated flow, etc., as desired. For example, the composition may be pumped into the subterranean formation using, e.g., a down-well turbine-driven motor pump, a geothermal down-well pump, hydraulic pump, fluid transfer pump, or a surface-located rotary pump, among other protocols. The rate of conveying the composition into the subterranean formation may vary depending on the depth and porosity of the subterranean formation, the size and number of conduits, as well as the size of the bore hole in the subterranean formation. In some embodiments the rate of conveyance of the bicarbonate composition into the subterranean formation may be 0.1 liters per minute or greater, such as 0.5 liters per minute or greater, such as 1 liter per minute or greater, such as 5 liters per minute or greater, such as 10 liters per minute or greater, such as 25 liters per minute or greater, such as 50 liters per minute or greater, such as 100 liters per minute or greater, including 500 liters per minute or greater.

In some embodiments, methods of the invention also include monitoring the composition in the subterranean formation after conveying the reaction products into the subterranean formation. Monitoring the bicarbonate composition in the subterranean formation may include determining the pH, electrochemical properties, spectroscopic properties, polydispersities, metal composition, bicarbonate concentration, salt composition, ionic composition, organometallic composition, organic composition of the bicarbonate composition in the subterranean formation. The bicarbonate composition can be monitored in the subterranean formation by any convenient protocol. In some embodiments, samples of the bicarbonate composition from within the subterranean formation may be drawn up through the one or more conduits at regular intervals, such as every 1 minute, every 5 minutes, every 10 minutes, every 30 minutes, every 60 minutes, every 100 minutes, every 200 minutes, every 500 minutes, or some other interval and then analyzed. In other embodiments, monitoring the bicarbonate composition in the subterranean formation may include collecting real-time data (e.g., pH, temperature, bicarbonate concentration, etc.) about the bicarbonate composition by employing detectors within the subterranean formation to monitor the bicarbonate composition. For example, the bicarbonate composition may be monitored in the subterranean formation by conveying temperature gauges, pH sensors, pressure gauges, bicarbonate concentration detectors (e.g., flow-type glass electrodes), etc. Into the subterranean formation.

After conveying the reaction products into the subterranean formation is completed (e.g., the aqueous solution comprising carbonic acid, bicarbonate, carbonate or mixture thereof is depleted or the subterranean formation is filled), the bore hole in the subterranean formation may be filled (i.e., plugged) to permanently sequester the bicarbonate composition in the subterranean formation. In accordance with methods of the invention, an impermeable, pressure tight, solidified plug may be placed in the bore hole by pumping a sealing material through the one or more conduits. In some embodiments, excess sealing material is applied to the bore hole to insure that no leaks exist in the bore hole plug. Depending on the depth of the bore hole, the plug may vary in vertical size, such as e.g., 0.1 meters or greater, such as 0.5 meters or greater, such as 1 meter or greater, such as 2 meters or greater, such as 3 meters or greater, such as 5 meters or greater, such as 7 meters or greater, and including 10 meters or greater. In some embodiments, the plug material may employ a settable composition that solidifies forming a permanent and impermeable seal. In some embodiments, the plug is a settable composition, such as e.g., a dense synthetic resin, epoxy resin, fly ash, synthetic resins interspersed with glass beads, among other materials. In some embodiments, the settable composition is a cement, e.g., a CO₂-sequestering cement, high alkali-metal silicate cements, cements having acid resistant aggregate, quartz, microsilica, colloidal silica, among other acid resistant and anti-corrosive cements. In some embodiments, after introducing the bicarbonate composition into the subterranean formation and plugging the bore hole, as described above, the one or more conduits may be removed from the subterranean formation by retracting each conduit back above ground.

Systems for Contacting a Solution with Carbon Dioxide

Aspects of the invention further include systems, e.g., processing plants or factories for practicing methods as described above. Systems of the invention may have any configuration which enables practice of the particular production method of interest. In some embodiments, systems of the invention include a source of one or more solutions. In one embodiment, the aqueous mixture may be an alkaline solutions that may be any concentrated aqueous compositions which possess sufficient alkalinity or basicity to remove one or more protons from proton-containing species in solution. As described above, alkaline solutions may have a pH that is above neutral pH (i.e., pH>7), e.g., the solution has a pH ranging from 7.1 to 12, such as 8 to 12, such as 8 to 11, and including 9 to 11. For example, the pH of the alkaline solutions may be 9.5 or higher, such as 9.7 or higher, including 10 or higher. In some instances, the source of alkalinity of may be an alkaline brines that is comprised of carbonate (e.g., sodium carbonate). In some instances, the alkaline solution is a “high carbonate” alkaline brine. As described above, “high carbonate” alkaline brines are aqueous compositions which possess carbonate in a sufficient amount so as to remove one or more protons from proton-containing species in solution so that carbonic acid in solution is converted to bicarbonate. The source of alkaline solution of the invention may be any convenient source, such as for example augmented natural brines, man-made brines, waste waters from industrial processing plants, brines produced by renewable energy sources (e.g., solar capture field, natural gas compression reservoirs, geothermal energy), naturally occurring brines, mineral rich freshwater, hard water lakes, inland seas or alkaline lakes (such as Lake Van in Turkey).

In some embodiments, systems of the invention may also include structures such as a pipe or conduit for conveying the solution from a brine source to a reactor for contacting the brine with CO₂. In some instances, the conveyance structure may include pumps for pumping the alkaline brine into the contacting reactor, such as a turbine-motor pump, rotary lobe pump, hydraulic pump, fluid transfer pump, etc. Pumps may provide no more than two bars of pressure. In some embodiments, systems of the invention also include a source of carbon dioxide. As reviewed in detail above, the source of CO₂ may be any convenient CO₂ source, such as for example a gas, a liquid, a solid (e.g., dry ice), a supercritical fluid, or CO₂ dissolved in a liquid. In some instances, the CO₂ source may be a waste gas stream from an industrial plant. Systems of the invention may also include structures such as a pipe, duct, or conduit which direct the C_{O2} to the reactor for contacting the alkaline brine with CO₂.

In some embodiments, systems of the invention also include one or more reactors configured for contacting the source of the brine with the source of CO₂. As described in detail above, the contacting reactor may include devices for contacting the alkaline brine with CO₂, such as for example gas bubblers, contact infusers, fluidic Venturi reactors, spargers, components for mechanical agitation, stirrers, components for recirculation of the source of CO₂ through the contacting reactor, gas filters, sprays, trays, or packed column reactors, and the like, as may be convenient. As reviewed above, when CO₂ is dissolved into an aqueous solution, carbonic acid may be produced. In some embodiments, brines of the invention possess an alkalinity that is sufficient to produce a reaction product comprising aqueous mixture of carbonic acid, bicarbonate or carbonate when contacted with CO₂ and thus, some or all of the CO₂ contacted with the alkaline brine is converted to a reaction product. As such, systems of the invention may also include systems for sequestering the aqueous mixture (e.g., conveying a reaction product to a sequestration location) and a carbonate-compound production station for producing a solid carbonate-containing reaction product from the aqueous solution.

In some embodiments, systems of the invention may also include a control station, configured to regulate the amount of the reaction product sequestered and the amount of the reaction product conveyed to a solid carbonate-compound production station. For instance, the amount of carbon dioxide which is sequestered may be regulated by the control station to be 1% or greater of the produced bicarbonate composition, such as 5% or greater, such as 10% or greater, such as 25% or greater, such as 50% or greater, such as 75% or greater, such as 90% or greater, such as 95% or greater, and including 99% or greater of the produced bicarbonate composition. In these instances, the control station may convey the remainder of the composition to a solid carbonate-compound production station or alternatively, for some other function, as desired, e.g., acid-neutralization protocols. The control station may regulate the amount of the bicarbonate composition sequestered or conveyed to a carbonate-compound production station by any convenient protocol. In embodiments of the invention, the control station can adjust the output of the bicarbonate composition from the bicarbonate composition production reactor at any time. “Adjust the output” is used herein to mean that the intended destination (e.g., sequestration location, carbonate-compound production plant, etc.) and amount of reaction product conveyed from the production reactor can be changed or modified at any time. The control station may employ any convenient protocol to regulate the output of bicarbonate composition from the composition reactor. For example, the control station may employ a set of valves or a multi-valve system which is manually, mechanically or digitally controlled, or may employ any other convenient flow regulation protocol. In some instances, the control station may include a computer interface, (where the flow regulator is computer-assisted or controlled entirely by a computer) configured to provide a user with input and output parameters to control the output flow of the bicarbonate composition to the sequestration location or to the carbonate-compound production station.

In some embodiments, the reaction product (aqueous solution comprising carbonic acid, bicarbonate, carbonate or mixture thereof is sequestered. As such, systems of the invention may include a sequestration location. Sequestration locations of the invention may be any convenient reservoir for storing the composition. For example, the sequestration location may be a tailings pond or a man-made above or underground storage facility. In some embodiments, the sequestration location may be a subterranean formation, such as for example, a deep geological aquifer or an underground well located in the sedimentary basins of a petroleum field, a subterranean metal ore, a geothermal field, or an oceanic ridge, among other underground locations.

In some embodiments, systems of the invention may also include systems for conveying the aqueous reaction product to the sequestration location. Systems for producing the carbonate composition may be located within 1.5 kilometers (km) or less from systems for conveying the reaction product to a sequestration location. In some embodiments, systems for producing a composition may be located within 4500 km or less from systems for conveying the composition to a sequestration location, such as 3000 km or less, such as 1000 km or less, such as 500 km or less, such as 250 km or less, such as 200 km or less, such 100 km or less, such as 50 km or less, such as 10 km or less from systems for conveying the bicarbonate composition to a sequestration location. In certain instances, systems for producing an aqueous solution reaction product (e.g., comprising carbonic acid, bicarbonate, carbonate or mixture thereof) may be co-located with systems for conveying the solution to a sequestration location. Where desired, systems for producing the reaction product and systems for conveying the composition to a sequestration location may be configured relative to each other to minimize ducting costs, e.g., where systems for producing the reaction product are located within 40 meters of the systems for conveying the composition to a sequestration location. Systems for producing the reaction product and systems for conveying the reaction product to a sequestration location may be configured to allow for synchronizing their activities. In certain instances, the activity of one system may not be matched to the activity of the other. For example, systems for conveying reaction product to the sequestration location may need to reduce or stop its acceptance of the composition but the system for producing the reaction product may need to keep operating. Conversely, situations may arise where the system for producing the reaction product reduces or ceases operation and systems for conveying the reaction product to the sequestration location do not. To address situations where either the system for producing the product composition or systems for conveying the product composition to the sequestration location may need to reduce or stop its activities, design features that provide for continued operation of one of the systems while the other reduces or ceases operation may be employed. For example, systems of the invention may include in certain embodiments, a bicarbonate composition storage facility present between systems for producing the bicarbonate composition and the systems for conveying the bicarbonate composition to a sequestration location. In another example, where systems for conveying the bicarbonate composition to the sequestration location need to reduce of stop its activities, the control station may increase the amount of the bicarbonate composition conveyed to the carbonate-compound production station.

In some embodiments, systems of the invention may include one or more subterranean formations. Subterranean formations of the invention may be any suitable geological formation such that it possesses a hollow internal space for the introduction and storage of a fluid composition without leakage or degradation and may be found in a location which is located below ground level. In some embodiments, the subterranean formation may be empty oil wells, salt domes, abandoned mines (e.g., coal mines), lava tubes or other hollow underground geological chambers. In some embodiments the subterranean location may be between 100 and 1000 meters below ground level. In some embodiments, the subterranean formation is located 100 m or deeper below ground level, such as 200 m or deeper below ground level, such as 300 m or deeper below ground level, such as 400 m or deeper below ground level, such as 500 m or deeper below ground level, such as 600 m or deeper below ground level, such as 700 m or deeper below ground level, such as 800 m or deeper below ground level, such as 900 m or deeper below ground level, such as 1000 m or deeper below ground level, such as 1500 m or deeper ground level, such as 2000 m or deeper below ground level, such as 2500 m or deeper below ground level, and including 3000 m or deeper below ground level. Depending on the depth and geographic location of the subterranean formation, the chemical composition and mineralogy of the subterranean formation may vary. In some embodiments the porosity of rock above a subterranean location may be greater than 1%. In some embodiments of this invention all of the rock above the subterranean location has a porosity greater than 1%. In some embodiments the subterranean location may be the same or a separate location from location of the subterranean brine used in the contacting reaction. In some embodiments that include two or more subterranean location, the system may include a first conduit configured to transport brine from a subterranean location and a conduit configured to transport an aqueous reaction product from the processor to the second subterranean location.

Systems of the invention may also include one or more detectors configured for monitoring the subterranean formation. Monitoring the subterranean formation may include, but is not limited to collecting data about the internal pressure, internal volume, size, internal temperature, and composition of the subterranean formation. The detectors may be any convenient device configured to monitor the subterranean formation, such as for example pressure sensors (e.g., permanent downhole pressure gauges, piezoresistive strain gage pressure sensors, capacitive pressure sensors, electromagnetic pressure sensors, potentiometric pressure sensors, etc.), temperature sensors (resistance temperature detectors, thermocouples, permanent downhole temperature gauges, gas thermometers, thermistors, pyrometers, infrared radiation sensors, etc.) size and volume sensors (e.g., geophysical diffraction tomography, X-ray tomography, hydroacoustic surveyers, etc.), and devices for determining chemical makeup of the subterranean formation (e.g., IR spectrometer, NMR spectrometer, UV-vis spectrophotometer, high performance liquid chromatographs, inductively coupled plasma emission spectrometers, inductively coupled plasma mass spectrometers, ion chromatographs, X-ray diffractometers, gas chromatographs, gas chromatography-mass spectrometers, flow-injection analysis, scintillation counters, acidimetric titration, and flame emission spectrometers, etc.).

Systems of this invention may include a heat exchanger to collect and utilize excess thermal energy from a subterranean brine. The heat exchanger may be an open loop or closed loop configuration to collect heat from a brine. Thermal energy may be converted to electrical energy using a steam generator or any device known in the art for generating electrical energy from an aqueous geothermal source. Thermal energy from a brine source may be routed via a conduit to contact product of this invention in order to dry a product of this invention.

In some embodiments, detectors for monitoring the subterranean formation may also include a computer interface which is configured to provide a user with the collected data about the subterranean formation. For example, a detector may determine the internal pressure of a subterranean formation and the computer interface may provide a summary of the changes in the internal pressure within the subterranean formation over time. In some embodiments, the summary may be stored as a computer readable data file or may be printed out as a user readable document.

In some embodiments, the detector may be a monitoring device such that can collect real-time data (e.g., internal pressure, temperature, etc.) about the subterranean formation. In other embodiments, the detector may be one or more detectors configured to determine the parameters of the subterranean formation at regular intervals, e.g., determining the composition every 1 minute, every 5 minutes, every 10 minutes, every 30 minutes, every 60 minutes, every 100 minutes, every 200 minutes, every 500 minutes, or some other interval.

Systems of the invention may also include one or more pumping stations for conveying the compositions of this invention to a sequestration location. The pumping stations may employ one or more pumps for pumping a carbonate composition to the sequestration location, such as for example turbine-motor pumps, rotary lobe pumps, hydraulic pumps, fluid transfer pumps, etc. In some embodiments, the contacting reactor for producing the carbonate composition and the pumping station may be integrated into a single station. In these embodiments, the contacting reactor may produce a bicarbonate composition by contacting an alkaline brine with CO₂ and directly convey the bicarbonate composition to the sequestration location.

Where the sequestration location is a subterranean formation, systems of the invention may also include one or more conduits inserted into the subterranean formation to convey the compositions of this invention into the subterranean formation. Conduits of the invention may be any tube, pipeline or other analogous conduit structure configured to convey a gas, liquid or slurry from one location to another. As described above, conduits of the invention may vary. In some embodiments the cross-sectional shape of the conduit may be circular, rectangular, oblong, square, etc. Depending on the nature of the composition (e.g., viscosity) and the size of the bore hole, the diameter of the conduit may also vary greatly, ranging from 5 to 100 cm, such as 10 to 90 cm, such as 10 to 90 cm, such as 20 to 80 cm, such as 25 to 75 cm, and including 30 to 50 cm. Depending on the depth of the subterranean formation, the wall thickness of conduits of the invention may range, in certain instances from 0.5 to 25 cm or thicker, such as 1 to 15 cm or thicker, such as 1 to 10 cm or thicker, including 1 to 5 cm or thicker. In certain embodiments, conduits may be configured in order to support high internal pressure from the flow of the bicarbonate composition. In other embodiments, the conduit may be configured to support high external loadings (e.g., external hydrostatic pressures, earth loads, etc.). Conduits for conveying the reaction product to a subterranean formation may be two-way delivery units such that a conduit may be employed to both introduce a fluid composition into the subterranean formation as well as withdraw a fluid composition from within the subterranean formation. For example, in some instances, a conduit may be employed to introduce a bicarbonate composition into the subterranean formation as well as be employed to withdraw the bicarbonate composition from within the subterranean formation at a later time.

In some embodiments, conduits for conveying the bicarbonate composition to a subterranean formation may include a plurality (e.g., 2 to 5) of concentric casings that form multiple layers within the conduit so that in the event of a fracture or break in one casing, leakage of the bicarbonate composition into the outside environment may be prevented or reduced. In some embodiments, the concentric casings may be produced from malleable steal or flexible corrosion-resistant materials such as e.g., fiberglass, Teflon, Kevlar, among others.

Systems of the invention may also include a carbonate-compound production station for producing a carbonate-containing reaction mixture and a carbonate-containing precipitation material from the bicarbonate composition. In some embodiments, the carbonate-compound production station may include one or more reactors configured for contacting a source of one or more divalent cations and a source of one or more proton-removing agents with the bicarbonate composition to produce a carbonate-containing reaction product. The reactor for contacting the source of one or more divalent cations and the source of one or more proton-removing agents may be any convenient mixing apparatus, e.g., conventional industrial mixing vessels having counterflow impellers, turbine impellers, anchor impellers, ribbon impellers, axial flow impellers, radial flow impellers, hydrofoil. The contacting reactor may also include conveyance structures such as pipes, ducts, or conduits which are connected to the source of the one or more divalent cations and the source of the one or more proton-removing agents, as well as to the control station which regulates the amount of the bicarbonate composition conveyed to the carbonate-compound production station.

In some embodiments, precipitation of the carbonate-containing precipitation material from the carbonate-containing reaction product may occur in the contacting reactor. As such, the contacting reactor may also include components for controlling precipitation conditions, such as temperature and pressure regulators and components for mechanical agitation and/or physical stirring mechanisms. The contacting reactor may also include filters and trays to allow for settling of the carbonate-containing precipitation material in the contacting reactor.

In some embodiments, systems of the invention may also include one or more reactors for the precipitation of a carbonate-containing precipitation material from the carbonate-containing reaction product. Precipitation reactors may include input structures for receiving the carbonate-containing reaction product. Precipitation reactors may also include output structures for conveying the carbonate-containing precipitation material and depleted brine from the precipitation reactor. The precipitation reactor may also include temperature and pressure regulators and components for mechanical agitation and physical stirring mechanisms. In some embodiments, the contacting reactor for producing the carbonate-containing reaction product and the precipitation reactor may be integrated into a single reactor. In these embodiments, the reactor may produce a carbonate-containing reaction product by contacting the bicarbonate composition with a source of one or more divalent cations and a source of one or more proton removing agents and subject the carbonate-containing reaction product to precipitation conditions to produce a carbonate-containing precipitation material and depleted brine.

In some embodiments, systems of the invention may also include a liquid-solid separator. As described above, liquid-solid separators of the invention may be any convenient separator, such as a basin for gravitational sedimentation of the precipitation material (e.g., where the liquid is separated by draining or decanting), a filter (e.g., gravity filter, vacuum filtration device, etc.), a centrifuge, or any combination thereof. The liquid-solid separator may be operably connected to the contacting or the precipitation reactor such that the carbonate-containing precipitation material may flow from the processor to the liquid-solid separator. Any of a number of different liquid-solid separators may be used in combination, in any arrangement (e.g., parallel, series, or combinations thereof).

In some embodiments, systems may also include a desalination station. The desalination station may be in fluid communication with the liquid-solid separator such that the liquid product may be conveyed from the liquid-solid separator to the desalination station directly. The systems may include a conveyance (e.g., pipe) where the output depleted brine may be directly pumped into the desalination station or may flow to desalination station by gravity. As described in detail above, desalination stations of the invention may employ any convenient protocol for desalination, and may include, but are not limited to distillers, vapor compressors, filtration devices, electrodialyzers, ion-exchange membranes, nano-filtration membranes, reverse osmosis desalination membranes, multiple effect evaporators or a combination thereof.

In some embodiments, systems may also include a drying station for drying the precipitated carbonate-containing precipitation material produced by the precipitation reactor. Depending on the particular drying protocol of the system, the drying station may include a filtration element, freeze drying structure, spray drying structure. The system may also include a conveyer, e.g., duct, from an industrial plant connected to the dryer so that a gaseous waste stream (i.e., industrial plant flue gas) may be contacted directly with the wet precipitate in the drying stage.

In some embodiments, systems of the invention may include a precipitate processing station, for processing the dried precipitate. The processing station may have grinders, millers, crushers, compressors, blender, etc. In order to obtain desired physical properties. One or more components may be added to the precipitate where the precipitate is used as a building material. The system further includes outlet conveyers, e.g., conveyer belt, slurry pump, that allow for the removal of precipitate from one or more of the following: the contacting reactor, precipitation reactor, drying station, or from the refining station. In certain embodiments, the system may further include a station for preparing a building material, such as cement, from the precipitate. This station can be configured to produce a variety of cements, aggregates, or cementitious materials from the precipitate, such as described in detail above.

In some embodiments, systems of the invention may also include one or more detectors configured for monitoring the composition of the brine, bicarbonate composition, carbonate-containing reaction product, carbonate-containing precipitation material or depleted brine. Monitoring may include, but is not limited to determining the chemical makeup (e.g., metal composition, salt composition, ionic composition, organometallic composition, and/or organic composition), pH, physical properties (e.g., boiling point), electrochemical properties, spectroscopic properties, acid-base properties, polydispersities, and partition coefficient. The detectors may be any convenient device configured to determine the composition of a gas, liquid, or solid, or a mixture thereof, and may in some embodiments be an inductively coupled plasma-atomic emission spectrometer (ICP-AES), a mass spectrometer, an X-ray diffractometer, UV-vis spectrometer, pH meter, gas chromatograph, infrared spectrometer, etc. In some embodiments, the detector may be configured to monitor conditions of the system such as pressure, temperature, temperature, pH, precipitation material particle size, metal-ion concentration, conductivity, alkalinity, pCO₂, etc.

In some embodiments, the detector may also include a computer interface which is configured to provide a user with the determined composition of the alkaline brine, bicarbonate composition, carbonate-containing reaction product, carbonate-containing precipitation material or depleted brine. For example, the detector may determine the composition and the computer interface may provide a summary of the composition. The summary may be stored as a computer readable data file or may be printed out as a user readable document.

In some embodiments, the detector may be a monitoring device such that it can collect real-time data (e.g., pH, carbonate concentration, bicarbonate concentration, conductivity, spectroscopic data, etc.). In other embodiments, the detector may be one or more detectors configured to collect data at regular intervals, e.g., determining the composition every 1 minute, every 5 minutes, every 10 minutes, every 30 minutes, every 60 minutes, every 100 minutes, every 200 minutes, every 500 minutes, or some other interval.

Systems of the invention may also include one or more processing stations configured to process the brine, bicarbonate composition, carbonate-containing reaction product, carbonate-containing precipitation material or depleted brine, as desired. In some embodiments, the one or more processing stations may include a mixing reactor for mixing additives into the alkaline brine, bicarbonate composition, carbonate-containing reaction product or carbonate-containing precipitation material. The mixing reactors may be any convenient industrial mixer, where in some embodiments it may include input structures for conveying components to the mixer for mixing. In some embodiments, the mixer may have an input structure, such as for example a pipe or a conduit. The input structure may further be coupled to a pump, such as a hydraulic pump or a rotary pump. The mixer may also have output structures to convey the processed composition from the mixer. As described above, mixing reactors of the invention may be any convenient mixer, such as a conventional industrial mixing vessel having counterflow impellers, turbine impellers, anchor impellers, ribbon impellers, axial flow impellers, radial flow impellers, hydrofoil mixers.

In some embodiments, the processing station may include a compressor configured to pressurize the alkaline brine, bicarbonate composition, carbonate-containing reaction product, carbonate-containing precipitation material or depleted brine, as desired. Compressors of the invention may employ any convenient compression protocol, and may include but are not limited to positive displacement pumps (e.g., piston or gear pumps), static or dynamic fluid compression pumps, radial flow centrifugal-type compressors, helical blade-type compressors, rotary compressors, reciprocating compressors, liquid-ring compressors, among other devices for fluid compression. In some embodiments, the compressor may be configured to pressurize to a pressure of 5 atm or greater, such as 10 atm or greater, such as 25 atm or greater, including 50 atm or greater.

In some embodiments, the processing station may include a concentrator configured to concentrate a desired component the brine, bicarbonate composition, carbonate-containing reaction product, carbonate-containing precipitation material or depleted brine. For example, the processing station may include a concentrator configured to concentrate bicarbonate in the bicarbonate composition. As such, in these embodiments, the concentrator may be configured to concentrate bicarbonate in the bicarbonate composition by 0.1 M or more, such as by 0.5 M or more, such as by 1 M or more, such as by 2 M or more, such as by 5 M or more, including by 10 M or more. The bicarbonate concentrator may be configured to concentrate bicarbonate in the bicarbonate composition to a concentration that is 0.5 M or greater, such as 1.0 M or greater, such as at least 1.5 M or greater, such as 2.0 M or greater, such as 5.0 M or greater, such as 7.5 M or greater, including 10 M or greater. Likewise, the processing station may include a concentrator configured to concentrate carbonate in the alkaline brine. Concentrators of the invention may employ any convenient protocol for concentrating a desired component and may include, but is not limited to distillers, extractive rectifiers, spray evaporators, among other protocols.

In some embodiments, the processing station may include a temperature regulator configured to adjust the temperature of the alkaline brine, bicarbonate composition, carbonate-containing reaction product, carbonate-containing precipitation material or depleted brine, as desired. In some embodiments, the temperature regulator may be may be configured to adjust the temperature by 5° C. or more, such as 10° C. or more, such as 15° C. or more, such as 25° C. or more, such as 50° C. or more, such as 75° C. or more, including 100° C. or more. As described in detail above, temperature regulators of the invention may be any convenient device that can cool or heat, and may include but is not limited to thermal heat exchangers, electric heating coils, Peltier thermoelectric devices, gas-powered boilers, coils employing refrigerants, coils employing cryogenic fluids, among other protocols. In certain embodiments, temperature regulators may employ energy generated from low or zero carbon dioxide emission sources, e.g., solar energy source, wind energy source, hydroelectric energy source, etc.

The brine provided to the contacting reactor or a component thereof (e.g., gas-liquid contactor, gas-liquid-solid contactor; etc.) may be re-circulated by a recirculation pump such that absorption of CO₂-containing gas (e.g., comprising CO₂, SOₓ, NOₓ, metals and metal-containing compounds, particulate matter, etc.) is optimized within a gas-liquid contactor or gas-liquid-solid contactor within the contacting reactor. With or without recirculation, processors of the invention or a component thereof (e.g., gas-liquid contactor, gas-liquid-solid contactor; etc.) may effect at least 25%, 50%, 70%, or 90% dissolution of the CO₂ in the CO₂-containing gas. Dissolution of other gases (e.g., SOₓ) may be even greater, for example, at least 95%, 98%, or 99%. Additional parameters that provide optimal absorption of CO₂-containing gas include a specific surface area of 0.1 to 30, 1 to 20, 3 to 20, or 5 to 20 cm⁻¹; a liquid side mass transfer coefficient (k_{L}) of 0.05 to 2, 0.1 to 1, 0.1 to 0.5, or 0.1 to 0.3 cm/s; and a volumetric mass transfer coefficient (K_{L}a) of 0.01 to 10, 0.1 to 8, 0.3 to 6, or 0.6 to 4.0 s⁻¹.

Contacting reactor may further include any of a number of different components, including, but not limited to, temperature regulators (e.g., configured to heat the alkaline brine to a desired temperature), pressure regulators, chemical additive components; electrochemical components, components for mechanical agitation and/or physical stirring mechanisms; and components for recirculation of industrial plant flue gas through the contacting reactor. Contacting reactor may also contain components configured for monitoring one or more parameters including, but not limited to, pH, metal-ion concentration, conductivity, alkalinity, and pCO₂. Contacting reactor may operate as batch wise, semi-batch wise, or continuously.

Contacting reactor may further include an output conveyance for outputting the reaction products of contacting the alkaline brine with CO₂. As discussed in detail above, depending on the alkalinity of the alkaline brine, the reaction products from contacting the alkaline brine with the source of CO₂ may vary. Where the alkaline brine possesses sufficient alkalinity to deprotonate carbonic acid to produce bicarbonate, the reaction products may be substantially all bicarbonate, such as for example where the molar ratio of bicarbonate to carbonic acid (HCO₃⁻/H₂CO₃) is 200/1 or greater, such as 500/1 or greater, such as 1000/1 or greater, such as 5000/1 or greater, including 10,000/1 or greater.

As discussed above, the produced bicarbonate composition may be further sequestered, such as for example, by conveying the bicarbonate composition into a subterranean formation. Alternatively, or in addition to sequestering the bicarbonate composition, the bicarbonate composition may be conveyed to a carbonate-compound production station to produce a carbonate-compound reaction product and a carbonate compound precipitation material.

In certain embodiments, systems of the invention may include a control station, configured to control the amount of the produced bicarbonate composition conveyed to a sequestration location and the amount of the bicarbonate composition conveyed to a carbonate-compound production station. A control station may include a set of valves or multi-valve systems which are manually, mechanically or digitally controlled, or may employ any other convenient flow regulator protocol. In some instances, the control station may include a computer interface, (where regulation is computer-assisted or is entirely controlled by computer) configured to provide a user with input and output parameters to control the amount of the bicarbonate composition conveyed to the sequestration location or to the carbonate-compound production station. A control station may also include one or more input conduits for conveying the bicarbonate composition from contacting reactor to the control station and one or more output conduits for conveying the bicarbonate composition to a sequestration location or to a carbonate-compound production station. In some embodiments, a contacting reactor and a control station are integrated into a single station which can produce the bicarbonate composition as well as regulate the flow of the bicarbonate composition to a sequestration location or to a carbonate-compound production station.

Where some or all of the bicarbonate composition is conveyed to a sequestration location, systems of the invention may also include a pumping station for conveying the bicarbonate composition to the sequestration location (e.g., subterranean formation). In some embodiments, a pumping station is in fluid communication with a control station, such as by a pipe, duct or conduit which directs the bicarbonate composition from contacting reactor to pumping station. The bicarbonate composition provided to a pumping station may be conveyed to a sequestration location by gravitational mediated flow or active pumping, as desired. The pumping reactor may employ conventional machinery for actively pumping the bicarbonate composition to the sequestration location, such as for example by down-well turbine-driven motor pumps, geothermal down-well pumps, hydraulic pumps, fluid transfer pumps, surface-located rotary pumps, among other protocols.

Where some or all of the bicarbonate composition is employed to produce a carbonate-containing precipitation material, systems of the invention may also include a carbonate-compound production station. In some embodiments, the carbonate-compound production station is in fluid communication with control station, such as by a pipe, duct or conduit which directs the bicarbonate composition from contacting reactor to carbonate-compound production station. Carbonate-compound production station may include a bicarbonate-composition contacting reactor for contacting a source of one or more divalent cations and a source of one or more proton removing agents with the bicarbonate composition. Where the source of the one or more proton removing agents is an electrochemical protocol, an electrochemical system may be in fluid communication with the carbonate-compound production station.

In some instances, a carbonate-compound production station may also include one or more precipitation reactors. The precipitation reactor may include structures for receiving the carbonate-containing reaction product from the bicarbonate composition contacting reactor. The precipitation reactor may also include components for controlling precipitation conditions, such as temperature and pressure regulators and components for mechanical agitation and/or physical stirring mechanisms; and components for recirculation of industrial plant flue gas through the precipitation reactor. The precipitation reactor may also include output structures for conveying the carbonate-containing precipitation material and depleted brine from the precipitation reactor. In some embodiments, the bicarbonate composition contacting reactor and precipitation reactor are integrated into a single reactor which contacts the bicarbonate composition with a source of divalent cations and a source of proton removing agent to produce a carbonate-containing reaction product and subjects the carbonate-containing reaction product to precipitation conditions to produce a carbonate-containing precipitation material and depleted brine.

In some embodiments, the carbonate-compound production station may also include a liquid-solid separator for separating carbonate-containing precipitation material from the depleted brine. In some instances, the liquid-solid separator may be in communication with desalination station, configured to produce desalinated water from the liquid product of the liquid-solid separator. System may also include a washer where bulk dewatered precipitation material from the liquid-solid separator is washed (e.g., to remove salts and other solutes from the precipitation material), prior to drying at the drying station (e.g., dryer). The system may further include drying station 480 for drying the carbonate-containing precipitation material from the liquid-solid separator. The dried precipitation material may undergo further processing in refining station in order to obtain desired physical properties. In some embodiments, systems of the invention include a processing station for producing a building material from the carbonate-containing precipitation material. In some instances, the system may be configured to produce a hydraulic cement, a supplementary cementitious material, a pozzolanic cement, or aggregate.

System may further include outlet conveyers (e.g., conveyer belt, slurry pump) configured for removal of precipitation material from one or more of the following: the contacting reactor, precipitation reactor, dryer, washer, or from the refining station. As described in detail above, precipitation material may be disposed of in a number of different ways. The precipitation material may be transported to a long-term storage location in empty conveyance vehicles (e.g., barges, train cars, trucks, etc.) that may include both above ground and underground storage facilities. In other embodiments, the precipitation material may be disposed of in an underwater location. In some embodiments, the precipitation material may be stored in the same sequestration location as the bicarbonate composition, such as for example, in a subterranean formation. Any convenient conveyance structure for transporting the precipitation material to the location of disposal may be employed. In certain embodiments, a pipeline or analogous slurry conveyance structure may be employed, wherein these structures may include units for active pumping, gravitational mediated flow, and the like.

### Methodology for Data Collection and Analyses of a Region

### Example 1

This example demonstrates a step in a site development process for the utilizing a region in Southwest Wyoming for sequestering carbon dioxide. The method includes steps to assess the availability of water, calcium, alkalinity, and CO₂ in the region using publicly available data. The first step in site selection process is to identify anthropogenic sources of CO₂ (potential sites suitable for the Calera process). Once these locations have been established sources of water, calcium, and alkalinity within 100 miles of the CO₂ source are screened based on predefined requirements. The results of this screening is a comprehensive data set in two formats (Excel and spatially referenced database file) that may then be spatially analyzed using the ARCGIS™ software system. Data analyses are conducted based on proximity to transportation networks (roads, pipelines, railroads), proximity to urban centers (potential markets), and proximity to other cement and concrete operators. A goal of this process is to identify areas of interest that will advance to the next stage of the site development process: Site visit, local data investigation, and sample collection and analysis.

Publicly available sources of data utilized during this process are as follows:
National Energy Technology Laboratory (NETL) Department of Energy (DOE) Rocky Mountain Produced Waters Database (2005)—a compilation of historical produced water records collected from the following sources: Amoco, British Petroleum, Anadarko Petroleum, United States Geological Survey (USGS), WOGCC, Denver Earth Resources Library, Bill Barrett Corporation, Stone Energy, and other operators. Recommended for general assessment only.
United States Geological Survey (USGS) Produced Water Database (2002)—Originally compiled by the DOE Fossil Energy Research Center.
Wyoming Oil and Gas Conservation Commission (WOGCC)—state operated database containing publicly available records pertaining to oil and gas recovery.
National Atlas—Federally operated geospatial spatial clearing house containing agriculture, biology, boundary, climate, environment, geology, history, map reference, people, transportation, and water data for the U.S.
Wyoming Geographic Information Science Center—state operated clearing house containing publicly available geospatial data.
NatCarb Atlas (NETL)—part of the NatCarb Project which links regionally managed databases. This source contains GIS shape files of CO₂ sources and Deep Saline Formations and Oil and Gas Reservoirs.

Calcium and Alkalinity—Wells with calcium concentrations greater than 10,000 ppm were queried and filtered based on proximity to trona mineral deposits (alkalinity source) and sources of anthropogenic carbon dioxide. Depth measurements for the wells were also collected. 55 unique sites were identified as having calcium concentrations greater than 10,000 ppm. Sources of error for calcium concentrations included inconsistent depth reporting, variable testing methods, data entry errors, data entry inconsistency. The calcium concentrations were generalized using the spatial modeling tools (ARCGIS™ Spatial Analyst). A kernel Density function to calculate the density of point features. In addition to calculating the density of point features, additional weight was added based on calcium concentration values.

Water Volumes—Aquifers were mapped and water volume calculations for produced water wells were generated exclusively from the WOGCC database. The year 2008 was randomly chosen and data was filtered by county and production field. The top 20 cumulative water producing fields were identified in the area of interest. The hydraulic head value for all wells was also calculated. Potentiometeric contours for the two shallowest aquifers in this region were collected from the USGS Groundwater Atlas of the United States. These potentiometeric contours represent the hydraulic head relative to sea level and are provided with intervals between 300 and 500 feet. After digitizing the lines of the potentiometeric contours, this dataset is interpolated and extrapolated using a Spline interpolation so that a potentiometeric value is been assigned to every location within the extent of the aquifer. The digital elevation model from USGS National Map Seamless Server (http://seamless.usgs.gov/) has been used as a high quality source for surface elevation information. Subtracting the surface elevation from the potentiometeric values generates the hydraulic head relative to the surface. A map of the hydraulic head relative to the surface may be used to evaluate potential well locations.

Anthropogenic carbon dioxide—Quantitative data on CO₂ Emissions was calculated using the NatCarb dataset. The nationwide dataset was filtered down to the area of interest using geographic information systems (GIS) software. The data was then sorted by source type and emissions per year. This data set also contained operator information.

A person having ordinary skill in the art will appreciate that flow rates, mass transfer, and heat transfer may vary and may be optimized for systems and methods described herein, and that parasitic load on a power plant may be reduced while carbon dioxide sequestration is maximized.

That which is claimed is:

1. A method comprising:
a. contacting carbon dioxide with an aqueous mixture to form a reaction product in the contacted aqueous mixture; wherein the reaction product comprises water and dissolved carbon dioxide carbonic acid, carbonates, or bicarbonates or a combination thereof, and
b. sequestering at least a portion of the reaction product or derivative thereof in a first subterranean location.

2. The method of claim 1 wherein the carbon dioxide is a component of an industrial waste gas.

3. The method of claim 1 wherein the carbon dioxide is supercritical carbon dioxide.

4. The method of claim 1, wherein the aqueous mixture comprises divalent cations.

5. The method of claim 1, wherein the aqueous mixture is alkaline.

6. The method of claim 4, wherein the divalent cations comprise cations of calcium, magnesium, or a combination of calcium and magnesium.

7. The method of claim 6, wherein the molar ratio of calcium to magnesium is between 1:1 and 1000:1.

8. The method of claim 1, wherein the reaction product contains less than 1% solids.

9. The method of claim 1, wherein sequestering carbon dioxide further comprises precipitating a precipitation material comprising carbonates, bicarbonates, or a combination of carbonates and bicarbonates from the reaction product.

10. The method of claim 1, further comprising concentrating the reaction product to form a concentrated mixture.

11. The method of claim 2, wherein contacting the aqueous mixture with the waste gas occurs at or above ground level.

12. The method of claim 1 wherein the carbon in the reaction product has a δ¹³C value less −10‰.

13. The method of claim 2, wherein the waste gas further comprises SOₓ, NOₓ, industrial waste particulate, VOCs, heavy metals, heavy metal containing compounds, or a derivative of any of the forgoing or any combinations thereof.

14. The method of claim 13, wherein the reaction product further comprises SOₓ, NOₓ, industrial waste particulates, VOCs, metals, metal containing compounds, or any combinations thereof.

15. The method of claim 1, wherein the subterranean location is between 100 and 1000 meters below ground.

16. The method of claim 15, wherein the concentration of the carbon is at least 0.2472 g/cm³.

17. The method of claim 1, wherein the aqueous mixture comprises solid material.

18. The method of claim 17, wherein the solid material comprises mafic mineral particulate, solid waste from an industrial process, or any derivative or combination thereof.

19. The method of claim 1, wherein the first subterranean location is an aquifer, a petroleum reservoir, a deep coal seam, or a sub-oceanic location.

20. The method of claim 1, wherein the subterranean location is a geological feature covered by rock with a porosity greater than 1%.

21. The method of claim 1, wherein the subterranean location is a geological feature not covered by cap rock.

22. The method of claim 1, wherein the aqueous mixture comprises fresh water, seawater, retentate from a desalination process, a subterranean brine, or a stream resulting from dissolution of mineral sources or any combination thereof.

23. The method of claim 2, wherein the waste gas comprising carbon dioxide is provided by an industrial process.

24. The method of claim 2, wherein the waste gas is provided by a power plant, a steam fossil fuel reformer, a liquefied natural gas plant, a cement plant, a smelter, or any combination thereof.

25. The method of claim 1, wherein producing the reaction product comprises removing protons from the aqueous solution before or after contacting the aqueous mixture with carbon dioxide.

26. The method of claim 25, wherein protons are removed by addition of a proton-removing agent.

27. The method of claim 26, wherein the proton-removing agent comprises an industrial waste.

28. The method of claim 27, wherein the industrial waste comprises fly ash, bottom ash, cement kiln dust, slag, red mud, mining waste, or any combination thereof.

29. The method of claim 25, wherein the protons are removed by an electrochemical method.

30. The method of claim 25, wherein the protons are removed by a combination of electrochemistry and the addition of a proton removing agent.

31. The method of claim 1, further comprising separating an amount of water from the reaction product, producing a concentrated mixture and a supernatant.

32. The method of claim 31, wherein a portion of the concentrated mixture is transported to the subterranean location.

33. The method of claim 31, wherein the concentrated mixture comprises greater than 30% solids by weight.

34. The method of claim 31, wherein the supernatant is reused as a portion of the aqueous mixture.

35. The method of claim 1, further comprising removing the aqueous mixture from a second subterranean location prior to contacting the aqueous mixture with the waste gas comprising carbon dioxide or supercritical carbon dioxide.

36. The method of claim 35, wherein the first and second subterranean locations are the same location.

37. The method of claim 35, wherein the first and second subterranean locations are the different locations.

38. A system comprising:
a. a processor configured for contacting an aqueous mixture with an industrial waste gas comprising carbon dioxide to produce a reaction product comprising water and dissolved carbon dioxide carbonic acid, carbonates, or bicarbonates or a combination thereof;
b. a first conduit;
c. a first subterranean location, wherein the conduit provides for transferring a portion of the reaction product or a derivative of the reaction product from the processor to the subterranean location.

39. The system of claim 38, further comprising d. a source for the industrial waste gas operably connected to the processor.

40. The system of claims 38 and 39, further comprising e. a second subterranean location operably connected to the processor.

41. The system of claim 40 further comprising a pump configured for transferring a subterranean brine from the second subterranean location to the processor.

42. The system of claims 40 and 41 wherein the first and second subterranean locations are the same location.

43. The system of claims 40 and 41 wherein the first and second subterranean locations are different locations.

44. The system of claims 38, 39 and 40, wherein the processor configured to contact an aqueous mixture that is a liquid or a slurry

45. The system of claims 38, 39 and 40, wherein the processor is configured to produce a reaction product comprising liquids and solids.

46. The system of claim 45, further comprising a liquid-solid separator for concentrating the reaction product mixture, wherein the liquid-solid separator is operably connected to the processor and the first conduit.

47. The system of claims 38, 39 and 40, wherein the system further comprises a first pump for pumping the product mixture to the first subterranean location.

48. The system of claim 47, wherein the first pump is configured to provide no more than 2 bars of pressure.

49. The system of claims 38, 39 and 40, wherein the first subterranean location is a depleted petroleum reservoir, or a coal deposit.

50. The system of claims 38, 39 and 40, wherein the rock above the first subterranean location has a porosity greater that 1%.

51. The system of claims 38, 39 and 40, wherein the first subterranean location is a geological formation is a saline aquifer.

52. The system of claims 38, 39 and 40, wherein the industrial waste gas comprising carbon dioxide is provided by a power plant, a steam fossil fuel reformer, a cement plant, a smelter, or a liquefied natural gas plant.

53. A method comprising:
a. obtaining a reaction product comprising at least 0.0103 mol/cm³ of carbon; from carbon dioxide and a first subterranean brine from a first subterranean location, and
b. sequestering some or all of the reaction product in a second subterranean location.

54. The method of claim 53, wherein the reaction product comprises a liquid comprising water, carbonic acid, bicarbonate, or carbonate or a combination thereof.

55. The method of claim 53, wherein the first and second subterranean location are the same location.

56. The method of claim 53, wherein the first and second subterranean location are less than 100 surface miles away from each other.

57. The method of claim 53, wherein the reaction product is a slurry comprising a liquid and a solid.

58. The method of claim 57, further comprising separating some or all of the liquid from the solid.

59. The method of claim 58, wherein separating the liquid from the solid creates a slurry comprising between 15% and 50% solids by weight.

60. The method of claim 59, wherein separating the liquid from the solid creates a slurry comprising between 40% and 50% solids by weight
